(19) United States
(12) Patent Application Publication
(10) Pub. No.: US 2024/0278592 A1
(43) Pub. Date: Aug. 22, 2024

(54) HEAT-SENSITIVE RECORDING MATERIALS

(71) Applicant: Koehler Innovation & Technology GmBH, Oberkirch (DE)

(72) Inventors: Timo STALLING, Appenweier (DE); Uwe BRASCH, Offenburg (DE); Dominik HOFERER, Lautenbach (DE)

(21) Appl. No.: 18/570,919

(22) PCT Filed: Jun. 17, 2022
(86) PCT No.: PCT/DE2022/100449

§ 371 Date: Dec. 15, 2023

(30) Foreign Application Priority Data
Jun. 18, 2021 (DE) 10 2021 115 909.1

(51) Int. Cl. B41M 5/36; B41M 5/44

(52) U.S. Cl. CPC B41M 5/363; B41M 5/44; B41M 2205/04; B41M 2205/36; B41M 2205/38; B41M 2205/40

(57) ABSTRACT

The present invention relates to heat-sensitive recording materials comprising a web-like support material, a colour layer on one side of the web-like support material and a heat-sensitive layer on the colour layer so that the colour layer is at least partially covered, the heat-sensitive layer being designed so that it becomes translucent due to local action of heat, so that the underlying colour layer becomes visible.

The present invention relates to heat-sensitive recording materials, especially heat-sensitive recording materials for thermal direct printing.

Heat-sensitive recording materials are known in principle, wherein a basic distinction can be made between two different types of heat-sensitive recording materials, especially for thermal direct printing:

Type 1: Heat-sensitive recording material in which the printed image is produced by local heat-induced chemical reaction in a colour layer, e.g. between colour former (e.g. a leuco dye) and colour developer (e.g. bisphenol A or a phenol-free alternative). Usually, the colour layer additionally contains a heat-sensitive dissolving substance (solvent) that melts under the action of heat (e.g. long-chain aliphatic alcohols, amides, esters or carboxylic acids), so that the colour reaction of colour former and colour developer is enabled. Furthermore, the colour layer may contain heat-sensitive sensitisers.

Type 2: Heat-sensitive recording material in which the printed image is produced by a heat-sensitive cover layer becoming translucent due to local action of heat, e.g. by means of a thermal direct printer, so that an underlying colour layer becomes visible. This technology is described or interpreted differently in the prior art and such a heat-sensitive recording material is obtained by partly different compositions, porosities and materials of the cover layer, optimised for thermal direct printing and explained in greater detail below.

In principle, the following applies:

1. The cover layer should cover the underlying colour layer as well as possible.

This is achieved substantially by light scattering (scattering particles) and light absorption.

2. The cover layer should have as high a contrast as possible relative to the underlying colour layer in order to produce a printed image that can be read by the human eye and/or a machine (scanner) (e.g. white/black or blue/yellow).

3. The cover layer should have sufficient heat sensitivity so that it becomes translucent due to local action of heat, especially by means of conventional thermal direct printers. With a conventional thermal direct printer, it should be possible to use recording materials of type 1 and type 2 and the printer settings should be comparable, especially print head temperature and printer speed.

The present invention relates to heat-sensitive recording materials of type 2 described above.

GB 997289 describes for the first time a recording material for thermal direct printing comprising a support material, a colour layer and a heat-sensitive cover layer, wherein the heat-sensitive cover layer becomes translucent due to local action of heat by means of a thermal direct printer, so that the underlying colour layer is visible and thus a printed image is produced.

U.S. Pat. No. 6,043,193 describes a heat-sensitive recording material comprising a support and an opaque recording layer applied thereto, comprising hollow spherical beads dispersed in a hydrophilic binder, said beads having a mean diameter of 0.2 μm to 1.5 μm and a void volume of 40% to 90%.

U.S. Pat. No. 6,133,342 describes a heat-sensitive recording material comprising a dye and an opaque polymer material of which the opacity changes substantially irreversibly, making the dye more visible when exposed to heat.

WO 2015/119964 A1 discloses an oriented multilayer film for printing comprising an extruded outer layer, an extruded inner pigment layer, and an extruded image-rendering layer interposed between the outer layer and the inner pigment layer, wherein the image-rendering layer comprises a void layer having a collapsible layer structure, in which a plurality of voids are dispersed, wherein a plurality of voids are formed by orienting the multilayer film, wherein the extruded image-rendering layer and the collapsible layer structure are in a non-collapsed state that is substantially opaque in order to obscure the pigment layer thereunder.

US 2010/245524 A describes a heat-sensitive recording material comprising a heat-sensitive substrate with an opaque polymer which is sensitive to the application of heat and pressure and which, when heated to a predetermined temperature and subjected to a predetermined pressure, causes the opaque polymer to become transparent, so that the opaque polymer becomes transparent, and a colour material arranged with respect to the substrate in such a manner that it is obscured by the opaque polymer prior to the application of the predetermined heat and pressure and becomes visible thereafter.

US 2011/172094 A discloses a recording material comprising the following:
a) a support having a surface impregnated with a dye or coated with a coating containing a pigment or a dye, and, arranged thereon,
b) a layer comprising polymer particles having a core-shell structure and being hollow when dry in order to scatter visible light, said particles having an inner first polymer shell with a Tg of from 40° C. to 130° C. and an outer second polymer shell with a Tg of from −55° C. to 50° C., the Tg of the outer polymer shell being lower than that of the inner polymer shell.

US 2011/251060 A describes a heat-sensitive recording material consisting of a dye and a flexible support substrate, wherein the heat-sensitive recording material further consists of a heat-sensitive layer, wherein the heat-sensitive layer comprises a binder, a plurality of organic hollow-sphere pigments and a thermal solvent, and wherein the heat-sensitive layer is arranged on the dye. The heat-sensitive layer may be provided with a barrier layer and a protective layer.

WO 2012/145456 A1 describes a heat-sensitive recording material optimised for conventional thermal direct printing, said material including:
a) a support in the form of a sheet-like structure comprising at least one coloured surface, and, arranged thereon,
b) a layer comprising polymer particles having a core-casing structure, wherein the particles have an outer first polymer casing with a calculated Tg of from 40° C. to 130° C., wherein the particles, when dry, comprise at least one void, and from 1 wt. % to 90 wt. %, in relation to the weight of the polymer particles, of an opacity reducer having a melting point of from 45° C. to 200° C., wherein said coloured surface has sufficient colour density to visibly stand out from the surface of the following layer dispersed thereon, wherein said opacity reducer is an aromatic oxalic acid ester, an aromatic ethylene glycol ether, 1,2-diphenyloxyethane, dibenzyloxalate, dibenzyl terephthalate, benzyl biphenyl, benzyl-2-naphthyl ether, diphenyl sulfone, m-terphenyl, p-benzyloxybenzyl benzoate, cyclohexanedimethanol benzoate, p-toluenesulfonamide, o-toluenesulfonamide, 2,6-diisopropylnaphthalene, 4,4-diisopropylbiphenyl, erucamide, stearic acid amide, palmitic acid amide or ethylene-bis-stearic acid amide.

WO 2013/152287 A1 describes a heat-sensitive recording material having a two-layer monoaxially oriented film comprising a first layer comprising a beta-nucleated propylene-based opaque polymer and a second layer comprising a dark pigment.

US 2015/049152 A describes a heat-sensitive recording material comprising a heat-sensitive layer arranged on a coloured solid support substrate, the heat-sensitive layer including single-phase scattering polymer particles each having a centre, a surface, a refractive index at the centre thereof different from a refractive index at the surface thereof, and a continuous refractive index gradient, the heat-sensitive layer further including heat-deformable particles and a binder.

EP 2993054 A1 describes a web-like heat-sensitive recording material having at least one first ply and a second ply at least partially covering the first ply, the first ply having an intensive colouration at least facing the second ply and the second ply having hollow-body pigments which can be melted to form a script by locally confined heat treatment, characterised in that the second ply, in addition to the hollow-body pigments, also comprises one or more fatty acids and one or more heat-sensitive sensitisers.

EP 2993055 A1 describes a web-like heat-sensitive recording material having at least one first ply and a second ply at least partially covering the first ply, the first ply having an intensive colouration at least facing the second ply and the second ply having hollow-body pigments which can be melted to form a script by locally confined heat treatment, characterised in that the recording material has at least one protective layer at least partially covering the second ply.

In terms of the physical process, a distinction is made there between two different methods for creating the printed image:

1. The printed image is created by making a heat-sensitive cover layer translucent due to local action of heat by means of a thermal direct printer, the cover layer comprising hollow-body pigments that can be melted.

2. The printed image is created by making a heat-sensitive cover layer translucent due to local action of heat by means of a thermal direct printer, the cover layer comprising hollow-body pigments that can be softened or dissolved.

According to this document, an acceptable grey recording material can be obtained having the following characteristic values: whiteness of 56% and 52% with and without UV component, respectively; optical density (unprinted) of 0.33 ODU, optical density (printed) of 1.22 ODU; and contrast of 0.89 ODU (thermal head 300 dpi, 16 mJ/mm²).

The associated divisional application EP 3517309 A1 specifies especially the feature of the cover layer, which comprises hollow-body pigment pigments that can be manipulated to form a script and at least one fatty acid, namely stearic acid and/or palmitic acid or stearic acid amide and/or methylstearic acid amide.

US 2017/337851 A discloses a recording material comprising:
a release-liner base material layer,
an optional adhesive layer,
a label base layer,
a thermal insulation layer (thermally insulating layer) placed over the label base layer,
an ink layer arranged over the thermal insulation layer (thermally insulating layer), the ink layer comprising at least one colour,
a cover layer arranged over the printed ink layer, and
a top-coat layer arranged over the cover layer,
the cover layer comprising an acrylic-based composition containing light-scattering particles that cause the cover layer to be opaque in a first state and transparent in a second state, wherein at least one of heat and pressure is applied from a print head and causes the cover layer to transition from the first state to the second state, thereby allowing the at least one colour of the ink layer to be visible through the cover layer.

In WO 2019/183471 A1, a recording medium is disclosed comprising a substrate, wherein the substrate takes part in the first scattering particles having a melting point and comprising a first solid light-scattering layer, and the first light-scattering layer is as close as possible to a plurality of second solid scattering particles, the second solid scattering particles having a lower melting point than the first melting point of the second solid scattering particles, and the first light-scattering layer being porous and the second scattering particles during melting of the solid, the first solid scattering particles being arranged to fill the space between the recording medium.

WO 2019/219391 A1 describes a heat-sensitive recording material comprising a support substrate that is black or coloured on at least one side and a thermoresponsive layer on the at least one black or coloured side of the support substrate, the thermoresponsive layer comprising nanoparticles of at least one cellulose ester.

WO 2021/055719 A1 describes a heat- or pressure-sensitive recording material comprising a layer of an opaque material, colour material arranged on a first side of the layer of opaque material, the layer of opaque material covering the colour material, the opaque material in an opaque state comprising a plurality of irregular and/or uneven shaped opaque polymer particles, defining voids therebetween and having different shapes and/or different sizes, and furthermore the opaque material being configured to change from the opaque state to a transparent state upon application of sufficient temperature and/or sufficient pressure to expose the colour material beneath the opaque material.

In WO 2021/062230 A1, a recording medium is disclosed, comprising a substrate, a first light-scattering layer supported by the substrate and containing first scattering particles having a first melting point, and a plurality of second scattering particles in proximity to the first light-scattering layer, the second scattering particles having a second melting point lower than the first melting point, wherein the first light-scattering layer is porous and the second scattering particles are arranged, upon melting, to fill spaces between the first scattering particles, and wherein the first scattering particles comprise perforated particles.

All of these known heat-sensitive recording materials are in need of improvement, especially with regard to their functionality, sustainability and economic production. Especially, it is desirable to provide heat-sensitive recording materials having improved functional properties and/or improved environmental properties that especially are especially economical, i.e. simple and inexpensive to produce.

The present invention addresses this need.

Surprisingly, these aims have been addressed by a heat-sensitive recording material according to claim 1, by a heat-sensitive recording material according to claim 21, by a heat-sensitive recording material according to claim 41, by a heat-sensitive recording material according to claim 64, by a heat-sensitive recording material according to claim 65 and/or by a heat-sensitive recording material according to claim 85.

All of these heat-sensitive recording materials are significantly improved, especially in terms of their functionality, their environmental properties (sustainability) and/or their economic production (simple and inexpensive).

Numerous specific details are also discussed below to provide a comprehensive understanding of the present subject matter. However, it is obvious to a person skilled in the art that the subject matter can be put into practice and reworked without these specific details.

All features of one embodiment may be combined with features of another embodiment if the features of the various embodiments are not incompatible.

It is also understood that, although the terms “first”, “second” etc. may be used here to describe various elements, these elements are not intended to be limited by these terms. These terms are only used to distinguish one element from another. For example, a first object or step could be referred to as a second object or step, and, similarly, a second object or step could be referred to as a first object or step. The first object or step and the second object or step are both objects or steps, but they are not to be considered the same object or step.

The terminology used in the description of the present disclosure serves to describe particular embodiments only and is not to be construed as limiting the subject matter. As used in the present description and claims, the singular forms “a”, “one” and “the” are to be understood as including the plural forms, unless the context clearly dictates otherwise. This also applies vice versa, i.e. the plural forms also include the singular forms. It is also understood that the term “and/or” as used herein refers to and includes all possible combinations of one or more of the associated listed elements. It is further understood that the terms “includes”, “including”, “comprises” and/or “comprising”, when used in the present description and claims, specify the presence of the specified features, steps, operations, elements and/or components, but do not exclude the presence or addition of one or more other features, steps, operations, elements, components and/or groups thereof.

In the present description and claims, the terms “includes”, “comprises” and/or “comprising” may also mean “consisting of”, i.e. the presence or addition of one or more other features, steps, operations, elements, components and/or groups is excluded.

In the present description and the claims, the term “including” can thus also mean “exclusively”.

In the present description, the Bekk smoothnesses mentioned are determined according to DIN 53107 (2016).

In a first aspect, the present invention relates to a heat-sensitive recording material comprising
a web-like support material,
a colour layer on one side of the web-like support material and
a heat-sensitive layer on the colour layer so that the colour layer is at least partially covered,
the heat-sensitive layer being designed so that it becomes translucent due to local action of heat, so that the underlying colour layer becomes visible, characterised in that
the support material has a Bekk smoothness of greater than 20 s on the side to which the colour layer is applied, the Bekk smoothness being determined according to DIN 53107 (2016).

Such a heat-sensitive recording material has the advantage of high dynamic sensitivity.

It is advantageous to already present a smooth web-like support material and to maintain this smoothness over the individual coatings. The smoother the substrate is built up from below, the better the final smoothness and thus the sensitivity of the end product.

Preferably, the support material has a Bekk smoothness of greater than 30 s, especially preferably of greater than 50 s on the side to which the colour layer is applied.

The colour layer preferably has a Bekk smoothness of greater than 50 s, especially preferably of greater than 100 s and very especially preferably of greater than 150 s on the side to which the heat-sensitive layer is applied.

The heat-sensitive layer preferably has a Bekk smoothness of greater than 100 s, especially preferably of greater than 250 s, on the side on which the colour layer is not located.

Preferably, the support material has a Bekk smoothness of 20 to 400 s, especially preferably 30 to 300 s and very especially preferably 50 to 200 s on the side to which the colour layer is applied. A Bekk smoothness of 50 to 150 s is most preferred.

The colour layer preferably has a Bekk smoothness of 50 to 400 s, especially preferably 100 to 250 s and very especially preferably 150 to 250 s on the side to which the heat-sensitive layer is applied.

The heat-sensitive layer preferably has a Bekk smoothness of 100 to 1000 s, especially preferably 250 to 800 s, on the side on which the colour layer does not lie.

It is preferred that each layer applied to the web-like support material has a Bekk smoothness on its upper side, i.e. on the side on which the web-like support material does not lie, that is at least as great as or greater than that of the underlying layer.

Preferably, each layer applied to the web-like support material has a Bekk smoothness of at least 5% (percentage increase) on its upper side, i.e. on the side on which the web-like support material does not lie, compared to the underlying layer.

Preferably, each layer applied to the web-like support material has a Bekk smoothness of at least 5 s (absolute increase) on its upper side, i.e. on the side on which the web-like support material does not lie, compared to the underlying layer.

The web-like support material is in principle not limited. In a preferred embodiment, the web-like support material comprises paper, synthetic paper and/or a plastics film. The support material preferably has an area density of from 30 to 100 g/m², especially from 40 to 80 g/m².

The web-like support material of the heat-sensitive recording material according to the invention preferably comprises at least one black or coloured side, which is achieved by applying a colour layer. The term “coloured side” is understood to mean that the side has a colour other than white or black. In other words, the heat-sensitive recording material comprises at least one side which is coloured such that it is not white. Embodiments are also possible in which the at least one black or coloured side has several different colours, also in combination with the colour black.

The at least one colour layer on one side of the web-like support material is preferably characterised in that the colour layer comprises at least one pigment and/or a dye and also preferably a binder.

The pigments and/or dyes include various organic and inorganic pigments, dyes and/or carbon black. These can be used alone or in any mixtures.

The pigment, the dye and/or the carbon black are preferably each present in the colour layer in an amount of from 2 to 50 wt. %, especially preferably from 10 to 35 wt. %, in relation to the total solids content of the colour layer.

Carbon black is usually understood to be a black, powdery solid which, depending on quality and use, consists to an extent of 80% to 99.5% of carbon and can be obtained, for example, by the incomplete combustion and/or thermal cracking of hydrocarbons.

Preferred binders are water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

The binder is preferably present in the colour layer in an amount of from 2 to 40, especially preferably from 10 to 30, in relation to the total solids content of the colour layer.

The colour layer preferably has an area density of from 1 to 10 g/m², especially from 3 to 8 g/m².

The colour layer preferably has a thickness of from 1 to 10 μm, especially from 2 to 8 μm.

In a further preferred embodiment, the heat-sensitive recording material is characterised in that the heat-sensitive layer comprises at least one scattering particle, especially a polymer particle, having a glass transition temperature of from −55 to 130° C., preferably from 40 to 80° C.

In a further preferred embodiment, the heat-sensitive recording material is characterised in that the heat-sensitive layer comprises at least one scattering particle, especially a polymer particle, having a core/casing structure, wherein the scattering particles, especially the polymer particles, are selected from the group consisting of (i) scattering particles, especially polymer particles, having an outer shell with a glass transition temperature of from 40° C. to 80° C. and (ii) scattering particles, especially polymer particles, having an inner shell with a glass transition temperature of from 40° C. to 130° C. and an outer shell with a glass transition temperature of from −55° C. to 50° C., wherein the glass transition temperature of the outer shell is preferably lower than that of the inner shell.

In a further preferred embodiment, the heat-sensitive recording material is characterised in that the heat-sensitive layer comprises at least one scattering particle, especially a polymer particle, having a melting temperature lower than 250° C., preferably from 0° C. to 250° C.

In a further preferred embodiment, the heat-sensitive recording material is characterised in that the heat-sensitive layer comprises at least one scattering particle, especially a polymer particle, having a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a glass transition temperature of from −55 to 130° C., preferably from 40 to 80° C., and having a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a core/casing structure, wherein the scattering particles, especially the polymer particles, are selected from the group consisting of (i) scattering particles, especially polymer particles, having an outer shell with a glass transition temperature of from 40° C. to 80° C. and (ii) scattering particles, especially polymer particles, having an inner shell with a glass transition temperature of from 40° C. to 130° C. and an outer shell with a glass transition temperature of from −55° C. to 50° C., wherein the glass transition temperature of the outer shell is preferably lower than that of the inner shell, and with a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a melting temperature lower than 250° C., preferably from 0° C. to 250° C., and having a mean particle size in the range of from 0.1 to 2.5 μm, preferably from 0.2 to 0.8 μm.

A glass transition temperature or a melting temperature lower than 250° C. was found to be advantageous. Above temperatures of 250° C., thermal direct printing is not possible because the temperature-time window is outside the printer specification.

A mean particle size in the range of from 0.1 to 2.5 μm is advantageous, as particles of this size scatter the visible light and thus the colour layer is covered to the greatest possible extent.

The mean particle size can be determined using a Beckman Coulter device (laser diffraction, Fraunhofer method).

The scattering particles, especially the polymer particles, are preferably crystalline, semi-crystalline and/or amorphous.

The above-stated glass transition temperatures refer to semi-crystalline or amorphous scattering particles, especially polymer particles. The melting temperatures refer to crystalline scattering particles, especially polymer particles, or to the crystalline portion of the scattering particles, especially polymer particles.

The primary property of the scattering particles, preferably the polymer particles, is light scattering in the visible range of light. The secondary property is thermal sensitivity.

The polymer particles preferably comprise thermoplastic polymers.

The polymer particles preferably comprise polymers resulting from the polymerisation of one or more monomers selected from the group comprising acrylonitrile, styrene, butadiene, benzyl methacrylate, phenyl methacrylate, ethyl methacrylate, divinylbenzene, 2-hydroxyethyl methacrylate, cyclohexyl methacrylate, 2-methylstyrene, 3-methylstyrene, 4-methylstyrene, alpha-methylstyrene, beta-methylstyrene, acrylamide, methacrylamide, methacrylonitrile, hydroxypropyl methacrylate, methoxystyrene, N-acrylylglycinamide and/or N-methacrylylglycinamide and/or derivatives thereof.

In another embodiment, the polymer particles may be polymerised using a variety of ethylenically unsaturated monomers. Examples of non-ionic monoethylenically unsaturated monomers include styrene, vinyl toluene, ethylene, vinyl acetate, vinyl chloride, vinylidene chloride, acrylonitrile, (meth)acrylamide, various (C₁-C₂₀)-alkyl or (C₃-C₂₀)-alkenyl esters of (meth)acrylic acid, including methyl acrylate (MA), methyl methacrylate (MMA), ethyl (meth)acrylate, butyl (meth)acrylate, 2-hydroxyethyl (meth)acrylate, 2-ethylhexyl (meth)acrylate, benzyl (meth)acrylate, lauryl (meth)acrylate, oleyl (meth)acrylate, palmityl (meth)acrylate and stearyl (meth)acrylate. Typically, acrylic esters such as MMA, EA, BA and styrene are preferred monomers for polymerisation and formation of the shell of the polymer particles. Difunctional vinyl monomers such as divinylbenzene, allyl methacrylate, ethylene glycol dimethacrylate, 1,3-butanediol dimethacrylate, diethylene glycol dimethacrylate, trimethylolpropane trimethacrylate and the like can also be copolymerised to form a crosslinked outer casing, as described in US patent application 2003-0176535 A1.

In another embodiment, the polymer particles preferably comprise (meth)acrylonitrile copolymers, polyvinyl chloride, polyvinylidene chloride, polystyrene, styrene acrylate, styrene (meth)acrylate copolymers, polyacrylonitrile, polyacrylic acid esters or also mixtures of at least two thereof.

The strength and durability of the polymer particles can be influenced by the crosslinking of polymer chains.

The scattering particles, especially the polymer particles, may be in the form of closed polymer particles, open polymer particles and/or solid-body particles, each of which may be regular or irregular in shape.

Examples of closed hollow-body particles include hollow-spherical polymer particles, or polymer particles with a core/casing structure.

Examples of hollow-spherical polymer particles or polymer particles with a core/casing structure are Ropaque HP-1055, Ropaque OP-96 and Ropaque TH-1000.

Especially, so-called “cup-shaped” polymer particles can be mentioned as examples of polymer particles. With regard to the casing, these have the same materials as the closed polymer particles, especially the closed hollow-spherical polymer particles. In contrast to the classic hollow-body pigments, in which an inner core of gas, usually air, is completely enclosed by a casing formed of organic, usually thermoplastic components, the “cup-shaped” polymer particles do not have a closed casing and only surround the inner core in the form of a shell or “cup”, which is closed to the greatest possible extent.

As further examples of open polymer particles, lattice cage-shaped polymer particles as described in WO 2021/062230 A1 can be mentioned.

Examples of solid-body particles are polyethylene, polystyrene and cellulose esters.

The above-mentioned scattering particles, especially the polymer particles, can be regularly or irregularly shaped.

In an alternative embodiment, the polymer particles are spherical solid-body particles, preferably irregularly shaped, and/or spherical hollow-body particles, both preferably in the form of droplets. These preferably comprise polystyrene, for example Plastic Pigment 756A from Trinseo LLC., and Plastic Pigment 772HS from Trinseo LLC., polyethylene, for example Chemipear 10 W401 from Mitsui Chemical Inc., spherical hollow-body particles (HSP)/spherical hollow-body pigments, for example Ropaque TH-500EF from The Dow Chemical Co., modified polystyrene particles, for example Joncryl 633 from BASF Corp., 1,2-diphenoxyethane (DPE), ethylene glycol m-tolyl ether (EGTE) and/or diphenyl sulfone (DPS). These can be used alone or in any mixtures. These polymer particles preferably have a mean particle size of 0.2 μm, 0.3 μm, 0.4 μm, 0.45 μm, 0.75 μm or 1.0 μm.

The scattering particles, especially polymer particles, are preferably present in the heat-sensitive layer in an amount of from 20 wt. % to 60 wt. %, preferably from 30 wt. % to 50 wt. % in relation to the solids content of the heat-sensitive layer.

Preferably, the heat-sensitive layer comprises at least one heat-sensitive material having a melting temperature in the range of from 40 to 200° C., preferably from 80 to 140° C., and/or a glass transition temperature in the range of from 40 to 200° C., preferably from 80 to 140° C.

Preferably, the heat-sensitive layer comprises at least one heat-sensitive material having a mean particle size of from 0.2 to 4.0 μm, preferably from 0.5 to 2.0 μm.

The heat-sensitive material also preferably contributes to the opacity (covering power) of the heat-sensitive layer, e.g. by absorbing and/or also scattering light.

It is assumed that the heat-sensitive material quickly melts locally due to local exposure to heat by the thermal print head of the thermal direct printer, resulting in a local “softening” of the polymer particles, and thus in a local reduction of the covering force (opacity reduction), so that the cover layer becomes translucent and the underlying colour layer becomes visible.

The heat-sensitive material can also be called a sensitiser or thermal solvent.

Preferably, the heat-sensitive material comprises one or more fatty acids, such as stearic acid, behenic acid or palmitic acid, one or more fatty acid amides, such as stearamide, behenamide or palmitamide, an ethylene-bis-fatty acid amide, such as N,N′-ethylene-bis-stearic acid amide or N,N′-ethylene-bis-oleic acid amide, one or more fatty acid alkanolamides, especially hydroxymethylated fatty acid amides, such as N-(hydroxymethyl)stearamide, N-hydroxymethylpalmitamide, hydroxyethylstearamide, one or more waxes, such as polyethylene wax, candelilla wax, carnauba wax or montan wax, one or more carboxylic acid esters, such as dimethylterephthalate, dibenzyl terephthalate, benzyl 4-benzyloxybenzoate, di-(4-methylbenzyl)oxalate, di-(4-chlorobenzyl)oxalate or di-(4-benzyl)oxalate, ketones, such as 4-acetylbiphenyl, one or more aromatic ethers, such as 1,2-diphenoxy-ethane, 1,2-di-(3-methylphenoxy)ethane, 2-benzyloxynaphthalene, 1,2-bis(phenoxymethyl)benzene or 1,4-diethoxynaphthalene, one or more aromatic sulfones, such as diphenylsulfone, and/or an aromatic sulfonamide, such as 2-, 3-, 4-toluenesulfonamide, benzenesulfonanilide or N-benzyl-4-toluenesulfonamide, or one or more aromatic hydrocarbons, such as 4-benzylbiphenyl, or combinations of the above compounds. These can be used alone or in any mixtures.

Stearamide is preferred because it has a favourable price-performance ratio.

The heat-sensitive material is preferably present in the heat-sensitive layer in an amount of from about 10 to about 80 wt. %, especially preferably in an amount of from about 25 to about 60 wt. %, in relation to the total solids content of the heat-sensitive layer.

Optionally, lubricants or release agents can also be present in the heat-sensitive layer. Such lubricants or release agents are present especially if there is no protective layer or no other layer on the heat-sensitive layer.

These agents are preferably fatty acid metal salts, such as zinc stearate or calcium stearate, or also behenate salts, synthetic waxes, e.g. in the form of fatty acid amides, such as stearic acid amide and behenic acid amide, fatty acid alkanolamides, such as stearic acid methylolamide, paraffin waxes of different melting points, ester waxes of different molecular weights, ethylene waxes, propylene waxes of different hardnesses and/or natural waxes, e.g. carnauba wax or montan wax. These can be used alone or in any mixtures.

Zinc stearate is preferred because it has a favourable price-performance ratio.

The lubricant or the release agent is preferably present in the heat-sensitive layer in an amount of from about 1 to about 10 wt. %, especially preferably in an amount of from about 3 to about 6 wt. %, in relation to the total solids content of the heat-sensitive layer.

In a further preferred embodiment, at least one binder is present in the heat-sensitive layer. This is preferably constituted by water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Partially saponified or semi-saponified polyvinyl alcohols are preferred, as they have a favourable price-performance ratio.

The binder is preferably present in the heat-sensitive layer in an amount of from 1 to 30 wt. %, preferably from 5 to 20 wt. %, in relation to the total solids content of the heat-sensitive layer.

In order to achieve specific application-related performance characteristics of heat-sensitive recording materials, the binder is preferably present in crosslinked form in the heat-sensitive layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the colour layer.

In another preferred embodiment, the heat-sensitive layer contains pigments. These pigments are preferably different from the pigments of the colour layer. The use of these has the advantage, among other things, that they can fix the chemical melt produced in the thermal printing process on their surface. Pigments can also be used to control the surface whiteness and opacity of the heat-sensitive layer and its printability with conventional printing inks.

Especially suitable pigments are inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Preferred are calcium carbonates, aluminium hydroxides and pyrogenic silicas, as they enable especially advantageous application properties of the heat-sensitive recording materials with regard to their subsequent printability with commercially available printing inks.

The pigments are preferably present in the heat-sensitive layer in an amount of from about 2 to about 50 wt. %, especially preferably in an amount of from about 5 to about 20 wt. %, in relation to the total solids content of the heat-sensitive layer.

The heat-sensitive layer may further comprise carbon black components and/or dyes/colour pigments.

To control the surface whiteness of the heat-sensitive recording material according to the invention, optical brighteners can be incorporated into the heat-sensitive colour-forming layer. These are preferably stilbenes.

The heat-sensitive layer may further contain inorganic oil-absorbing white pigments.

Examples of these inorganic oil-absorbing white pigments include natural or calcined kaolin, silica, bentonite, calcium carbonate, aluminium hydroxide, especially boehmite, and mixtures thereof.

The inorganic oil-absorbing white pigments are preferably present in the heat-sensitive layer in an amount of from about 2 to about 50 wt. %, especially preferably in an amount of from about 5 to about 20 wt. %, in relation to the total solids content of the heat-sensitive layer.

In order to improve certain coating properties, it is preferable in individual cases to add further constituents, especially rheology aids, such as thickeners and/or surfactants, to the constituents of the heat-sensitive recording material according to the invention.

The further constituents are each preferably present in customary amounts known to a person skilled in the art.

The heat-sensitive layer preferably has an area density of from 1 to 8 g/m², especially 2 to 6 g/m².

The heat-sensitive layer preferably has a thickness of from 1 to 10 μm, especially 2 to 8 μm.

In a further preferred embodiment, the heat-sensitive recording material is preferably characterised in that an insulation layer is present between the web-like support material and the colour layer.

In an alternative embodiment, the heat-sensitive recording material is preferably characterised in that the colour layer simultaneously constitutes a colour layer and also an insulation layer.

Such an insulation layer or a colour layer, which is simultaneously a colour layer and also an insulation layer, causes a reduction in heat conduction through the heat-sensitive recording material. This makes the local action of heat by means of a thermal direct printer more efficient and a higher thermal printer speed possible. The cover layer becomes translucent more quickly due to the amount of heat introduced and the sensitivity is thus improved.

This means that less dye is needed, which results in improved recyclability in the materials cycle, especially in the waste paper cycle (easier deinkability, separation of dye and support material components).

The insulation layer or the colour layer, which is simultaneously a colour layer and also an insulation layer, preferably has a Bekk smoothness of greater than 50 s, especially preferably of greater than 100 s and very especially preferably of 100 to 250 s.

The insulation layer or the colour layer, which is simultaneously a colour layer and also an insulation layer, preferably comprises a heat-insulating material.

Preferably, the heat-sensitive recording material comprising an insulation layer or a colour layer which is simultaneously also an insulation layer has a lower thermal conductivity than a heat-sensitive recording material that does not comprise an insulation layer or a colour layer which is simultaneously also an insulation layer.

The thermally insulating material preferably comprises kaolin, especially preferably calcined kaolin and mixtures thereof.

The thermally insulating material may also comprise hollow-sphere pigments, especially hollow-sphere pigments comprising styrene-acrylate copolymer.

These hollow-sphere pigments preferably have a glass transition temperature of from 40 to 80° C. and/or a mean particle size of 0.1 to 2.5 μm.

The thermally insulating material is preferably present in the insulation layer in an amount of from about 20 to about 80 wt. %, especially preferably in an amount of from about 40 to about 60 wt. %, in relation to the total solids content of the insulation layer.

In a colour layer which is simultaneously a colour layer and also an insulation layer, the thermally insulating material is preferably present therein in an amount of from about 30 to about 70 wt. %, especially preferably in an amount of from about 40 to about 60 wt. %, in relation to the total solids content of the colour layer which is simultaneously a colour layer and also an insulation layer.

In order to achieve specific application-related performance characteristics of heat-sensitive recording materials, the binder is preferably present in crosslinked form in the insulation layer and/or colour layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the insulation or colour layer.

The insulation layer preferably has an area density of from 1 to 5 g/m², especially 2 to 4 g/m².

The insulation layer preferably has a thickness of from 1 to 10 μm, especially from 2 to 8 μm.

The colour layer which is simultaneously a colour layer and also an insulation layer preferably has an area density of from 1 to 10 g/m², especially 3 to 8 g/m².

The colour layer which is simultaneously a colour layer and also an insulation layer preferably has a thickness of from 1 to 12 μm, especially from 4 to 8 μm.

In a further preferred embodiment, the heat-sensitive recording material is preferably characterised in that a layer comprising starch (starch coating) and/or modifications thereof (modified starches) is present directly on at least one side of the web-like support material, preferably directly on both sides of the web-like support material.

The starch coating is preferably applied in an amount of from 0.1 to 3, especially preferably from 0.2 to 1.5 g/m².

A starch coating on the side of the web-like support material on which the colour layer is present has the advantage of sealing the web-like support material and thus improving the adhesion of the colour layer and reducing or preventing penetration of the colour layer into the web-like support material.

A starch coating on the side of the web-like support material that does not have the colour layer has the advantage of reducing or preventing the colour layer from bleeding through the web-like support material.

The layer comprising starch preferably has a Bekk smoothness of greater than 20 s, especially preferably of greater than 50 s and very especially preferably from 50 to 200 s.

In a further preferred embodiment, the heat-sensitive recording material is preferably characterised in that a protective layer is present on the heat-sensitive layer.

The protective layer preferably has a Bekk smoothness of greater than 200 s, preferably of greater than 400 s, and very especially preferably of 400 s to 1500 s. A Bekk smoothness of 400 to 1300 s is most preferred.

This is present on the side of the heat-sensitive layer on which the colour layer does not lie.

This protective layer preferably comprises at least one binder and at least one pigment, especially preferably an inorganic pigment.

Suitable binders include water-soluble starches, starch derivatives, starch-based EcoSphere-type biolatices, methyl cellulose, hydroxyethyl cellulose, carboxymethyl cellulose, partially or fully saponified polyvinyl alcohols, chemically modified polyvinyl alcohols, such as acetoacetyl, diacetone, carboxy-, silanol-modified polyvinyl alcohols, or styrene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Suitable inorganic pigments include inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Suitable organic pigments include hollow pigments with a styrene/acrylate copolymer wall or urea/formaldehyde condensation polymers. These can be used alone or in any mixtures.

The binder is preferably present in the protective layer in an amount of from about 40 to about 90 wt. %, especially preferably in an amount of from about 50 to about 80 wt. %, in relation to the total solids content of the protective layer. The pigment is preferably present in the protective layer in an amount of from about 5 to about 40 wt. %, especially preferably in an amount of from about 10 to about 30 wt. %, in relation to the total solids content of the protective layer.

In order to achieve specific application-related performance characteristics of heat-sensitive recording materials, the binder is preferably present in crosslinked form in the protective layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0, especially preferably in an amount of from about 0.05 to about 15.0, in relation to the total solids content of the colour layer.

The crosslinker is preferably present in an amount of from about 0.01 to about 25.0 wt. %, especially preferably in an amount of from about 0.05 to about 15.0 wt. %, in relation to the total solids content of the protective layer.

The protective layer further preferably comprises at least one lubricant or at least one release agent.

These agents are preferably fatty acid metal salts, such as zinc stearate or calcium stearate, or also behenate salts, synthetic waxes, e.g. in the form of fatty acid amides, such as stearic acid amide and behenic acid amide, fatty acid alkanolamides, such as stearic acid methylolamide, paraffin waxes of different melting points, ester waxes of different molecular weights, ethylene waxes, propylene waxes of different hardnesses and/or natural waxes, e.g. carnauba wax or montan wax.

The lubricant or the release agent is preferably present in the protective layer in an amount of from about 1 to about 30 wt. %, especially preferably in an amount of from about 2 to about 20 wt. %, in relation to the total solids content of the protective layer.

To control the surface whiteness of the heat-sensitive recording material according to the invention, optical brighteners, preferably stilbenes, can be incorporated into the protective layer.

The protective layer preferably has an area density of from 0.3 to 5.0 g/m², especially from 1.0 to 3.0 g/m².

The protective layer preferably has a thickness of from 0.3 to 6.0 μm, especially from 0.5 to 2.0 μm.

The use of a protective layer has the advantage that the recording material is better protected against external influences.

In a further preferred embodiment, the heat-sensitive recording material is preferably characterised in that an adhesive layer is present on the web-like support material on the side on which the colour layer is not located.

If a starch coating is present, it lies between the web-like support material and the adhesive layer.

The adhesive layer preferably comprises at least one adhesive, preferably a heat-activatable adhesive, especially a pressure-sensitive adhesive.

Especially preferably, the adhesive, preferably the heat-activatable adhesive and especially the pressure-sensitive adhesive, is a rubber- and/or acrylate-based adhesive.

The adhesive layer preferably has an area density of from 1 to 40 g/m², especially 12 to 25 g/m².

In a further preferred embodiment, the heat-sensitive recording material is preferably characterised in that a siliconised release layer is present on the heat-sensitive layer.

The terms “siliconised release layer” and “siliconised layer” are to be understood synonymously in the sense of “to cover with a layer of silicone”. Preferably, these layers consist of silicone or comprise at least 90 wt. %, preferably at least 95 wt. % and especially preferably at least 99 wt. % and very especially preferably only silicone except for unavoidable traces or auxiliaries (e.g. for UV curing of a siliconisation fluid).

The siliconised release layer preferably has a Bekk smoothness of greater than 400 s, especially preferably greater than 800 s and very especially preferably from 800 to 2000 s.

If a protective layer, especially as defined above, is present on the heat-sensitive layer, the siliconised release layer is preferably located on this protective layer.

In a further preferred embodiment, the heat-sensitive recording material is preferably characterised in that a diffusion layer is formed between the siliconised layer and the underlying layer, preferably the heat-sensitive layer. This diffusion layer is preferably formed by diffusing, areally, at least parts of the siliconised release layer into the upper region of the underlying layer, wherein preferably 5 to 50 wt. %, especially preferably 6 to 45 wt. % and especially 7 to 40 wt. % of the siliconised release layer diffuse into the upper region of the underlying layer. Such a diffusion layer is described, for example, in EP 3 221 153 A1.

A siliconised release layer is preferably present when an adhesive layer, as described above, is also present.

The presence of a siliconised release layer on the heat-sensitive layer and of an adhesive layer on the web-like support material on the side where the colour layer is not located has the advantage that the heat-sensitive recording material can be used as a “linerless” heat-sensitive recording material.

The term “linerless” means that the (self-adhesive) heat-sensitive recording material according to the invention is not applied to a support material, but is wound onto itself. This has the advantage that the production costs can be further reduced, more running metres per roll can be realised, no disposal effort for the disposal of the liner is necessary, and more labels per specific loading space volume can be transported.

If a siliconised release layer is present, it is preferred that at least one platelet-shaped pigment is contained in the heat-sensitive layer or in the layer that lies directly below the siliconised release layer.

The at least one platelet-shaped pigment is preferably selected from the group consisting of kaolin, Al(OH)₃ and/or talc. The use of kaolin is especially preferred.

The use of a coating kaolin is very especially preferred. Such a coating kaolin is available under the trade name Kaolin ASP 109 (BASF, Germany).

The use of these platelet-shaped pigments, especially kaolin, has the particular advantage that the heat-sensitive layer or the layer that lies directly below the siliconised release layer can be siliconised very easily.

A platelet-shaped pigment is understood to mean a pigment in which the diameter to thickness ratio is between about 7 and 40 to 1, preferably between about 15 and 30 to 1.

The particle size of the platelet-shaped pigment is preferably set so that at least about 70%, preferably at least about 85%, of the particles have a particle size of about <2 μm (sedigraph). The pH value of the platelet-shaped pigment in aqueous solution is preferably 6 to 8.

The at least one platelet-shaped pigment is present in the heat-sensitive colour-forming layer or in the layer which lies directly below the siliconised release layer, preferably in an amount of from about 5 to about 60 wt. %, especially preferably in the amount of from about 15 to about 55 wt. %, in relation to the total solids content of the respective layer.

In a further preferred embodiment, the heat-sensitive recording material is preferably characterised in that the siliconised release layer comprises at least one siloxane, preferably a poly(organo)siloxane, especially an acrylic poly(organo)siloxane.

In a further embodiment, the siliconised release layer comprises a mixture of at least two siloxanes. Preferred is a mixture of at least two acrylic-poly(organo)siloxanes.

Examples of very especially preferred siloxanes are siloxanes available under the trade names TEGO® RC902 and TEGO® RC711 (Evonik, Germany).

In another embodiment, the heat-sensitive recording material is preferably characterised in that the siliconised release layer contains at least one polysilicone acrylate, preferably formed by condensation of at least one silicone acrylate.

The siliconised release layer is preferably water-free. It is also preferred that the siliconised release layer does not contain Pt catalysts.

The siliconised release layer preferably contains an initiator, especially preferably a photoinitiator. This serves for the radical curing of the silicone.

Very especially preferred here is the TEGO® photoinitiator A18 (from Evonik, Germany).

The siliconised release layer may preferably contain further additives, such as matting agents and/or adhesion additives.

The siliconised release layer preferably has an area density of from 0.3 to 5.0 g/m², especially 1.0 to 3.0 g/m².

The siliconised release layer preferably has a thickness of from 0.3 to 6.0 μm, especially from 0.5 to 2.0 μm.

In a further preferred embodiment, the heat-sensitive recording material is preferably characterised in that the heat-sensitive recording material has a residual moisture of from 2 to 14%, preferably from 2 to 12% and very especially preferably from 3 to 10%. A residual moisture of from 3 to 8% is most preferred.

The residual moisture can be determined as described in conjunction with the examples.

It is assumed that the opacity in the heat-sensitive layer is not only generated by the scattering particles, especially the polymer particles, themselves, but also by the air trapped between the scattering particles, especially the polymer particles (open porosity). Penetration of moisture into these “pores” displaces air and reduces opacity. This can result in a greyer material that is not preferred.

In a further preferred embodiment, the heat-sensitive recording material is preferably characterised in that the heat-sensitive recording material has a surface whiteness of from 35 to 60%, especially from 45 to 50%.

A residual moisture in the specified range has the advantage that, after printing, there is a high relative print contrast with advantageous application-related properties, such as better legibility.

The surface whiteness (paper whiteness) can be determined according to ISO 2470-2 (2008) with an Elrepho 3000 spectrophotometer.

In a further preferred embodiment, the heat-sensitive recording material is preferably characterised in that the contrast from locations where the heat-sensitive layer has become translucent due to local action of heat to locations where the heat-sensitive layer has not become translucent due to local action of heat is 40 to 80%, especially from 50 to 70%.

This contrast can be calculated by taking the difference between the optical density of the background and the script. The measurement of the optical density (o. D.) is done, for example, by means of a densitometer.

All of the above-mentioned layers can be single- or multi-ply.

The heat-sensitive recording material according to the invention can be obtained by known production methods.

The present invention also relates to a production method for a heat-sensitive recording material as described above.

It is preferred to obtain the heat-sensitive recording material according to the invention by a method in which (aqueous) suspensions comprising the starting materials of the individual layers are successively applied to the web-like support material, the (aqueous) application suspensions having a solids content of from 8 to 50 wt. %, preferably from 10 to 40 wt. %, and being applied by the curtain coating process at an operating speed of the coating facility of at least 200 m/min.

This method is especially advantageous from economic points of view and due to the even application over the web-like support material.

If the value of the solids content falls below about 8 wt. %, then the economic efficiency deteriorates, since a large amount of water has to be removed by gentle drying in a short space of time, which has a detrimental effect on the coating speed. On the other hand, if the value of 60 wt. % is exceeded, then this only leads to an increased technical effort to ensure the stability of the coating curtain material during the coating process and the drying of the applied film, since the machine has to run very quickly again in this case.

In the curtain coating process, a free-falling curtain of coating dispersion is formed. The coating dispersion, which is in the form of a thin film (curtain), is “poured” by free fall onto a substrate in order to apply the coating dispersion to the substrate. Document DE 10 196 052 T1 discloses the use of the curtain coating process in the production of information recording materials, wherein multi-layer recording layers are realised by applying the curtain, consisting of a plurality of coating dispersion films, to substrates.

Embodiments of the method according to the invention in which a “double curtain” is used are also conceivable. This means that two successive layers are applied immediately successively. The application is performed here immediately successively so that the first applied layer has not yet dried before the next layer is applied. The two layers are thus preferably applied “wet-on-wet”.

All definitions in relation to the curtain coating process apply similarly for the double curtain coating process.

The advantage of a wet-on-wet application by means of a double curtain coating process is that the two layers have a stronger connection and especially it is possible to dispense with an adhesion promoter arranged in between.

In a preferred embodiment of the method according to the invention, the aqueous deaerated application suspension has a viscosity of about 100 to about 1000 mPas (Brookfield, 100 rpm, 20° C.). If the viscosity falls below the value of about 100 mPas or exceeds the value of about 1000 mPas, this leads to poor runnability of the coating medium at the coating unit. The viscosity of the aqueous deaerated application suspension is especially preferably about 200 to about 500 mPas. The viscosities of successive coating media in the double curtain process should decrease from bottom to top. In the event of incorrectly set coatings, the likelihood of the formation of a heel at the point where the curtain contacts increases, as does the occurrence of “wetting defects”.

In a preferred embodiment, the surface tension of the aqueous coating suspension can be set to about 25 to about 70 mN/m, preferably to about 35 to about 60 mN/m (measured according to the standard for bubble pressure tensiometry (ASTM D 3825-90), as described below), to optimise the process. Better control over the coating process is obtained by determining the dynamic surface tension of the coating material and adjusting it in a targeted manner by selecting the appropriate surfactant and by determining the required amount of surfactant.

The dynamic surface tension is measured by means of a bubble pressure tensiometer. The maximum internal pressure of a gas bubble formed via a capillary in a liquid is measured. The internal pressure p of a spherical gas bubble (Laplace pressure) depends on the radius of curvature r and the surface tension a according to the Young-Laplace equation:

$$\\ p = \frac{2 σ}{r}$$

If a gas bubble is created at the tip of a capillary in a liquid, the curvature first increases and then decreases again, resulting in a pressure maximum. The greatest curvature and thus the greatest pressure occur when the radius of curvature is equal to the capillary radius.

Pressure curve during bubble pressure measurement, position of the pressure maximum:

The radius of the capillary is determined with a reference measurement, which is carried out with a liquid of known surface tension, usually water. If the radius is then known, the surface tension can be calculated from the pressure maximum pmax. Since the capillary is immersed in the liquid, the hydrostatic pressure p0, which results from the immersion depth and the density of the liquid, must be subtracted from the measured pressure (this is done automatically in the case of modern measuring instruments). This results in the following formula for the bubble pressure method:

$$\\ σ = \frac{( {p}_{max} - {p}_{0} ) \cdot r}{2}$$

The measured value corresponds to the surface tension at a certain surface age, the time from the beginning of bubble formation to the occurrence of the pressure maximum. By varying the speed at which the bubbles are generated, the dependence of the surface tension on the surface age can be recorded, resulting in a curve in which the surface tension is plotted over time.

This dependence plays an important role for the use of surfactants, since the equilibrium value of the interfacial tension is not reached at all in many processes due to the sometimes low diffusion rates and adsorption rates of surfactants.

The individual layers can be formed on-line or in a separate coating process off-line.

Especially, to ensure that the layers described in detail above have the Bekk smoothnesses mentioned above, the following method steps are preferably carried out.

The web-like support material is preferably smoothed in a first cylinder. This one-sided or two-sided high smoothness, which is produced by this process technology, already imparts an advantage to the web-like support material. An additional calendering by a downstream calender, preferably before a first coater, can further improve the smoothness and/or serves for a good profiling.

If a starch coating, as defined above, is applied, this is preferably done by a film press before the colour layer is applied by means of a blade coater.

The thickness on the reverse side especially is advantageous in order to prevent the coating colour from bleeding through with the blade coater.

It would also be possible to apply the colour layer directly with a film press. However, there would be a disadvantage in terms of smoothness development compared to a blade coater. The use of a blade coater gives the material a good base smoothness for the important dynamic sensitivity of the final product. There is a correlation between final smoothness and dynamic sensitivity.

It would also be conceivable to apply the colour layer with a film press or even with a curtain coater. The advantage of smoothness is then eliminated, but could also be made up for with a calender, especially with a film press. However, this only makes sense if no hollow spheres are used, as these would be destroyed by the film press.

The insulation layer, if present, is applied analogously.

The siliconised layer, if present, is also applied analogously.

The same applies for the protective layer, if present. If present, the protective layer can alternatively be printed on. Protective coatings that can be cured by means of actinic radiation are especially suitable for processing and with regard to their technological properties. The term “actinic radiation” is understood to mean UV or ionising radiation, such as electron beams.

The heat-sensitive layer is preferably applied by curtain coating, as described above.

If web-like support materials, especially papers, are coated on one side, the resulting curl should then be evened out.

This is preferably done with an LAS dampening system (LAS Liquid Applicator System). For this purpose, a film of water is applied to the less coated side and then dried. In this way, the so-called flatness is obtained again. When applying the water film, the surface is slightly deteriorated.

A preferred variant for protecting the surface would be a steam humidifier. Here, steam is blown on instead of water being applied. The surface is not damaged during this process. This is very suitable for applications where the highest surface quality must be achieved.

Another option would be a spray dampener, where a mist of water is applied.

All of the above-mentioned layers can be single- or multi-ply.

The present invention further relates to a heat-sensitive recording material obtainable by the method described above.

The present invention also relates to the use of a heat-sensitive recording material as described above as a sales receipt roll, as an adhesive label (roll), also in the refrigeration and deep-freeze sector, and as a ticket (roll). These have especially a functional side and/or reverse side (with colour, coloured, black/grey) and can be pre-printed. These rolls are preferably available in typical widths and lengths.

In a second aspect, the present invention relates to a heat-sensitive recording material comprising a colour layer on one side of the web-like support material and
a heat-sensitive layer on the colour layer so that the colour layer is at least partially covered,
the heat-sensitive layer being designed so that it becomes translucent due to local action of heat, so that the underlying colour layer becomes visible, characterised in that
the heat-sensitive recording material has a residual moisture of from 2 to 14%, preferably from 2 to 12% and especially preferably from 3 to 10%. A residual moisture of from 3 to 8% is most preferred.

A residual moisture in the specified range has the advantage that, after printing, there is a high relative print contrast with advantageous application-related properties, such as better legibility.

The residual moisture can be determined as described in conjunction with the examples.

It is assumed that the opacity in the heat-sensitive layer is not only generated by the scattering particles, especially the polymer particles, but also by the air trapped between the scattering particles, especially the polymer particles (open porosity). Penetration of moisture into these “pores” displaces air and reduces opacity. This can result in a greyer material that is not preferred.

In a further preferred embodiment, the heat-sensitive recording material is preferably characterised in that the heat-sensitive recording material has a surface whiteness of from 35 to 60%, especially from 45 to 50%.

The surface whiteness (paper whiteness) can be determined according to ISO 2470-2 (2008) with an Elrepho 3000 spectrophotometer.

In a further preferred embodiment, the heat-sensitive recording material is preferably characterised in that the contrast from locations where the heat-sensitive layer has become translucent due to local action of heat to locations where the heat-sensitive layer has not become translucent due to local action of heat is 40 to 80%, especially from 50 to 70%.

This contrast can be calculated by taking the difference between the optical density of the background and the script. The measurement of the optical density (o. D.) is done, for example, by means of a densitometer.

Preferably, the support material has a Bekk smoothness of greater than 20 s, especially preferably of greater than 30 s and very especially preferably of greater than 50 s on the side to which the colour layer is applied.

The colour layer preferably has a Bekk smoothness of greater than 50 s, especially preferably of greater than 100 s and very especially preferably of greater than 150 s on the side to which the heat-sensitive layer is applied.

The heat-sensitive layer preferably has a Bekk smoothness of greater than 100 s, especially preferably of greater than 150 s, on the side on which the colour layer is not located.

Preferably, the support material has a Bekk smoothness of 20 to 400 s, especially preferably 30 to 300 s and very especially preferably 50 to 200 s on the side to which the colour layer is applied. A Bekk smoothness of 50 to 150 s is most preferred.

The colour layer preferably has a Bekk smoothness of 50 to 400 s, especially preferably 100 to 250 s and very especially preferably 150 to 250 s on the side to which the heat-sensitive layer is applied.

Such a heat-sensitive recording material has the advantage of high dynamic sensitivity.

It is advantageous to already present a smooth web-like support material and to maintain this smoothness over the individual coatings. The smoother the substrate is built up from below, the better the final smoothness and thus the sensitivity of the end product.

It is preferred that each layer applied to the web-like support material has a Bekk smoothness on its upper side, i.e. on the side on which the web-like support material does not lie, that is at least as great as or greater than that of the underlying layer.

Preferably, each layer applied to the web-like support material has a Bekk smoothness of at least 5% (percentage increase) on its upper side, i.e. on the side on which the web-like support material does not lie, compared to the underlying layer.

Preferably, each layer applied to the web-like support material has a Bekk smoothness of at least 5% (absolute increase) on its upper side, i.e. on the side on which the web-like support material does not lie, compared to the underlying layer.

The web-like support material is in principle not limited. In a preferred embodiment, the web-like support material comprises paper, synthetic paper and/or a plastics film. The support material preferably has an area density of from 30 to 100 g/m², especially from 40 to 80 g/m².

The web-like support material of the heat-sensitive recording material according to the invention preferably comprises at least one black or coloured side, which is achieved by applying a colour layer. The term “coloured side” is understood to mean that the side has a colour other than white or black. In other words, the heat-sensitive recording material comprises at least one side which is coloured such that it is not white. Embodiments are also possible in which the at least one black or coloured side has several different colours, also in combination with the colour black.

The at least one colour layer on one side of the web-like support material is preferably characterised in that the colour layer comprises at least one pigment and/or a dye and also preferably a binder.

The pigments and/or dyes include various organic and inorganic pigments, dyes and/or carbon black. These can be used alone or in any mixtures.

The pigment, the dye and/or the carbon black are preferably each present in the colour layer in an amount of from 2 to 50 wt. %, especially preferably from 10 to 35 wt. %, in relation to the total solids content of the colour layer.

Preferred binders are water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

The binder is preferably present in the colour layer in an amount of from 2 to 40 wt. %, especially preferably from 10 to 30 wt. %, in relation to the total solids content of the colour layer.

The colour layer preferably has an area density of from 1 to 10 g/m², especially from 3 to 8 g/m².

The colour layer preferably has a thickness of from 1 to 10 μm, especially from 2 to 8 μm.

In a further preferred embodiment, the heat-sensitive recording material is characterised in that the heat-sensitive layer comprises at least one scattering particle, especially a polymer particle, having a glass transition temperature of from −55 to 130° C., preferably from 40 to 80° C.

In a further preferred embodiment, the heat-sensitive recording material is characterised in that the heat-sensitive layer comprises at least one scattering particle, especially a polymer particle, having a core/casing structure, wherein the scattering particle, especially polymer particle, is selected from the group consisting of (i) scattering particles, especially polymer particles, having an outer polymer shell with a glass transition temperature of from 40° C. to 80° C. and (ii) scattering particles, especially polymer particles, having an inner shell with a glass transition temperature of from 40° C. to 130° C. and an outer shell with a glass transition temperature of from −55° C. to 50° C., wherein the glass transition temperature of the outer shell is preferably lower than that of the inner shell.

In a further preferred embodiment, the heat-sensitive recording material is characterised in that the heat-sensitive layer comprises at least one scattering particle, especially a polymer particle, having a melting temperature lower than 250° C., preferably from 0° C. to 250° C.

In a further preferred embodiment, the heat-sensitive recording material is characterised in that the heat-sensitive layer comprises at least one scattering particle, especially a polymer particle, having a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a glass transition temperature of from −55 to 130° C., preferably from 40 to 80° C., and having a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a core/casing structure, wherein the scattering particles, especially polymer particles, are selected from the group consisting of (i) scattering particles, especially polymer particles, having an outer shell with a glass transition temperature of from 40° C. to 80° C. and (ii) scattering particles, especially polymer particles, having an inner shell with a glass transition temperature of from 40° C. to 130° C. and an outer shell with a glass transition temperature of from −55° C. to 50° C., wherein the glass transition temperature of the outer shell is preferably lower than that of the inner shell, and with a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a melting temperature lower than 250° C., preferably from 0° C. to 250° C., and having a mean particle size in the range of from 0.1 to 2.5 μm, preferably from 0.2 to 0.8 μm.

A glass transition temperature or a melting temperature lower than 250° C. was found to be advantageous. Above temperatures of 250° C., thermal direct printing is not possible because the temperature-time window is outside the printer specification.

A mean particle size in the range of from 0.1 to 2.5 μm is advantageous, as particles of this size scatter the visible light and thus the colour layer is covered to the greatest possible extent.

The mean particle size can be determined using a Beckman Coulter device (laser diffraction, Fraunhofer method).

The scattering particles, especially the polymer particles, are preferably crystalline, semi-crystalline and/or amorphous.

The above-stated glass transition temperatures refer to semi-crystalline or amorphous scattering particles, especially polymer particles. The melting temperatures refer to crystalline scattering particles, especially polymer particles, or to the crystalline portion of the scattering particles, especially polymer particles.

The primary property of the scattering particles, preferably the polymer particles, is light scattering in the visible range of light. The secondary property is thermal sensitivity.

The polymer particles preferably comprise thermoplastic polymers.

The polymer particles preferably comprise polymers resulting from the polymerisation of one or more monomers selected from the group comprising acrylonitrile, styrene, butadiene, benzyl methacrylate, phenyl methacrylate, ethyl methacrylate, divinylbenzene, 2-hydroxyethyl methacrylate, cyclohexyl methacrylate, 2-methylstyrene, 3-methylstyrene, 4-methylstyrene, alpha-methylstyrene, beta-methylstyrene, acrylamide, methacrylamide, methacrylonitrile, hydroxypropyl methacrylate, methoxystyrene, N-acrylylglycinamide and/or N-methacrylylglycinamide and/or derivatives thereof.

In another embodiment, the polymer particles may be polymerised using a variety of ethylenically unsaturated monomers. Examples of non-ionic monoethylenically unsaturated monomers include styrene, vinyl toluene, ethylene, vinyl acetate, vinyl chloride, vinylidene chloride, acrylonitrile, (meth)acrylamide, various (C₁-C₂₀)-alkyl or (C₃-C₂₀)-alkenyl esters of (meth)acrylic acid, including methyl acrylate (MA), methyl methacrylate (MMA), ethyl (meth)acrylate, butyl (meth)acrylate, 2-hydroxyethyl (meth)acrylate, 2-ethylhexyl (meth)acrylate, benzyl (meth)acrylate, lauryl (meth)acrylate, oleyl (meth)acrylate, palmityl (meth)acrylate and stearyl (meth)acrylate. Typically, acrylic esters such as MMA, EA, BA and styrene are preferred monomers for polymerisation and formation of the shell of the polymer particles. Difunctional vinyl monomers such as divinylbenzene, allyl methacrylate, ethylene glycol dimethacrylate, 1,3-butanediol dimethacrylate, diethylene glycol dimethacrylate, trimethylolpropane trimethacrylate and the like can also be copolymerised to form a crosslinked outer casing, as described in US patent application 2003-0176535 A1.

In another embodiment, the polymer particles preferably comprise (meth)acrylonitrile copolymers, polyvinyl chloride, polyvinylidene chloride, polystyrene, styrene acrylate, styrene (meth)acrylate copolymers, polyacrylonitrile, polyacrylic acid esters or also mixtures of at least two thereof.

The strength and durability of the polymer particles can be influenced by the crosslinking of polymer chains.

The polymer particles may be in the form of closed polymer particles, open polymer particles and/or solid-body particles, each of which can be regularly or irregularly shaped.

Examples of closed hollow-body particles include hollow-spherical polymer particles, or polymer particles with a core/casing structure.

Examples of hollow-spherical polymer particles or polymer particles with a core/casing structure are Ropaque HP-1055, Ropaque OP-96 and Ropaque TH-1000.

Especially, so-called “cup-shaped” polymer particles can be mentioned as examples of open polymer particles. With regard to the casing, these have the same materials as the closed polymer particles, especially the closed hollow-spherical polymer particles. In contrast to the classic hollow-body pigments, in which an inner core of gas, usually air, is completely enclosed by a casing formed of organic, usually thermoplastic components, the “cup-shaped” pigments do not have a closed casing and only surround the inner core in the form of a shell or “cup”, which is closed to the greatest possible extent.

As further examples of open polymer particles, lattice cage-shaped polymer particles as described in WO 2021/062230 A1 can be mentioned.

Examples of solid-body particles are polyethylene, polystyrene and cellulose esters.

The above-mentioned scattering particles, especially the polymer particles, can be regularly or irregularly shaped.

In an alternative embodiment, the polymer particles are spherical solid-body particles, preferably irregularly shaped, and/or spherical hollow-body particles, both preferably in the form of droplets. These preferably comprise polystyrene, for example Plastic Pigment 756A from Trinseo LLC., and Plastic Pigment 772HS from Trinseo LLC., polyethylene, for example Chemipear 10 W401 from Mitsui Chemical Inc., spherical hollow-body particles (HSP)/spherical hollow-body pigments, for example Ropaque TH-500EF from The Dow Chemical Co., modified polystyrene particles, for example Joncryl 633 from BASF Corp., 1,2-diphenoxyethane (DPE, also known under the name diphenoxyethane), ethylene glycol m-tolyl ether (EGTE) and/or diphenyl sulfone (DPS). These can be used alone or in any mixtures. These polymer particles preferably have a mean particle size of 0.2 μm, 0.3 μm, 0.4 μm, 0.45 μm, 0.75 μm or 1.0 μm.

The scattering particles, especially polymer particles, are preferably present in the heat-sensitive layer in an amount of from 20 wt. % to 60 wt. %, preferably from 30 wt. % to 50 wt. % in relation to the solids content of the heat-sensitive layer.

Preferably, the heat-sensitive layer comprises at least one heat-sensitive material having a melting temperature in the range of from 40 to 200° C., preferably from 80 to 140° C., and/or a glass transition temperature in the range of from 40 to 200° C., preferably from 80 to 140° C.

Preferably, the heat-sensitive layer comprises at least one heat-sensitive material having a mean particle size of from 0.2 to 4.0 μm, preferably from 0.5 to 2.0 μm.

The heat-sensitive material also preferably contributes to the opacity (covering power) of the heat-sensitive layer, e.g. by absorbing and/or also scattering light.

It is assumed that the heat-sensitive material quickly melts locally due to local exposure to heat by the thermal print head of the thermal direct printer, resulting in a local “softening” of the polymer particles, and thus in a local reduction of the covering force (opacity reduction), so that the cover layer becomes translucent and the underlying colour layer becomes visible.

The heat-sensitive material can also be called a sensitiser or thermal solvent.

Preferably, the heat-sensitive material comprises one or more fatty acids, such as stearic acid, behenic acid or palmitic acid, one or more fatty acid amides, such as stearamide, behenamide or palmitamide, an ethylene-bis-fatty acid amide, such as N,N′-ethylene-bis-stearic acid amide or N,N′-ethylene-bis-oleic acid amide, one or more fatty acid alkanolamides, especially hydroxymethylated fatty acid amides, such as N-(hydroxymethyl)stearamide, N-hydroxymethylpalmitamide, hydroxyethylstearamide, one or more waxes, such as polyethylene wax, candelilla wax, carnauba wax or montan wax, one or more carboxylic acid esters, such as dimethylterephthalate, dibenzyl terephthalate, benzyl 4-benzyloxybenzoate, di-(4-methylbenzyl)oxalate, di-(4-chlorobenzyl)oxalate or di-(4-benzyl)oxalate, ketones, such as 4-acetylbiphenyl, one or more aromatic ethers, such as 1,2-diphenoxy-ethane, 1,2-di-(3-methylphenoxy)ethane, 2-benzyloxynaphthalene, 1,2-bis(phenoxymethyl)benzene or 1,4-diethoxynaphthalene, one or more aromatic sulfones, such as diphenylsulfone, and/or an aromatic sulfonamide, such as 2-, 3-, 4-toluenesulfonamide, benzenesulfonanilide or N-benzyl-4-toluenesulfonamide, or one or more aromatic hydrocarbons, such as 4-benzylbiphenyl, or combinations of the above compounds. These can be used alone or in any mixtures.

Stearamide is preferred because it has a favourable price-performance ratio.

The heat-sensitive material is preferably present in the heat-sensitive layer in an amount of from about 10 to about 80 wt. %, especially preferably in an amount of from about 25 to about 60 wt. %, in relation to the total solids content of the heat-sensitive layer.

Optionally, lubricants or release agents can also be present in the heat-sensitive layer. Such lubricants or release agents are present especially if there is no protective layer or no other layer on the heat-sensitive layer.

These agents are preferably fatty acid metal salts, such as zinc stearate or calcium stearate, or also behenate salts, synthetic waxes, e.g. in the form of fatty acid amides, such as stearic acid amide and behenic acid amide, fatty acid alkanolamides, such as stearic acid methylolamide, paraffin waxes of different melting points, ester waxes of different molecular weights, ethylene waxes, propylene waxes of different hardnesses and/or natural waxes, e.g. carnauba wax or montan wax. These can be used alone or in any mixtures.

Zinc stearate is preferred because it has a favourable price-performance ratio.

The lubricant or the release agent is preferably present in the heat-sensitive layer in an amount of from about 1 to about 10 wt. %, especially preferably in an amount of from about 3 to about 6 wt. %, in relation to the total solids content of the heat-sensitive layer.

In a further preferred embodiment, at least one binder is present in the heat-sensitive layer. This is preferably constituted by water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Partially saponified or semi-saponified polyvinyl alcohols are preferred, as they have a favourable price-performance ratio.

The binder is preferably present in the heat-sensitive layer in an amount of from 1 to 30 wt. %, preferably from 5 to 20 wt. %, in relation to the total solids content of the heat-sensitive layer.

In order to achieve specific application-related performance characteristics of heat-sensitive recording materials, the binder is preferably present in crosslinked form in the heat-sensitive layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the colour layer.

In another preferred embodiment, the heat-sensitive layer contains pigments.

These pigments are preferably different from the pigments of the colour layer.

The use of these has the advantage, among other things, that they can fix the chemical melt produced in the thermal printing process on their surface. Pigments can also be used to control the surface whiteness and opacity of the heat-sensitive layer and its printability with conventional printing inks.

Especially suitable pigments are inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Preferred are calcium carbonates, aluminium hydroxides and pyrogenic silicas, as they enable especially advantageous application properties of the heat-sensitive recording materials with regard to their subsequent printability with commercially available printing inks.

The pigments are preferably present in the heat-sensitive layer in an amount of from about 2 to about 50 wt. %, especially preferably in an amount of from about 5 to about 20 wt. %, in relation to the total solids content of the heat-sensitive layer.

The heat-sensitive layer may further comprise carbon black components and/or dyes/colour pigments.

To control the surface whiteness of the heat-sensitive recording material according to the invention, optical brighteners can be incorporated into the heat-sensitive colour-forming layer. These are preferably stilbenes.

The heat-sensitive layer may further contain inorganic oil-absorbing white pigments.

Examples of these inorganic oil-absorbing white pigments include natural or calcined kaolin, silica, bentonite, calcium carbonate, aluminium hydroxide, especially boehmite, and/or mixtures thereof.

The inorganic oil-absorbing white pigments are preferably present in the heat-sensitive layer in an amount of from about 2 to about 50 wt. %, especially preferably in an amount of from about 5 to about 20 wt. %, in relation to the total solids content of the heat-sensitive layer.

In order to improve certain coating properties, it is preferable in individual cases to add further constituents, especially rheology aids, such as thickeners and/or surfactants, to the constituents of the heat-sensitive recording material according to the invention.

The further constituents are each preferably present in customary amounts known to a person skilled in the art.

The heat-sensitive layer preferably has an area density of from 1 to 8 g/m², especially 2 to 6 g/m².

The heat-sensitive layer preferably has a thickness of from 1 to 10 μm, especially 2 to 8 μm.

In a further preferred embodiment, the heat-sensitive recording material is preferably characterised in that an insulation layer is present between the web-like support material and the colour layer.

In an alternative embodiment, the heat-sensitive recording material is preferably characterised in that the colour layer simultaneously constitutes a colour layer and also an insulation layer.

Such an insulation layer or a colour layer, which is simultaneously a colour layer and also an insulation layer, causes a reduction in heat conduction through the heat-sensitive recording material. This makes the local action of heat by means of a thermal direct printer more efficient and a higher thermal printer speed possible. The cover layer becomes translucent more quickly due to the amount of heat introduced and the sensitivity is thus improved.

This means that less dye is needed, which results in improved recyclability in the materials cycle, especially in the waste paper cycle (easier deinkability, separation of dye and support material components).

The insulation layer or the colour layer, which is simultaneously a colour layer and also an insulation layer, preferably has a Bekk smoothness of greater than 50 s, especially preferably of greater than 100 s and very preferably of 100 to 250 s.

The insulation layer or the colour layer, which is simultaneously a colour layer and also an insulation layer, preferably comprises a heat-insulating material.

Preferably, the heat-sensitive recording material comprising an insulation layer or a colour layer which is simultaneously also an insulation layer has a lower thermal conductivity than a heat-sensitive recording material that does not comprise an insulation layer or a colour layer which is simultaneously also an insulation layer.

The thermally insulating material preferably comprises kaolin, especially preferably calcined kaolin and mixtures thereof.

The thermally insulating material may also comprise hollow-sphere pigments, especially hollow-sphere pigments comprising styrene-acrylate copolymer.

These hollow-sphere pigments preferably have a glass transition temperature of from 40 to 80° C. and/or a mean particle size of 0.1 to 2.5 μm.

The thermally insulating material is preferably present in the insulation layer in an amount of from about 20 to about 80 wt. %, especially preferably in an amount of from about 40 to about 60 wt. %, in relation to the total solids content of the insulation layer.

In a colour layer which is simultaneously a colour layer and also an insulation layer, the thermally insulating material is preferably present therein in an amount of from about 30 to about 70 wt. %, especially preferably in an amount of from about 40 to about 60 wt. %, in relation to the total solids content of the colour layer which is simultaneously a colour layer and also an insulation layer.

In order to achieve specific application-related performance characteristics of heat-sensitive recording materials, the binder is preferably present in crosslinked form in the insulation layer and/or colour layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the insulation or colour layer.

The insulation layer preferably has an area density of from 1 to 10 g/m², especially 2 to 8 g/m².

The insulation layer preferably has a thickness of from 2 to 8 μm, especially from 4 to 6 μm.

The colour layer which is simultaneously a colour layer and also an insulation layer preferably has an area density of from 1 to 10 g/m², especially 3 to 8 g/m².

The colour layer which is simultaneously a colour layer and also an insulation layer preferably has a thickness of from 1 to 10 μm, especially from 4 to 8 μm.

In a further preferred embodiment, the heat-sensitive recording material is preferably characterised in that a layer comprising starch (starch coating) and/or modifications thereof (modified starches) is present directly on at least one side of the web-like support material, preferably directly on both sides of the web-like support material.

The starch coating is preferably applied in an amount of from 0.1 to 3, especially preferably from 0.2 to 1.5 g/m².

A starch coating on the side of the web-like support material on which the colour layer is present has the advantage of sealing the web-like support material and thus improving the adhesion of the colour layer and reducing or preventing penetration of the colour layer into the web-like support material.

A starch coating on the side of the web-like support material that does not have the colour layer has the advantage of reducing or preventing the colour layer from bleeding through the web-like support material.

The layer comprising starch preferably has a Bekk smoothness of greater than 20 s, especially preferably of greater than 50 s and very especially preferably from 50 to 200 s.

In a further preferred embodiment, the heat-sensitive recording material is preferably characterised in that a protective layer is present on the heat-sensitive layer.

The protective layer preferably has a Bekk smoothness of greater than 200 s, especially preferably of greater than 400 s and very especially preferably from 400 to 1500 s. A Bekk smoothness of 400 to 1300 s is most preferred.

This is present on the side of the heat-sensitive layer on which the colour layer does not lie.

This protective layer preferably comprises at least one binder and at least one pigment, especially preferably an inorganic pigment.

Suitable binders include water-soluble starches, starch derivatives, starch-based EcoSphere-type biolatices, methyl cellulose, hydroxyethyl cellulose, carboxymethyl cellulose, partially or fully saponified polyvinyl alcohols, chemically modified polyvinyl alcohols, such as acetoacetyl, diacetone, carboxy-, silanol-modified polyvinyl alcohols, or styrene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Suitable inorganic pigments include inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Suitable organic pigments include hollow pigments with a styrene/acrylate copolymer wall or urea/formaldehyde condensation polymers. These can be used alone or in any mixtures.

The binder is preferably present in the protective layer in an amount of from about 40 to about 90 wt. %, especially preferably in an amount of from about 50 to about 80 wt. %, in relation to the total solids content of the protective layer.

The pigment is preferably present in the protective layer in an amount of from about 5 to about 40 wt. %, especially preferably in an amount of from about 10 to about 30 wt. %, in relation to the total solids content of the protective layer.

In order to achieve specific application-related performance characteristics of heat-sensitive recording materials, the binder is preferably present in crosslinked form in the protective layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0, especially preferably in an amount of from about 0.05 to about 15.0, in relation to the total solids content of the colour layer.

The protective layer further preferably comprises at least one lubricant or at least one release agent.

These agents are preferably fatty acid metal salts, such as zinc stearate or calcium stearate, or also behenate salts, synthetic waxes, e.g. in the form of fatty acid amides, such as stearic acid amide and behenic acid amide, fatty acid alkanolamides, such as stearic acid methylolamide, paraffin waxes of different melting points, ester waxes of different molecular weights, ethylene waxes, propylene waxes of different hardnesses and/or natural waxes, e.g. carnauba wax or montan wax.

The lubricant or the release agent is preferably present in the protective layer in an amount of from about 1 to about 30 wt. %, especially preferably in an amount of from about 2 to about 20 wt. %, in relation to the total solids content of the protective layer.

The protective layer preferably has an area density of from 0.3 to 5.0 g/m², especially from 1.0 to 3.0 g/m².

To control the surface whiteness of the heat-sensitive recording material according to the invention, optical brighteners, preferably stilbenes, can be incorporated into the protective layer.

The protective layer preferably has a thickness of from 0.5 to 6.0 μm, especially from 0.5 to 2.0 μm.

The use of a protective layer has the advantage that the recording material is better protected against external influences.

In a further preferred embodiment, the heat-sensitive recording material is preferably characterised in that an adhesive layer is present on the web-like support material on the side on which the colour layer is not located.

If a starch coating is present, it lies between the web-like support material and the adhesive layer.

The adhesive layer preferably comprises at least one adhesive, preferably a heat-activatable adhesive, especially a pressure-sensitive adhesive.

Especially preferably, the adhesive, preferably the heat-activatable adhesive and especially the pressure-sensitive adhesive, is a rubber- and/or acrylate-based adhesive.

The adhesive layer preferably has an area density of from 10 to 40 g/m², especially 12 to 25 g/m².

In a further preferred embodiment, the heat-sensitive recording material is preferably characterised in that a siliconised release layer is present on the heat-sensitive layer.

The terms “siliconised release layer” and “siliconised layer” are to be understood synonymously in the sense of “to cover with a layer of silicone”. Preferably, these layers consist of silicone or comprise at least 90 wt. %, preferably at least 95 wt. % and especially preferably at least 99 wt. % and very especially preferably only silicone except for unavoidable traces or auxiliaries (e.g. for UV curing of a siliconisation fluid).

The siliconised release layer preferably has a Bekk smoothness of greater than 400 s, especially preferably greater than 800 s and very especially preferably from 800 to 2000 s.

If a protective layer, especially as defined above, is present on the heat-sensitive layer, the siliconised release layer is preferably located on this protective layer.

In a further preferred embodiment, the heat-sensitive recording material is preferably characterised in that a diffusion layer is formed between the siliconised layer and the underlying layer, preferably the heat-sensitive layer. This diffusion layer is preferably formed by diffusing, areally, at least parts of the siliconised release layer into the upper region of the underlying layer, wherein preferably 5 to 50 wt. %, especially preferably 6 to 45 wt. % and especially 7 to 40 wt. % of the siliconised release layer diffuse into the upper region of the underlying layer. Such a diffusion layer is described, for example, in EP 3 221 153 A1.

A siliconised release layer is preferably present when an adhesive layer, as described above, is also present.

The presence of a siliconised release layer on the heat-sensitive layer and of an adhesive layer on the web-like support material on the side where the colour layer is not located has the advantage that the heat-sensitive recording material can be used as a “linerless” heat-sensitive recording material.

The term “linerless” means that the (self-adhesive) heat-sensitive recording material according to the invention is not applied to a support material, but is wound onto itself. This has the advantage that the production costs can be further reduced, more running metres per roll can be realised, no disposal effort for the disposal of the liner is necessary, and more labels per specific loading space volume can be transported.

If a siliconised release layer is present, it is preferred that at least one platelet-shaped pigment is contained in the heat-sensitive layer or in the layer that lies directly below the siliconised release layer.

The at least one platelet-shaped pigment is preferably selected from the group consisting of kaolin, Al(OH)₃ and/or talc. The use of kaolin is especially preferred.

The use of a coating kaolin is very especially preferred. Such a coating kaolin is available under the trade name Kaolin ASP 109 (BASF, Germany).

The use of these platelet-shaped pigments, especially kaolin, has the particular advantage that the heat-sensitive layer or the layer that lies directly below the siliconised release layer can be siliconised very easily.

A platelet-shaped pigment is understood to mean a pigment in which the diameter to thickness ratio is between about 7 and 40 to 1, preferably between about 15 and 30 to 1.

The particle size of the platelet-shaped pigment is preferably set so that at least about 70%, preferably at least about 85%, of the particles have a particle size of about <2 μm (sedigraph). The pH value of the platelet-shaped pigment in aqueous solution is preferably 6 to 8.

The at least one platelet-shaped pigment is present in the heat-sensitive colour-forming layer or in the layer which lies directly below the siliconised release layer, preferably in an amount of from about 5 to about 60 wt. %, especially preferably in the amount of from about 15 to about 55 wt. %, in relation to the total solids content of the respective layer.

In a further preferred embodiment, the heat-sensitive recording material is preferably characterised in that the siliconised release layer comprises at least one siloxane, preferably a poly(organo)siloxane, especially an acrylic poly(organo)siloxane.

In a further embodiment, the siliconised release layer comprises a mixture of at least two siloxanes. Preferred is a mixture of at least two acrylic-poly(organo)siloxanes.

Examples of very especially preferred siloxanes are siloxanes available under the trade names TEGO® RC902 and TEGO® RC711 (Evonik, Germany).

In another embodiment, the heat-sensitive recording material is preferably characterised in that the siliconised release layer contains at least one polysilicone acrylate, preferably formed by condensation of at least one silicone acrylate.

The siliconised release layer is preferably water-free. It is also preferred that the siliconised release layer does not contain Pt catalysts.

The siliconised release layer preferably contains an initiator, especially preferably a photoinitiator. This serves for the radical curing of the silicone.

Very especially preferred here is the TEGO® photoinitiator A18 (from Evonik, Germany).

The siliconised release layer may preferably contain further additives, such as matting agents and/or adhesion additives.

The siliconised release layer preferably has an area density of from 0.3 to 5.0 g/m², especially from 1.0 to 3.0 g/m².

The siliconised release layer preferably has a thickness of from 0.3 to 6.0 μm, especially from 0.5 to 2.0 μm.

All of the above-mentioned layers can be single- or multi-ply.

The heat-sensitive recording material according to the invention according to the second aspect can be obtained by the production method described in conjunction with the first aspect.

The present invention further relates to a heat-sensitive recording material obtainable by the method described above.

The present invention also relates to the use of a heat-sensitive recording material as described above as a sales receipt roll, as an adhesive label (roll), also in the refrigeration and deep-freeze sector, and as a ticket (roll). These have especially a functional side and/or reverse side (with colour, coloured, black/grey) and can be pre-printed. These rolls are preferably available in typical widths and lengths.

In a third aspect, the present invention relates to a heat-sensitive recording material comprising a web-like support material, a colour layer on one side of the web-like support material and a heat-sensitive layer on the colour layer so that the colour layer is at least partially covered, the heat-sensitive layer being designed so that it becomes translucent by local action of heat, so that the underlying colour layer becomes visible, characterised in that the heat-sensitive layer comprises from 10 to 90 wt. %, preferably 20 to 60 wt. %, especially from 30 wt. % to 50 wt. %, of scattering particles, especially polymer particles, having a mean particle size in the range of from 0.1 to 2.5 μm, preferably from 0.2 to 0.8 μm, 10 to 80 wt. %, preferably 25 to 60 wt. %, of a heat-sensitive material having a melting temperature in the range of from 40 to 200° C. and/or a glass transition temperature in the range of from 40 to 200° C., and 1 to 30 wt. %, preferably 5 to 20 wt. %, of a binder.

Such a heat-sensitive recording material is distinguished especially with regard to its functionality, its environmental properties (sustainability) and/or its economic production (simple and inexpensive) and especially by the advantageous combination of these three properties.

In an especially preferred embodiment, the heat-sensitive recording material is characterised in that the heat-sensitive layer comprises at least one scattering particle, especially a polymer particle, having a glass transition temperature of from −55 to 130° C., preferably from 40 to 80° C.

In a further preferred embodiment, the heat-sensitive recording material is characterised in that the heat-sensitive layer comprises at least one scattering particle, especially a polymer particle, having a core/casing structure, wherein the scattering particles, especially the polymer particles, are selected from the group consisting of (i) scattering particles, especially polymer particles, having an outer shell with a glass transition temperature of from 40° C. to 80° C. and (ii) scattering particles, especially polymer particles, having an inner shell with a glass transition temperature of from 40° C. to 130° C. and an outer shell with a glass transition temperature of from −55° C. to 50° C., wherein the glass transition temperature of the outer shell is preferably lower than that of the inner shell.

In a further preferred embodiment, the heat-sensitive recording material is characterised in that the heat-sensitive layer comprises at least one scattering particle, especially a polymer particle, having a melting temperature lower than 250° C., preferably from 0° C. to 250° C.

In a further preferred embodiment, the heat-sensitive recording material is characterised in that the heat-sensitive layer comprises at least one scattering particle, especially a polymer particle, having a glass transition temperature of from −55 to 130° C., preferably from 40 to 80° C., and having a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially the polymer particle, having a core/casing structure, wherein the scattering particles, especially the polymer particles, are selected from the group consisting of (i) scattering particles, especially polymer particles, having an outer shell with a glass transition temperature of from 40° C. to 80° C. and (ii) scattering particles, especially polymer particles, having an inner shell with a glass transition temperature of from 40° C. to 130° C. and an outer shell with a glass transition temperature of from −55° C. to 50° C., wherein the glass transition temperature of the outer shell is preferably lower than that of the inner shell, and having a mean particle size in the rage of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a melting temperature lower than 250° C., preferably from 0° C. to 250° C., and having a mean particle size in the range of from 0.1 to 2.5 μm, preferably from 0.2 to 0.8 μm.

A glass transition temperature or a melting temperature lower than 250° C. was found to be advantageous. Above temperatures of 250° C., thermal direct printing is not possible because the temperature-time window is outside the printer specification.

A mean particle size in the range of from 0.1 to 2.5 μm is advantageous, as particles of this size scatter the visible light and thus the colour layer is covered to the greatest possible extent.

The mean particle size can be determined using a Beckman Coulter device (laser diffraction, Fraunhofer method).

The scattering particles, especially the polymer particles, are preferably crystalline, semi-crystalline and/or amorphous.

The above-stated glass transition temperatures refer to semi-crystalline or amorphous scattering particles, especially polymer particles. The melting temperatures refer to crystalline scattering particles, especially polymer particles, or to the crystalline portion of the scattering particles, especially polymer particles.

The polymer particles are preferably closed hollow-body particles, especially hollow-spherical polymer particles, open hollow-body particles, especially lattice cage-shaped polymer particles, and/or solid-body particles, especially irregularly shaped polymer particles.

The primary property of the scattering particles, preferably the polymer particles, is light scattering in the visible range of light. The secondary property is thermal sensitivity.

The polymer particles preferably comprise thermoplastic polymers.

The polymer particles preferably comprise polymers resulting from the polymerisation of one or more monomers selected from the group comprising acrylonitrile, styrene, butadiene, benzyl methacrylate, phenyl methacrylate, ethyl methacrylate, divinylbenzene, 2-hydroxyethyl methacrylate, cyclohexyl methacrylate, 2-methylstyrene, 3-methylstyrene, 4-methylstyrene, alpha-methylstyrene, beta-methylstyrene, acrylamide, methacrylamide, methacrylonitrile, hydroxypropyl methacrylate, methoxystyrene, N-acrylylglycinamide and/or N-methacrylylglycinamide and/or derivatives thereof.

In another embodiment, the polymer particles may be polymerised using a variety of ethylenically unsaturated monomers. Examples of non-ionic monoethylenically unsaturated monomers include styrene, vinyl toluene, ethylene, vinyl acetate, vinyl chloride, vinylidene chloride, acrylonitrile, (meth)acrylamide, various (C₁-C₂₀)-alkyl or (C₃-C₂₀)-alkenyl esters of (meth)acrylic acid, including methyl acrylate (MA), methyl methacrylate (MMA), ethyl (meth)acrylate, butyl (meth)acrylate, 2-hydroxyethyl (meth)acrylate, 2-ethylhexyl (meth)acrylate, benzyl (meth)acrylate, lauryl (meth)acrylate, oleyl (meth)acrylate, palmityl (meth)acrylate and stearyl (meth)acrylate. Typically, acrylic esters such as MMA, EA, BA and styrene are preferred monomers for polymerisation and formation of the shell of the polymer particles. Difunctional vinyl monomers such as divinylbenzene, allyl methacrylate, ethylene glycol dimethacrylate, 1,3-butanediol dimethacrylate, diethylene glycol dimethacrylate, trimethylolpropane trimethacrylate and the like can also be copolymerised to form a crosslinked outer casing, as described in US patent application 2003-0176535 A1.

In another embodiment, the polymer particles preferably comprise (meth)acrylonitrile copolymers, polyvinyl chloride, polyvinylidene chloride, polystyrene, styrene acrylate, styrene (meth)acrylate copolymers, polyacrylonitrile, polyacrylic acid esters or also mixtures of at least two thereof.

The strength and durability of the polymer particles can be influenced by the crosslinking of polymer chains.

The scattering particles, especially the polymer particles, may be in the form of closed scattering particles, especially polymer particles, especially hollow-body particles, open scattering particles, especially polymer particles, and/or solid-body particles, each of which can be regularly or irregularly shaped.

Examples of closed hollow-body particles include hollow-spherical polymer particles, or polymer particles with a core/casing structure.

Examples of hollow-spherical polymer particles or polymer particles with a core/casing structure are Ropaque HP-1055, Ropaque OP-96 and Ropaque TH-1000.

Especially, so-called “cup-shaped” polymer particles can be mentioned as examples of open polymer particles. With regard to the casing, these have the same materials as the closed polymer particles, especially the closed hollow-spherical polymer particles. In contrast to the classic hollow-body pigments, in which an inner core of gas, usually air, is completely enclosed by a casing formed of organic, usually thermoplastic components, the “cup-shaped” pigments do not have a closed casing and only surround the inner core in the form of a shell or “cup”, which is closed to the greatest possible extent.

As further examples of open polymer particles, lattice cage-shaped polymer particles as described in WO 2021/062230 A1 can be mentioned.

Examples of solid-body particles are polyethylene, polystyrene and cellulose esters.

The above-mentioned scattering particles, especially the polymer particles, can be regularly or irregularly shaped.

In an alternative embodiment, the polymer particles are spherical solid-body particles, preferably irregularly shaped, and/or spherical hollow-body particles, both preferably in the form of droplets. These preferably comprise polystyrene, for example Plastic Pigment 756A from Trinseo LLC., and Plastic Pigment 772HS from Trinseo LLC., polyethylene, for example Chemipear 10 W401 from Mitsui Chemical Inc., spherical hollow-body particles (HSP)/spherical hollow-body pigments, for example Ropaque TH-500EF from The Dow Chemical Co., modified polystyrene particles, for example Joncryl 633 from BASF Corp., 1,2-diphenoxyethane (DPE), ethylene glycol m-tolyl ether (EGTE) and/or diphenyl sulfone (DPS). These can be used alone or in any mixtures. These polymer particles preferably have a mean particle size of 0.2 μm, 0.3 μm, 0.4 μm, 0.45 μm, 0.75 μm or 1.0 μm.

The scattering particles, especially the polymer particles, are preferably present in the heat-sensitive layer in an amount of from 20 wt. % to 60 wt. %, preferably from 30 wt. % to 50 wt. % in relation to the solids content of the heat-sensitive layer.

As previously mentioned, the heat-sensitive layer comprises at least one heat-sensitive material having a melting temperature in the range of from 40 to 200° C., preferably from 80 to 140° C., and/or a glass transition temperature in the range of from 40 to 200° C., preferably from 80 to 140° C.

Preferably, the heat-sensitive layer comprises at least one heat-sensitive material having an average particle size of from 0.2 to 4.0 μm, preferably from 0.5 to 2.0 μm.

The heat-sensitive material also preferably contributes to the opacity (covering power) of the heat-sensitive layer, e.g. by absorbing and/or also scattering light.

It is assumed that the heat-sensitive material quickly melts locally due to local exposure to heat by the thermal print head of the thermal direct printer, resulting in a local “softening” of the polymer particles, and thus in a local reduction of the covering force (opacity reduction), so that the cover layer becomes translucent and the underlying colour layer becomes visible.

The heat-sensitive material can also be called a sensitiser or thermal solvent.

Preferably, the heat-sensitive material comprises one or more fatty acids, such as stearic acid, behenic acid or palmitic acid, one or more fatty acid amides, such as stearamide, behenamide or palmitamide, an ethylene-bis-fatty acid amide, such as N,N′-ethylene-bis-stearic acid amide or N,N′-ethylene-bis-oleic acid amide, one or more fatty acid alkanolamides, especially hydroxymethylated fatty acid amides, such as N-(hydroxymethyl)stearamide, N-hydroxymethylpalmitamide, hydroxyethylstearamide, one or more waxes, such as polyethylene wax, candelilla wax, carnauba wax or montan wax, one or more carboxylic acid esters, such as dimethylterephthalate, dibenzyl terephthalate, benzyl 4-benzyloxybenzoate, di-(4-methylbenzyl)oxalate, di-(4-chlorobenzyl)oxalate or di-(4-benzyl)oxalate, ketones, such as 4-acetylbiphenyl, one or more aromatic ethers, such as 1,2-diphenoxy-ethane, 1,2-di-(3-methylphenoxy)ethane, 2-benzyloxynaphthalene, 1,2-bis(phenoxymethyl)benzene or 1,4-diethoxynaphthalene, one or more aromatic sulfones, such as diphenylsulfone, and/or an aromatic sulfonamide, such as 2-, 3-, 4-toluenesulfonamide, benzenesulfonanilide or N-benzyl-4-toluenesulfonamide, or one or more aromatic hydrocarbons, such as 4-benzylbiphenyl, or combinations of the above compounds. These can be used alone or in any mixtures. Stearamide is preferred because it has a favourable price-performance ratio.

The heat-sensitive material is preferably present in the heat-sensitive layer in an amount of from about 10 to about 80 wt. %, especially preferably in an amount of from about 25 to about 60 wt. %, in relation to the total solids content of the heat-sensitive layer.

As previously mentioned, at least one binder is present in the heat-sensitive layer. This is preferably constituted by water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Partially saponified or semi-saponified polyvinyl alcohols are preferred, as they have a favourable price-performance ratio.

The binder is preferably present in the heat-sensitive layer in an amount of from 1 to 30 wt. %, preferably from 5 to 20 wt. %, in relation to the total solids content of the heat-sensitive layer.

In order to achieve specific application-related performance characteristics of heat-sensitive recording materials, the binder is preferably present in crosslinked form in the heat-sensitive layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0, especially preferably in an amount of from about 0.05 to about 15.0, in relation to the total solids content of the colour layer.

In a further preferred embodiment, the heat-sensitive recording material is preferably characterised in that the heat-sensitive recording material has a residual moisture of from 2 to 14%, preferably from 2 to 12% and very especially preferably from 3 to 10%. A residual moisture of from 3 to 8% is most preferred.

A residual moisture in the specified range has the advantage that, after printing, there is a high relative print contrast with advantageous application-related properties, such as better legibility.

The residual moisture can be determined as described in conjunction with the examples.

It is assumed that the opacity in the heat-sensitive layer is not only generated by the scattering particles, especially the polymer particles, but also by the air trapped between the scattering particles, especially the polymer particles (open porosity). Penetration of moisture into these “pores” displaces air and reduces opacity. This can result in a greyer material that is not preferred.

In a further preferred embodiment, the heat-sensitive recording material is preferably characterised in that the heat-sensitive recording material has a surface whiteness of from 35 to 60%, especially from 45 to 50%.

The surface whiteness (paper whiteness) can be determined according to ISO 2470-2 (2008) with an Elrepho 3000 spectrophotometer.

In a further preferred embodiment, the heat-sensitive recording material is preferably characterised in that the contrast from locations where the heat-sensitive layer has become translucent due to local action of heat to locations where the heat-sensitive layer has not become translucent due to local action of heat is 40 to 80%, especially from 50 to 70%.

This contrast can be calculated by taking the difference between the optical density of the background and the script. The measurement of the optical density (o. D.) is done, for example, by means of a densitometer.

Preferably, the support material has a Bekk smoothness of greater than 20 s, especially preferably of greater than 30 s and very especially preferably of greater than 50 s on the side to which the colour layer is applied.

The colour layer preferably has a Bekk smoothness of greater than 50 s, especially preferably of greater than 100 s and very especially preferably of greater than 150 s on the side to which the heat-sensitive layer is applied.

The heat-sensitive layer preferably has a Bekk smoothness of greater than 100 s, especially preferably of greater than 250 s, on the side on which the colour layer is not located.

Preferably, the support material has a Bekk smoothness of 20 to 400 s, especially preferably 30 to 300 s and very especially preferably of 50 to 200 s on the side to which the colour layer is applied. A Bekk smoothness of 50 to 150 s is most preferred.

The colour layer preferably has a Bekk smoothness of 50 to 400 s, especially preferably 100 to 250 s and very especially preferably 100 to 250 s on the side to which the heat-sensitive layer is applied.

Such a heat-sensitive recording material has the advantage of high dynamic sensitivity.

It is advantageous to already present a smooth web-like support material and to maintain this smoothness over the individual coatings. The smoother the substrate is built up from below, the better the final smoothness and thus the sensitivity of the end product.

It is preferred that each layer applied to the web-like support material has a Bekk smoothness on its upper side, i.e. on the side on which the web-like support material does not lie, that is at least as great as or greater than that of the underlying layer.

Preferably, each layer applied to the web-like support material has a Bekk smoothness of at least 5% (percentage increase) on its upper side, i.e. on the side on which the web-like support material does not lie, compared to the underlying layer.

Preferably, each layer applied to the web-like support material has a Bekk smoothness of at least 5 s (absolute increase) on its upper side, i.e. on the side on which the web-like support material does not lie, compared to the underlying layer.

Optionally, lubricants or release agents can also be present in the heat-sensitive layer. Such lubricants or release agents are present especially if there is no protective layer or no other layer on the heat-sensitive layer.

These agents are preferably fatty acid metal salts, such as zinc stearate or calcium stearate, or also behenate salts, synthetic waxes, e.g. in the form of fatty acid amides, such as stearic acid amide and behenic acid amide, fatty acid alkanolamides, such as stearic acid methylolamide, paraffin waxes of different melting points, ester waxes of different molecular weights, ethylene waxes, propylene waxes of different hardnesses and/or natural waxes, e.g. carnauba wax or montan wax. These can be used alone or in any mixtures.

Zinc stearate is preferred because it has a favourable price-performance ratio.

The lubricant or the release agent is preferably present in the heat-sensitive layer in an amount of from about 1 to about 10 wt. %, especially preferably in an amount of from about 3 to about 6 wt. %, in relation to the total solids content of the heat-sensitive layer.

In another preferred embodiment, the heat-sensitive layer contains pigments.

These pigments are preferably different from the pigments of the colour layer.

The use of these has the advantage, among other things, that they can fix the chemical melt produced in the thermal printing process on their surface. Pigments can also be used to control the surface whiteness and opacity of the heat-sensitive layer and its printability with conventional printing inks.

Especially suitable pigments are inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Preferred are calcium carbonates, aluminium hydroxides and pyrogenic silicas, as they enable especially advantageous application properties of the heat-sensitive recording materials with regard to their subsequent printability with commercially available printing inks.

The pigments are preferably present in the heat-sensitive layer in an amount of from about 2 to about 50 wt. %, especially preferably in an amount of from about 5 to about 20 wt. %, in relation to the total solids content of the heat-sensitive layer.

The heat-sensitive layer may further comprise carbon black components and/or dyes/colour pigments.

To control the surface whiteness of the heat-sensitive recording material according to the invention, optical brighteners can be incorporated into the heat-sensitive colour-forming layer. These are preferably stilbenes.

The heat-sensitive layer may further contain inorganic oil-absorbing white pigments.

Examples of these inorganic oil-absorbing white pigments include natural or calcined kaolin, silica, bentonite, calcium carbonate, aluminium hydroxide, especially boehmite, and/or mixtures thereof.

The inorganic oil-absorbing white pigments are preferably present in the heat-sensitive layer in an amount of from about 2 to about 50 wt. %, especially preferably in an amount of from about 5 to about 20 wt. %, in relation to the total solids content of the heat-sensitive layer.

In order to improve certain coating properties, it is preferable in individual cases to add further constituents, especially rheology aids, such as thickeners and/or surfactants, to the constituents of the heat-sensitive recording material according to the invention.

The further constituents are each preferably present in customary amounts known to a person skilled in the art.

The heat-sensitive layer preferably has an area density of from 1 to 8 g/m², especially from 2 to 6 g/m².

The heat-sensitive layer preferably has a thickness of from 1 to 10 μm, especially 2 to 8 μm.

The web-like support material is in principle not limited. In a preferred embodiment, the web-like support material comprises paper, synthetic paper and/or a plastics film. The support material preferably has an area density of from 30 to 100 g/m², especially from 40 to 80 g/m².

The web-like support material of the heat-sensitive recording material according to the invention preferably comprises at least one black or coloured side, which is achieved by applying a colour layer. The term “coloured side” is understood to mean that the side has a colour other than white or black. In other words, the heat-sensitive recording material comprises at least one side which is coloured such that it is not white. Embodiments are also possible in which the at least one black or coloured side has several different colours, also in combination with the colour black.

The at least one colour layer on one side of the web-like support material is preferably characterised in that the colour layer comprises at least one pigment and/or a dye and also preferably a binder.

The pigments and/or dyes include various organic and inorganic pigments, dyes and/or carbon black. These can be used alone or in any mixtures.

The pigment, the dye and/or the carbon black are preferably each present in the colour layer in an amount of from 2 to 50 wt. %, especially preferably from 10 to 35 wt. %, in relation to the total solids content of the colour layer.

Preferred binders are water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

The binder is preferably present in the colour layer in an amount of from 2 to 40 wt. %, especially preferably from 10 to 30 wt. %, in relation to the total solids content of the colour layer.

The colour layer preferably has an area density of from 1 to 10 g/m², especially from 3 to 8 g/m².

The colour layer preferably has a thickness of from 1 to 10 μm, especially from 2 to 8 μm.

In a further preferred embodiment, the heat-sensitive recording material is preferably characterised in that an insulation layer is present between the web-like support material and the colour layer.

In an alternative embodiment, the heat-sensitive recording material is preferably characterised in that the colour layer simultaneously constitutes a colour layer and also an insulation layer.

Such an insulation layer or a colour layer, which is simultaneously a colour layer and also an insulation layer, causes a reduction in heat conduction through the heat-sensitive recording material. This makes the local action of heat by means of a thermal direct printer more efficient and a higher thermal printer speed possible. The cover layer becomes translucent more quickly due to the amount of heat introduced and the sensitivity is thus improved.

This means that less dye is needed, which results in improved recyclability in the materials cycle, especially in the waste paper cycle (easier deinkability, separation of dye and support material components).

The insulation layer or the colour layer, which is simultaneously a colour layer and also an insulation layer, preferably has a Bekk smoothness of greater than 50 s, especially preferably of greater than 100 s and very especially preferably of 100 s to 250 s.

The insulation layer or the colour layer, which is simultaneously a colour layer and also an insulation layer, preferably comprises a heat-insulating material.

Preferably, the heat-sensitive recording material comprising an insulation layer or a colour layer which is simultaneously also an insulation layer has a lower thermal conductivity than a heat-sensitive recording material that does not comprise an insulation layer or a colour layer which is simultaneously also an insulation layer.

The thermally insulating material preferably comprises kaolin, especially preferably calcined kaolin and mixtures thereof.

The thermally insulating material may also comprise hollow-sphere pigments, especially hollow-sphere pigments comprising styrene-acrylate copolymer.

These hollow-sphere pigments preferably have a glass transition temperature of from 40 to 80° C. and/or a mean particle size of from 0.1 to 2.5 μm. The thermally insulating material is preferably present in the insulation layer in an amount of from about 20 to about 80 wt. %, especially preferably in an amount of from about 40 to about 60 wt. %, in relation to the total solids content of the insulation layer.

In a colour layer which is simultaneously a colour layer and also an insulation layer, the thermally insulating material is preferably present therein in an amount of from about 30 to about 70 wt. %, especially preferably in an amount of from about 40 to about 60 wt. %, in relation to the total solids content of the colour layer which is simultaneously a colour layer and also an insulation layer.

In order to achieve specific application-related performance characteristics of heat-sensitive recording materials, the binder is preferably present in crosslinked form in the insulation layer and/or colour layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the insulation or colour layer. The insulation layer preferably has an area density of from 1 to 5 g/m², especially 2 to 4 g/m².

The insulation layer preferably has a thickness of from 1 to 10 μm, especially from 2 to 8 μm.

The colour layer which is simultaneously a colour layer and also an insulation layer preferably has an area density of from 1 to 12 g/m², especially 4 to 8 g/m².

The colour layer which is simultaneously a colour layer and also an insulation layer preferably has a thickness of from 2 to 10 μm, especially from 4 to 8 μm.

In a further preferred embodiment, the heat-sensitive recording material is preferably characterised in that a layer comprising starch (starch coating) and modifications thereof (modified starches) is present directly on at least one side of the web-like support material, preferably directly on both sides of the web-like support material.

The starch coating is preferably applied in an amount of from 0.1 to 3, especially preferably from 0.2 to 1.5 g/m².

A starch coating on the side of the web-like support material on which the colour layer is present has the advantage of sealing the web-like support material and thus improving the adhesion of the colour layer and reducing or preventing penetration of the colour layer into the web-like support material.

A starch coating on the side of the web-like support material that does not have the colour layer has the advantage of reducing or preventing the colour layer from bleeding through the web-like support material.

The layer comprising starch preferably has a Bekk smoothness of greater than 20 s, especially preferably greater than 50 s and very especially preferably from 50 s to 200 s.

In a further preferred embodiment, the heat-sensitive recording material is preferably characterised in that a protective layer is present on the heat-sensitive layer.

The protective layer preferably has a Bekk smoothness of greater than 200 s, especially preferably of greater than 400 s and very especially preferably from 400 to 1500 s. A Bekk smoothness of 400 to 1300 s is most preferred.

This is present on the side of the heat-sensitive layer on which the colour layer does not lie.

This protective layer preferably comprises at least one binder and at least one pigment, especially preferably an inorganic pigment.

Suitable binders include water-soluble starches, starch derivatives, starch-based EcoSphere-type biolatices, methyl cellulose, hydroxyethyl cellulose, carboxymethyl cellulose, partially or fully saponified polyvinyl alcohols, chemically modified polyvinyl alcohols, such as acetoacetyl, diacetone, carboxy-, silanol-modified polyvinyl alcohols, or styrene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Suitable inorganic pigments include inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Suitable organic pigments include hollow pigments with a styrene/acrylate copolymer wall or urea/formaldehyde condensation polymers. These can be used alone or in any mixtures.

The binder is preferably present in the protective layer in an amount of from about 40 to about 90 wt. %, especially preferably in an amount of from about 50 to about 80 wt. %, in relation to the total solids content of the protective layer. The pigment is preferably present in the protective layer in an amount of from about 5 to about 40 wt. %, especially preferably in an amount of from about 10 to about 30 wt. %, in relation to the total solids content of the protective layer.

In order to achieve specific application-related performance characteristics of heat-sensitive recording materials, the binder is preferably present in crosslinked form in the protective layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0, especially preferably in an amount of from about 0.05 to about 15.0, in relation to the total solids content of the colour layer.

The protective layer further preferably comprises at least one lubricant or at least one release agent.

These agents are preferably fatty acid metal salts, such as zinc stearate or calcium stearate, or also behenate salts, synthetic waxes, e.g. in the form of fatty acid amides, such as stearic acid amide and behenic acid amide, fatty acid alkanolamides, such as stearic acid methylolamide, paraffin waxes of different melting points, ester waxes of different molecular weights, ethylene waxes, propylene waxes of different hardnesses and/or natural waxes, e.g. carnauba wax or montan wax.

The lubricant or the release agent is preferably present in the protective layer in an amount of from about 1 to about 30 wt. %, especially preferably in an amount of from about 2 to about 20 wt. %, in relation to the total solids content of the protective layer.

To control the surface whiteness of the heat-sensitive recording material according to the invention, optical brighteners, preferably stilbenes, can be incorporated into the protective layer.

The protective layer preferably has an area density of from 0.3 to 5.0 g/m², especially from 1.0 to 3.0 g/m².

The protective layer preferably has a thickness of from 0.3 to 6.0 μm, especially from 0.5 to 2.0 μm.

The use of a protective layer has the advantage that the recording material is better protected against external influences.

In a further preferred embodiment, the heat-sensitive recording material is preferably characterised in that an adhesive layer is present on the web-like support material on the side on which the colour layer is not located.

If a starch coating is present, it lies between the web-like support material and the adhesive layer.

The adhesive layer preferably comprises at least one adhesive, preferably a heat-activatable adhesive, especially a pressure-sensitive adhesive.

Especially preferably, the adhesive, preferably the heat-activatable adhesive and especially the pressure-sensitive adhesive, is a rubber- and/or acrylate-based one.

The adhesive layer preferably has an area density of from 10 to 40 g/m², especially 12 to 25 g/m².

In a further preferred embodiment, the heat-sensitive recording material is preferably characterised in that a siliconised release layer is present on the heat-sensitive layer.

The terms “siliconised release layer” and “siliconised layer” are to be understood synonymously in the sense of “to cover with a layer of silicone”. Preferably, these layers consist of silicone or comprise at least 90 wt. %, preferably at least 95 wt. % and especially preferably at least 99 wt. % and very especially preferably only silicone except for unavoidable traces or auxiliaries (e.g. for UV curing of a siliconisation fluid).

The siliconised release layer preferably has a Bekk smoothness of greater than 400 s, especially preferably greater than 800 s and very especially preferably from 800 to 2000 s.

If a protective layer, especially as defined above, is present on the heat-sensitive layer, the siliconised release layer is preferably located on this protective layer.

In a further preferred embodiment, the heat-sensitive recording material is preferably characterised in that a diffusion layer is formed between the siliconised layer and the underlying layer, preferably the heat-sensitive layer. This diffusion layer is preferably formed by diffusing, areally, at least parts of the siliconised release layer into the upper region of the underlying layer, wherein preferably 5 to 50 wt. %, especially preferably 6 to 45 wt. % and especially 7 to 40 wt. % of the siliconised release layer diffuse into the upper region of the underlying layer. Such a diffusion layer is described, for example, in EP 3 221 153 A1.

A siliconised release layer is preferably present when an adhesive layer, as described above, is also present.

The presence of a siliconised release layer on the heat-sensitive layer and of an adhesive layer on the web-like support material on the side where the colour layer is not located has the advantage that the heat-sensitive recording material can be used as a “linerless” heat-sensitive recording material.

The term “linerless” means that the (self-adhesive) heat-sensitive recording material according to the invention is not applied to a support material, but is wound onto itself. This has the advantage that the production costs can be further reduced, more running metres per roll can be realised, no disposal effort for the disposal of the liner is necessary, and more labels per specific loading space volume can be transported.

If a siliconised release layer is present, it is preferred that at least one platelet-shaped pigment is contained in the heat-sensitive layer or in the layer that lies directly below the siliconised release layer.

The at least one platelet-shaped pigment is preferably selected from the group consisting of kaolin, Al(OH)₃ and/or talc. The use of kaolin is especially preferred.

The use of a coating kaolin is very especially preferred. Such a coating kaolin is available under the trade name Kaolin ASP 109 (BASF, Germany).

The use of these platelet-shaped pigments, especially kaolin, has the particular advantage that the heat-sensitive layer or the layer that lies directly below the siliconised release layer can be siliconised very easily.

A platelet-shaped pigment is understood to mean a pigment in which the diameter to thickness ratio is between about 7 and 40 to 1, preferably between about 15 and 30 to 1.

The particle size of the platelet-shaped pigment is preferably set so that at least about 70%, preferably at least about 85%, of the particles have a particle size of about <2 μm (sedigraph). The pH value of the platelet-shaped pigment in aqueous solution is preferably 6 to 8.

The at least one platelet-shaped pigment is present in the heat-sensitive colour-forming layer or in the layer which lies directly below the siliconised release layer, preferably in an amount of from about 5 to about 60 wt. %, especially preferably in the amount of from about 15 to about 55 wt. %, in relation to the total solids content of the respective layer.

In a further preferred embodiment, the heat-sensitive recording material is preferably characterised in that the siliconised release layer comprises at least one siloxane, preferably a poly(organo)siloxane, especially an acrylic poly(organo)siloxane.

In a further embodiment, the siliconised release layer comprises a mixture of at least two siloxanes. Preferred is a mixture of at least two acrylic-poly(organo)siloxanes.

Examples of very especially preferred siloxanes are siloxanes available under the trade names TEGO® RC902 and TEGO® RC711 (Evonik, Germany).

In another embodiment, the heat-sensitive recording material is preferably characterised in that the siliconised release layer contains at least one polysilicone acrylate, preferably formed by condensation of at least one silicone acrylate.

The siliconised release layer is preferably water-free. It is also preferred that the siliconised release layer does not contain Pt catalysts.

The siliconised release layer preferably contains an initiator, especially preferably a photoinitiator. This serves for the radical curing of the silicone.

Very especially preferred here is the TEGO® photoinitiator A18 (from Evonik, Germany).

The siliconised release layer may preferably contain further additives, such as matting agents and/or adhesion additives.

The siliconised release layer preferably has an area density of from 0.3 to 5.0 g/m², especially from 1.0 to 3.0 g/m².

The siliconised release layer preferably has a thickness of from 0.5 to 6.0 μm, especially from 0.5 to 2.0 μm.

All of the above-mentioned layers can be single- or multi-ply.

The heat-sensitive recording material according to the invention according to the third aspect can be obtained by the production method described in conjunction with the first aspect.

The present invention further relates to a heat-sensitive recording material obtainable by the method described above.

The present invention also relates to the use of a heat-sensitive recording material as described above as a sales receipt roll, as an adhesive label (roll), also in the refrigeration and deep-freeze sector, and as a ticket (roll). These have especially a functional side and/or reverse side (with colour, coloured, black/grey) and can be pre-printed. These rolls are preferably available in typical widths and lengths.

In a fourth aspect, the present invention relates to a heat-sensitive recording material comprising a web-like support material, an insulation layer on one side of the web-like support material, a colour layer on the insulation layer and a heat-sensitive layer on the colour layer so that the colour layer is at least partially covered, the heat-sensitive layer being designed so that it becomes translucent due to local action of heat, so that the underlying colour layer becomes visible.

In a fifth aspect, the present invention relates to a heat-sensitive recording material comprising a web-like support material, a layer which is simultaneously a colour layer and also an insulation layer on one side of the web-like support material, and a heat-sensitive layer, on the colour layer, so that the colour layer is at least partially covered, the heat-sensitive layer being designed so that it becomes translucent due to local action of heat, so that the underlying colour layer becomes visible.

All of the following definitions and preferred embodiments apply analogously to the fourth and fifth aspects of the invention.

Such an insulation layer or a colour layer, which is simultaneously a colour layer and also an insulation layer, causes a reduction in heat conduction through the heat-sensitive recording material. This makes the local action of heat by means of a thermal direct printer more efficient and a higher thermal printer speed possible. The cover layer becomes translucent more quickly due to the amount of heat introduced and the sensitivity is thus improved.

This means that less dye is needed, which results in improved recyclability in the materials cycle, especially in the waste paper cycle (easier deinkability, separation of dye and support material components).

Preferably, the heat-sensitive recording material comprising an insulation layer or a colour layer which is simultaneously an insulation layer has a lower thermal conductivity than a heat-sensitive recording material that does not comprise an insulation layer or a colour layer which is simultaneously an insulation layer.

The insulation layer or the colour layer, which is simultaneously a colour layer and also an insulation layer, preferably comprises a heat-insulating material.

The thermally insulating material preferably comprises kaolin, especially preferably calcined kaolin and mixtures thereof.

The thermally insulating material may also comprise hollow-sphere pigments, especially hollow-sphere pigments comprising styrene-acrylate copolymer.

These hollow-sphere pigments preferably have a glass transition temperature of from 40 to 80° C. and/or a mean particle size of from 0.1 to 2.5 μm.

The thermally insulating material is preferably present in the insulation layer in an amount of from about 20 to about 80 wt. %, especially preferably in an amount of from about 40 to about 60 wt. %, in relation to the total solids content of the insulation layer.

In a colour layer which is simultaneously a colour layer and also an insulation layer, the thermally insulating material is preferably present therein in an amount of from about 30 to about 70 wt. %, especially preferably in an amount of from about 40 to about 60 wt. %, in relation to the total solids content of the colour layer which is simultaneously a colour layer and also an insulation layer.

The insulation layer or the colour layer, which is simultaneously a colour layer and also an insulation layer, preferably has a Bekk smoothness of greater than 50 s, especially preferably of greater than 100 s and very especially preferably of 100 to 250 s.

In order to achieve specific application-related performance characteristics of heat-sensitive recording materials, the binder is preferably present in crosslinked form in the insulation layer and/or colour layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the insulation or colour layer.

The insulation layer preferably has an area density of from 1 to 5 g/m², especially 2 to 4 g/m².

The insulation layer preferably has a thickness of from 1 to 10 μm, especially from 2 to 8 μm.

The colour layer which is simultaneously a colour layer and also an insulation layer preferably has an area density of from 1 to 10 g/m², especially 3 to 8 g/m².

The colour layer which is simultaneously a colour layer and also an insulation layer preferably has a thickness of from 1 to 12 μm, especially from 4 to 8 μm.

In a further preferred embodiment, the heat-sensitive recording material is preferably characterised in that the heat-sensitive recording material has a residual moisture of from 2 to 14%, especially preferably from 2 to 12% and very especially preferably from 3 to 10%. A residual moisture of from 3 to 8% is most preferred.

A residual moisture in the specified range has the advantage that, after printing, there is a high relative print contrast with advantageous application-related properties, such as better legibility.

The residual moisture can be determined as described in conjunction with the examples.

It is assumed that the opacity in the heat-sensitive layer is not only generated by the scattering particles, especially the polymer particles, but also by the air trapped between the scattering particles, especially the polymer particles (open porosity). Penetration of moisture into these “pores” displaces air and reduces opacity. This can result in a greyer material that is not preferred.

In a further preferred embodiment, the heat-sensitive recording material is preferably characterised in that the heat-sensitive recording material has a surface whiteness of from 35 to 60%, especially from 45 to 50%.

The surface whiteness (paper whiteness) can be determined according to ISO 2470-2 (2008) with an Elrepho 3000 spectrophotometer.

In a further preferred embodiment, the heat-sensitive recording material is preferably characterised in that the contrast from locations where the heat-sensitive layer has become translucent due to local action of heat to locations where the heat-sensitive layer has not become translucent due to local action of heat is 40 to 80%, especially from 50 to 70%.

This contrast can be calculated by taking the difference between the optical density of the background and the script. The measurement of the optical density (o. D.) is done, for example, by means of a densitometer.

Preferably, the support material has a Bekk smoothness of greater than 20 s, especially preferably of greater than 30 s and very especially preferably of greater than 50 s on the side to which the colour layer is applied.

The colour layer preferably has a Bekk smoothness of greater than 50 s, especially preferably of greater than 100 s and very especially preferably of greater than 150 s on the side to which the heat-sensitive layer is applied.

The heat-sensitive layer preferably has a Bekk smoothness of greater than 100 s, especially preferably of greater than 250 s, on the side on which the colour layer is not located.

Preferably, the support material has a Bekk smoothness of 20 to 400 s, especially preferably 50 to 300 s and very especially preferably 50 to 200 s on the side to which the colour layer is applied. A Bekk smoothness of 50 to 150 s is most preferred.

The colour layer preferably has a Bekk smoothness of 50 to 400 s, especially preferably 100 to 250 s and very especially preferably 150 to 250 s on the side to which the heat-sensitive layer is applied.

The heat-sensitive layer preferably has a Bekk smoothness of 100 to 1000 s, especially preferably 250 to 800 s, on the side on which the colour layer does not lie.

The Bekk smoothness is determined in each case according to DIN 53107 (2016).

Such a heat-sensitive recording material has the advantage of high dynamic sensitivity.

It is advantageous to already present a smooth web-like support material and to maintain this smoothness over the individual coatings. The smoother the substrate is built up from below, the better the final smoothness and thus the sensitivity of the end product.

It is preferred that each layer applied to the web-like support material has a Bekk smoothness on its upper side, i.e. on the side on which the web-like support material does not lie, that is at least as great as or greater than that of the underlying layer.

Preferably, each layer applied to the web-like support material has a Bekk smoothness of at least 5% (percentage increase) on its upper side, i.e. on the side on which the web-like support material does not lie, compared to the underlying layer.

Preferably, each layer applied to the web-like support material has a Bekk smoothness of at least 5% (absolute increase) on its upper side, i.e. on the side on which the web-like support material does not lie, compared to the underlying layer.

The web-like support material is in principle not limited. In a preferred embodiment, the web-like support material comprises paper, synthetic paper and/or a plastics film. The support material preferably has an area density of from 30 to 100 g/m², especially from 40 to 80 g/m².

The web-like support material of the heat-sensitive recording material according to the invention preferably comprises at least one black or coloured side, which is achieved by applying a colour layer. The term “coloured side” is understood to mean that the side has a colour other than white or black. In other words, the heat-sensitive recording material comprises at least one side which is coloured such that it is not white. Embodiments are also possible in which the at least one black or coloured side has several different colours, also in combination with the colour black.

The at least one colour layer on one side of the web-like support material is preferably characterised in that the colour layer comprises at least one pigment and/or a dye and also preferably a binder.

The pigments and/or dyes include various organic and inorganic pigments, dyes and/or carbon black. These can be used alone or in any mixtures.

The pigment, the dye and/or the carbon black are preferably each present in the colour layer in an amount of from 2 to 50 wt. %, especially preferably from 10 to 35 wt. %, in relation to the total solids content of the colour layer.

Preferred binders are water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

The binder is preferably present in the colour layer in an amount of from 2 to 40 wt. %, especially preferably from 10 to 30 wt. %, in relation to the total solids content of the colour layer.

The colour layer preferably has an area density of from 1 to 10 g/m², especially from 3 to 8 g/m².

The colour layer preferably has a thickness of from 1 to 10 μm, especially from 2 to 8 μm.

In a further preferred embodiment, the heat-sensitive recording material is characterised in that the heat-sensitive layer comprises at least one scattering particle, especially a polymer particle, having a glass transition temperature of from −55 to 130° C., preferably from 40 to 80° C.

In a further preferred embodiment, the heat-sensitive recording material is characterised in that the heat-sensitive layer comprises at least one scattering particle, especially a polymer particle, having a core/casing structure, wherein the scattering particles, especially the polymer particles, are selected from the group consisting of (i) scattering particles, especially polymer particles, having an outer shell with a glass transition temperature of from 40° C. to 80° C. and (ii) scattering particles, especially polymer particles, having an inner shell with a glass transition temperature of from 40° C. to 130° C. and an outer shell with a glass transition temperature of from −55° C. to 50° C., wherein the glass transition temperature of the outer shell is preferably lower than that of the inner shell.

In a further preferred embodiment, the heat-sensitive recording material is characterised in that the heat-sensitive layer comprises at least one scattering particle, especially a polymer particle, having a melting temperature lower than 250° C., preferably from 0° C. to 250° C.

In a further preferred embodiment, the heat-sensitive recording material is characterised in that the heat-sensitive layer comprises at least one scattering particle, especially a polymer particle, having a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a glass transition temperature of from −55 to 130° C., preferably from 40 to 80° C., and having a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a core/casing structure, wherein the scattering particles, especially the polymer particles, are selected from the group consisting of (i) scattering particles, especially polymer particles, having an outer shell with a glass transition temperature of from 40° C. to 80° C. and (ii) scattering particles, especially polymer particles, having an inner shell with a glass transition temperature of from 40° C. to 130° C. and an outer shell with a glass transition temperature of from −55° C. to 50° C., wherein the glass transition temperature of the outer shell is preferably lower than that of the inner shell, and with a mean particle size in the range of from 0.1 to 2.5 μm, preferably from 0.2 to 0.8 μm.

In a further preferred embodiment, the heat-sensitive recording material is characterised in that the heat-sensitive layer comprises at least one scattering particle, especially a polymer particle, having a melting temperature lower than 250° C., preferably from 0° C. to 250° C., and having a mean particle size in the range of from 0.1 to 2.5 μm, preferably from 0.2 to 0.8 μm.

A glass transition temperature or a melting temperature lower than 250° C. was found to be advantageous. Above temperatures of 250° C., thermal direct printing is not possible because the temperature-time window is outside the printer specification.

A mean particle size in the range of from 0.1 to 2.5 μm is advantageous, as particles of this size scatter the visible light and thus the colour layer is covered to the greatest possible extent.

The mean particle size can be determined using a Beckman Coulter device (laser diffraction, Fraunhofer method).

The scattering particles, especially the polymer particles, are preferably crystalline, semi-crystalline and/or amorphous.

The above-stated glass transition temperatures refer to semi-crystalline or amorphous scattering particles, especially polymer particles. The melting temperatures refer to crystalline scattering particles, especially polymer particles, or to the crystalline portion of the scattering particles, especially polymer particles.

The scattering particles, especially polymer particles, are preferably closed hollow-body particles, especially hollow-spherical polymer particles, open hollow-body particles, especially lattice cage-shaped polymer particles, and/or solid-body particles, especially irregularly shaped polymer particles.

The primary property of the scattering particles, preferably the polymer particles, is light scattering in the visible range of light. The secondary property is thermal sensitivity.

The polymer particles preferably comprise thermoplastic polymers.

The polymer particles preferably comprise polymers resulting from the polymerisation of one or more monomers selected from the group comprising acrylonitrile, styrene, butadiene, benzyl methacrylate, phenyl methacrylate, ethyl methacrylate, divinylbenzene, 2-hydroxyethyl methacrylate, cyclohexyl methacrylate, 2-methylstyrene, 3-methylstyrene, 4-methylstyrene, alpha-methylstyrene, beta-methylstyrene, acrylamide, methacrylamide, methacrylonitrile, hydroxypropyl methacrylate, methoxystyrene, N-acrylylglycinamide and/or N-methacrylylglycinamide and/or derivatives thereof.

In another embodiment, the polymer particles may be polymerised using a variety of ethylenically unsaturated monomers. Examples of non-ionic monoethylenically unsaturated monomers include styrene, vinyl toluene, ethylene, vinyl acetate, vinyl chloride, vinylidene chloride, acrylonitrile, (meth)acrylamide, various (C₁-C₂₀)-alkyl or (C₃-C₂₀)-alkenyl esters of (meth)acrylic acid, including methyl acrylate (MA), methyl methacrylate (MMA), ethyl (meth)acrylate, butyl (meth)acrylate, 2-hydroxyethyl (meth)acrylate, 2-ethylhexyl (meth)acrylate, benzyl (meth)acrylate, lauryl (meth)acrylate, oleyl (meth)acrylate, palmityl (meth)acrylate and stearyl (meth)acrylate. Typically, acrylic esters such as MMA, EA, BA and styrene are preferred monomers for polymerisation and formation of the shell of the polymer particles. Difunctional vinyl monomers such as divinylbenzene, allyl methacrylate, ethylene glycol dimethacrylate, 1,3-butanediol dimethacrylate, diethylene glycol dimethacrylate, trimethylolpropane trimethacrylate and the like can also be copolymerised to form a crosslinked outer casing, as described in US patent application 2003-0176535 A1.

In another embodiment, the polymer particles preferably comprise (meth)acrylonitrile copolymers, polyvinyl chloride, polyvinylidene chloride, polystyrene, styrene acrylate, styrene (meth)acrylate copolymers, polyacrylonitrile, polyacrylic acid esters or also mixtures of at least two thereof.

The strength and durability of the polymer particles can be influenced by the crosslinking of polymer chains.

The scattering particles, especially the polymer particles, may be in the form of closed polymer particles, open polymer particles and/or solid-body particles, each of which may be regular or irregular in shape.

Examples of closed hollow-body particles include hollow-spherical polymer particles, or polymer particles with a core/casing structure.

Examples of hollow-spherical polymer particles or polymer particles with a core/casing structure are Ropaque HP-1055, Ropaque OP-96 and Ropaque TH-1000.

Especially, so-called “cup-shaped” polymer particles can be mentioned as examples of open polymer particles. With regard to the casing, these have the same materials as the closed polymer particles, especially the closed hollow-spherical polymer particles. In contrast to the classic hollow-body pigments, in which an inner core of gas, usually air, is completely enclosed by a casing formed of organic, usually thermoplastic components, the “cup-shaped” pigments do not have a closed casing and only surround the inner core in the form of a shell or “cup”, which is closed to the greatest possible extent.

As further examples of open polymer particles, lattice cage-shaped polymer particles as described in WO 2021/062230 A1 can be mentioned.

Examples of solid-body particles are polyethylene, polystyrene and cellulose esters.

The above-mentioned polymer particles can be regularly or irregularly shaped.

In an alternative embodiment, the polymer particles are spherical solid-body particles, preferably irregularly shaped, and/or spherical hollow-body particles, both preferably in the form of droplets. These preferably comprise polystyrene, for example Plastic Pigment 756A from Trinseo LLC., and Plastic Pigment 772HS from Trinseo LLC., polyethylene, for example Chemipear 10 W401 from Mitsui Chemical Inc., spherical hollow-body particles (HSP)/spherical hollow-body pigments, for example Ropaque TH-500EF from The Dow Chemical Co., modified polystyrene particles, for example Joncryl 633 from BASF Corp., 1,2-diphenoxyethane (DPE), ethylene glycol m-tolyl ether (EGTE) and/or diphenyl sulfone (DPS). These can be used alone or in any mixtures. These polymer particles preferably have a mean particle size of 0.2 μm, 0.3 μm, 0.4 μm, 0.45 μm, 0.75 μm or 1.0 μm.

The polymer particles are preferably present in the heat-sensitive layer in an amount of from 20 wt. % to 60 wt. %, preferably from 30 wt. % to 50 wt. % in relation to the solids content of the heat-sensitive layer.

Preferably, the heat-sensitive layer comprises at least one heat-sensitive material having a melting temperature in the range of from 40 to 200° C., preferably from 80 to 140° C., and/or a glass transition temperature in the range of from 40 to 200° C., preferably from 80 to 140° C.

Preferably, the heat-sensitive layer comprises at least one heat-sensitive material having a mean particle size of from 0.2 to 4.0 μm, preferably from 0.5 to 2.0 μm. The heat-sensitive material also preferably contributes to the opacity (covering power) of the heat-sensitive layer, e.g. by absorbing and/or also scattering light.

It is assumed that the heat-sensitive material quickly melts locally due to local exposure to heat by the thermal print head of the thermal direct printer, resulting in a local “softening” of the polymer particles, and thus in a local reduction of the covering force (opacity reduction), so that the cover layer becomes translucent and the underlying colour layer becomes visible.

The heat-sensitive material can also be called a sensitiser or thermal solvent.

Preferably, the heat-sensitive material comprises one or more fatty acids, such as stearic acid, behenic acid or palmitic acid, one or more fatty acid amides, such as stearamide, behenamide or palmitamide, an ethylene-bis-fatty acid amide, such as N,N′-ethylene-bis-stearic acid amide or N,N′-ethylene-bis-oleic acid amide, one or more fatty acid alkanolamides, especially hydroxymethylated fatty acid amides, such as N-(hydroxymethyl)stearamide, N-hydroxymethylpalmitamide, hydroxyethylstearamide, one or more waxes, such as polyethylene wax, candelilla wax, carnauba wax or montan wax, one or more carboxylic acid esters, such as dimethylterephthalate, dibenzyl terephthalate, benzyl 4-benzyloxybenzoate, di-(4-methylbenzyl)oxalate, di-(4-chlorobenzyl)oxalate or di-(4-benzyl)oxalate, ketones, such as 4-acetylbiphenyl, one or more aromatic ethers, such as 1,2-diphenoxy-ethane, 1,2-di-(3-methylphenoxy)ethane, 2-benzyloxynaphthalene, 1,2-bis(phenoxymethyl)benzene or 1,4-diethoxynaphthalene, one or more aromatic sulfones, such as diphenylsulfone, and/or an aromatic sulfonamide, such as 2-, 3-, 4-toluenesulfonamide, benzenesulfonanilide or N-benzyl-4-toluenesulfonamide, or one or more aromatic hydrocarbons, such as 4-benzylbiphenyl, or combinations of the above compounds. These can be used alone or in any mixtures.

Stearamide is preferred because it has a favourable price-performance ratio.

The heat-sensitive material is preferably present in the heat-sensitive layer in an amount of from about 10 to about 80 wt. %, especially preferably in an amount of from about 25 to about 60 wt. %, in relation to the total solids content of the heat-sensitive layer.

Optionally, lubricants or release agents can also be present in the heat-sensitive layer. Such lubricants or release agents are present especially if there is no protective layer or no other layer on the heat-sensitive layer.

These agents are preferably fatty acid metal salts, such as zinc stearate or calcium stearate, or also behenate salts, synthetic waxes, e.g. in the form of fatty acid amides, such as stearic acid amide and behenic acid amide, fatty acid alkanolamides, such as stearic acid methylolamide, paraffin waxes of different melting points, ester waxes of different molecular weights, ethylene waxes, propylene waxes of different hardnesses and/or natural waxes, e.g. carnauba wax or montan wax. These can be used alone or in any mixtures.

Zinc stearate is preferred because it has a favourable price-performance ratio.

The lubricant or the release agent is preferably present in the heat-sensitive layer in an amount of from about 1 to about 10 wt. %, especially preferably in an amount of from about 3 to about 6 wt. %, in relation to the total solids content of the heat-sensitive layer.

In a further preferred embodiment, at least one binder is present in the heat-sensitive layer. This is preferably constituted by water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Partially saponified or semi-saponified polyvinyl alcohols are preferred, as they have a favourable price-performance ratio.

The binder is preferably present in the heat-sensitive layer in an amount of from 1 to 30 wt. %, preferably from 5 to 20 wt. %, in relation to the total solids content of the heat-sensitive layer.

In order to achieve specific application-related performance characteristics of heat-sensitive recording materials, the binder is preferably present in crosslinked form in the heat-sensitive layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the colour layer.

In another preferred embodiment, the heat-sensitive layer contains pigments.

These pigments are preferably different from the pigments of the colour layer.

The use of these has the advantage, among other things, that they can fix the chemical melt produced in the thermal printing process on their surface. Pigments can also be used to control the surface whiteness and opacity of the heat-sensitive layer and its printability with conventional printing inks.

Especially suitable pigments are inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Preferred are calcium carbonates, aluminium hydroxides and pyrogenic silicas, as they enable especially advantageous application properties of the heat-sensitive recording materials with regard to their subsequent printability with commercially available printing inks.

The pigments are preferably present in the heat-sensitive layer in an amount of from about 2 to about 50 wt. %, especially preferably in an amount of from about 5 to about 20 wt. %, in relation to the total solids content of the heat-sensitive layer.

The heat-sensitive layer may further comprise carbon black components and/or dyes/colour pigments.

To control the surface whiteness of the heat-sensitive recording material according to the invention, optical brighteners can be incorporated into the heat-sensitive colour-forming layer. These are preferably stilbenes.

The heat-sensitive layer may further contain inorganic oil-absorbing white pigments.

Examples of these inorganic oil-absorbing white pigments include natural or calcined kaolin, silica, bentonite, calcium carbonate, aluminium hydroxide, especially boehmite, and/or mixtures thereof.

The inorganic oil-absorbing white pigments are preferably present in the heat-sensitive layer in an amount of from about 2 to about 50 wt. %, especially preferably in an amount of from about 5 to about 20 wt. %, in relation to the total solids content of the heat-sensitive layer.

In order to improve certain coating properties, it is preferable in individual cases to add further constituents, especially rheology aids, such as thickeners and/or surfactants, to the constituents of the heat-sensitive recording material according to the invention.

The further constituents are each preferably present in customary amounts known to a person skilled in the art.

The heat-sensitive layer preferably has an area density of from 1 to 8 g/m², especially from 2 to 6 g/m².

The heat-sensitive layer preferably has a thickness of from 1 to 10 μm, especially 2 to 8 μm.

In a further preferred embodiment, the heat-sensitive recording material is preferably characterised in that a layer comprising starch (starch coating) and/or modifications thereof (modified starches) is present directly on at least one side of the web-like support material, preferably directly on both sides of the web-like support material.

The starch coating is preferably applied in an amount of from 0.1 to 3, especially preferably from 0.2 to 1.5 g/m².

A starch coating on the side of the web-like support material on which the colour layer is present has the advantage of sealing the web-like support material and thus improving the adhesion of the colour layer and reducing or preventing penetration of the colour layer into the web-like support material.

A starch coating on the side of the web-like support material that does not have the colour layer has the advantage of reducing or preventing the colour layer from bleeding through the web-like support material.

The layer comprising starch preferably has a Bekk smoothness of greater than 20 s, especially preferably of greater than 50 s and very especially preferably from 50 to 200 s.

In a further preferred embodiment, the heat-sensitive recording material is preferably characterised in that a protective layer is present on the heat-sensitive layer.

The protective layer preferably has a Bekk smoothness of greater than 200 s, especially preferably of greater than 400 s and very especially preferably from 400 to 1500 s. A Bekk smoothness of 400 to 1300 s is most preferred.

This is present on the side of the heat-sensitive layer on which the colour layer does not lie.

This protective layer preferably comprises at least one binder and at least one pigment, especially preferably an inorganic pigment.

Suitable binders include water-soluble starches, starch derivatives, starch-based EcoSphere-type biolatices, methyl cellulose, hydroxyethyl cellulose, carboxymethyl cellulose, partially or fully saponified polyvinyl alcohols, chemically modified polyvinyl alcohols, such as acetoacetyl, diacetone, carboxy-, silanol-modified polyvinyl alcohols, or styrene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Suitable inorganic pigments include inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Suitable organic pigments include hollow pigments with a styrene/acrylate copolymer wall or urea/formaldehyde condensation polymers. These can be used alone or in any mixtures.

The binder is preferably present in the protective layer in an amount of from about 40 to about 90 wt. %, especially preferably in an amount of from about 50 to about 80 wt. %, in relation to the total solids content of the protective layer. The pigment is preferably present in the protective layer in an amount of from about 5 to about 40 wt. %, especially preferably in an amount of from about 10 to about 30 wt. %, in relation to the total solids content of the protective layer.

In order to achieve specific application-related performance characteristics of heat-sensitive recording materials, the binder is preferably present in crosslinked form in the protective layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers, etc. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the colour layer.

The protective layer further preferably comprises at least one lubricant or at least one release agent.

These agents are preferably fatty acid metal salts, such as zinc stearate or calcium stearate, or also behenate salts, synthetic waxes, e.g. in the form of fatty acid amides, such as stearic acid amide and behenic acid amide, fatty acid alkanolamides, such as stearic acid methylolamide, paraffin waxes of different melting points, ester waxes of different molecular weights, ethylene waxes, propylene waxes of different hardnesses and/or natural waxes, e.g. carnauba wax or montan wax.

The lubricant or the release agent is preferably present in the protective layer in an amount of from about 1 to about 30 wt. %, especially preferably in an amount of from about 2 to about 20 wt. %, in relation to the total solids content of the protective layer.

To control the surface whiteness of the heat-sensitive recording material according to the invention, optical brighteners, preferably stilbenes, can be incorporated into the protective layer.

The protective layer preferably has an area density of from 0.3 to 5.0 g/m², especially from 1.0 to 3.0 g/m².

The protective layer preferably has a thickness of from 0.3 to 6.0 μm, especially from 0.5 to 2.0 μm.

The use of a protective layer has the advantage that the recording material is better protected against external influences.

In a further preferred embodiment, the heat-sensitive recording material is preferably characterised in that an adhesive layer is present on the web-like support material on the side on which the colour layer is not located.

If a starch coating is present, it lies between the web-like support material and the adhesive layer.

The adhesive layer preferably comprises at least one adhesive, preferably a heat-activatable adhesive, especially a pressure-sensitive adhesive.

Especially preferably, the adhesive, preferably the heat-activatable adhesive and especially the pressure-sensitive adhesive, is a rubber- and/or acrylate-based adhesive.

The adhesive layer preferably has an area density of from 10 to 40 g/m², especially 12 to 25 g/m².

In a further preferred embodiment, the heat-sensitive recording material is preferably characterised in that a siliconised release layer is present on the heat-sensitive layer.

The terms “siliconised release layer” and “siliconised layer” are to be understood synonymously in the sense of “to cover with a layer of silicone”. Preferably, these layers consist of silicone or comprise at least 90 wt. %, preferably at least 95 wt. % and especially preferably at least 99 wt. % and very especially preferably only silicone except for unavoidable traces or auxiliaries (e.g. for UV curing of a siliconisation fluid).

The siliconised release layer preferably has a Bekk smoothness of greater than 400 s, especially preferably greater than 800 s and very especially preferably from 800 to 2000 s.

If a protective layer, especially as defined above, is present on the heat-sensitive layer, the siliconised release layer is preferably located on this protective layer.

In a further preferred embodiment, the heat-sensitive recording material is preferably characterised in that a diffusion layer is formed between the siliconised layer and the underlying layer, preferably the heat-sensitive layer. This diffusion layer is preferably formed by diffusing, areally, at least parts of the siliconised release layer into the upper region of the underlying layer, wherein preferably 5 to 50 wt. %, especially preferably 6 to 45 wt. % and especially 7 to 40 wt. % of the siliconised release layer diffuse into the upper region of the underlying layer. Such a diffusion layer is described, for example, in EP 3 221 153 A1.

A siliconised release layer is preferably present when an adhesive layer, as described above, is also present.

The presence of a siliconised release layer on the heat-sensitive layer and of an adhesive layer on the web-like support material on the side where the colour layer is not located has the advantage that the heat-sensitive recording material can be used as a “linerless” heat-sensitive recording material.

The term “linerless” means that the (self-adhesive) heat-sensitive recording material according to the invention is not applied to a support material, but is wound onto itself. This has the advantage that the production costs can be further reduced, more running metres per roll can be realised, no disposal effort for the disposal of the liner is necessary, and more labels per specific loading space volume can be transported.

If a siliconised release layer is present, it is preferred that at least one platelet-shaped pigment is contained in the heat-sensitive layer or in the layer that lies directly below the siliconised release layer.

The at least one platelet-shaped pigment is preferably selected from the group consisting of kaolin, Al(OH)₃ and/or talc. The use of kaolin is especially preferred.

The use of a coating kaolin is very especially preferred. Such a coating kaolin is available under the trade name Kaolin ASP 109 (BASF, Germany).

The use of these platelet-shaped pigments, especially kaolin, has the especial advantage that the heat-sensitive layer or the layer that lies directly below the siliconised release layer can be siliconised very easily.

A platelet-shaped pigment is understood to mean a pigment in which the diameter to thickness ratio is between about 7 and 40 to 1, preferably between about 15 and 30 to 1.

The particle size of the platelet-shaped pigment is preferably set so that at least about 70%, preferably at least about 85%, of the particles have a particle size of about <2 μm (sedigraph). The pH value of the platelet-shaped pigment in aqueous solution is preferably 6 to 8.

The at least one platelet-shaped pigment is present in the heat-sensitive colour-forming layer or in the layer which lies directly below the siliconised release layer, preferably in an amount of from about 5 to about 60 wt. %, especially preferably in the amount of from about 15 to about 55 wt. %, in relation to the total solids content of the respective layer.

In a further preferred embodiment, the heat-sensitive recording material is preferably characterised in that the siliconised release layer comprises at least one siloxane, preferably a poly(organo)siloxane, especially an acrylic poly(organo)siloxane.

In a further embodiment, the siliconised release layer comprises a mixture of at least two siloxanes. Preferred is a mixture of at least two acrylic-poly(organo)siloxanes.

Examples of very especially preferred siloxanes are siloxanes available under the trade names TEGO® RC902 and TEGO® RC711 (Evonik, Germany).

In another embodiment, the heat-sensitive recording material is preferably characterised in that the siliconised release layer contains at least one polysilicone acrylate, preferably formed by condensation of at least one silicone acrylate.

The siliconised release layer is preferably water-free. It is also preferred that the siliconised release layer does not contain Pt catalysts.

The siliconised release layer preferably contains an initiator, especially preferably a photoinitiator. This serves for the radical curing of the silicone.

Very especially preferred here is the TEGO® photoinitiator A18 (from Evonik, Germany).

The siliconised release layer may preferably contain further additives, such as matting agents and/or adhesion additives.

The siliconised release layer preferably has an area density of from 0.1 to 5.0 g/m², preferably from 0.3 to 5.0 g/m², especially from 1.0 to 3.0 g/m² or 0.2 to 2.0 g/m².

The siliconised release layer preferably has a thickness of from 0.1 to 6, 0 μm, preferably 0.3 to 6.0 μm, especially from 0.5 to 2.0 μm or 0.2 to 1.5 μm.

Due to its hydrophobic character, the application of a siliconised release layer leads to improved resistance properties of the heat-sensitive recording material to hydrophilic agents such as alcohols or water. The siliconised release layer is therefore suitable as protective layer.

All of the above-mentioned layers can be single- or multi-ply.

The heat-sensitive recording material according to the invention according to the fourth and fifth aspect can be obtained by the production method described in conjunction with the first aspect.

The present invention further relates to a heat-sensitive recording material obtainable by the method described above.

The present invention also relates to the use of a heat-sensitive recording material as described above as a sales receipt roll, as an adhesive label (roll), also in the refrigeration and deep-freeze sector, and as a ticket (roll). These have especially a functional side and/or reverse side (with colour, coloured, black/grey) and can be pre-printed. These rolls are preferably available in typical widths and lengths.

In a sixth aspect, the present invention relates to a heat-sensitive recording material comprising a web-like support material, a colour layer on one side of the web-like support material, and a heat-sensitive layer on the colour layer, so that the colour layer is at least partially covered, the heat-sensitive layer being designed so that it becomes translucent due to local action of heat, so that the underlying colour layer becomes visible, characterised in that the heat-sensitive layer contains or consists of scattering particles, especially a heat-sensitive material (as scattering particle), especially a scattering particle, especially a heat-sensitive material (as scattering particle), selected from the group of biopolymers, modified biopolymers, fats, natural waxes, semi-synthetic waxes and/or synthetic waxes.

Such a heat-sensitive recording material is distinguished especially in that sustainable raw substances are used.

Suitable examples of biopolymers include natural biopolymers, such as proteins, peptides, nucleic acids, α-polysaccharides, β-polysaccharides, lipids, polyhydroxyalkanuates, cutin, sulberin and/or lignin.

It is also possible to use so-called technical biopolymers, such as native polymers, bio-based polymers and degradable, petroleum-based polymers.

Examples of native polymers include regenerated fibres, such as viscose and cellophane, and celluloid, as well as thermoplastic starch.

Examples of bio-based polymers include polylactides, polyhydroxybutyrates, lignin-based thermoplastics and/or epoxy acrylates based on oils, especially linseed oil and palm oil.

Examples of degradable petroleum-based polymers include polyester, polyvinyl alcohol, polybutylene adipate terephthalate, polybutylene succinate, polycaprolactone and/or polyglycolide.

These can be used alone or as mixtures.

Suitable examples of modified biopolymers include the esters of cellulose and/or lignin. These can be used alone or as mixtures.

Suitable examples of fats include, for example, fats based on saturated and/or unsaturated fatty acids, such as butyric acid, lauric acid, myristic acid, palmitic acid, stearic acid, arachidic acid, lauroleic acid, myrstoleic acid, palmitoleic acid, oleic acid, linoleic acid, linolenic acid, gadoleic acid and/or arachidonic acid.

Suitable examples of natural waxes include, for example, carnauba wax, candelilla wax and/or montan wax.

Suitable examples of synthetic waxes include, for example, (hydro)carbon waxes, polyolefin waxes, HD-PE waxes, PE waxes, EVA waxes, polyester waxes, polyethylene glycol waxes, PTFE waxes, fluorine waxes, Fischer-Tropsch waxes, synthetic fatty acid esters and/or reconstituted waxes. These can be used alone or as mixtures.

Suitable examples of semi-synthetic waxes include, for example, stearic acid amide wax and/or palmitic acid amide wax. These can be used alone or as a mixture.

The use of waxes from the group of animal waxes, vegetable waxes, mineral waxes and/or microwaxes is also conceivable.

The use of semi-synthetic waxes is preferred, as these have a favourable price-performance ratio.

The biopolymers, the modified bioplymers, the fats, the natural waxes, the semi-synthetic waxes and the synthetic waxes can be used alone or as mixtures.

In one embodiment, the heat-sensitive recording material is preferably characterised in that the scattering particles, preferably the heat-sensitive material, are selected from amide waxes, stearic acid amide waxes, palmitic acid amide waxes or combinations thereof.

Such amide waxes are used because they have a favourable price-performance ratio.

In one embodiment, the heat-sensitive recording material is preferably characterised in that the scattering particles, preferably the heat-sensitive material, are present in the heat-sensitive layer in an amount of from 5 to 100 wt. %, preferably from 40 to 100 wt. %, and especially preferably from 40 to 95 wt. %, in relation to the total weight of the heat-sensitive layer.

In one embodiment, the heat-sensitive recording material is preferably characterised in that the scattering particles, preferably the heat-sensitive material, has a melting temperature in the range of from 30 to 250° C., preferably in the range of from 40 to 200° C.

A melting temperature lower than 250° C. was found to be advantageous; above temperatures of 250° C., thermal direct printing is not possible because the temperature-time window is outside the printer specification.

In one embodiment, the heat-sensitive recording material is preferably characterised in that the scattering particles, preferably the heat-sensitive material, comprise at least one binder and/or at least one pigment.

This binder is preferably constituted by water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Partially saponified or semi-saponified polyvinyl alcohols are preferred, as they have a favourable price-performance ratio.

The binder is preferably present in the heat-sensitive layer in an amount of from 1 to 30 wt. %, preferably from 5 to 20 wt. %, in relation to the total solids content of the heat-sensitive layer.

In order to achieve specific application-related performance characteristics of heat-sensitive recording materials, the binder is preferably present in crosslinked form in the heat-sensitive layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the colour layer.

In another preferred embodiment, the heat-sensitive layer contains pigments.

These pigments are preferably different from the pigments of the colour layer.

The use of these has the advantage, among other things, that they can fix the chemical melt produced in the thermal printing process on their surface. Pigments can also be used to control the surface whiteness and opacity of the heat-sensitive layer and its printability with conventional printing inks.

Especially suitable pigments are inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Preferred are calcium carbonates, aluminium hydroxides and pyrogenic silicas, as they enable especially advantageous application properties of the heat-sensitive recording materials with regard to their subsequent printability with commercially available printing inks.

The pigments are preferably present in the heat-sensitive layer in an amount of from about 2 to about 50 wt. %, especially preferably in an amount of from about 5 to about 20 wt. %, in relation to the total solids content of the heat-sensitive layer.

The heat-sensitive layer may further comprise carbon black components and/or dyes/colour pigments.

To control the surface whiteness of the heat-sensitive recording material according to the invention, optical brighteners can be incorporated into the heat-sensitive colour-forming layer. These are preferably stilbenes.

The heat-sensitive layer may further contain inorganic oil-absorbing white pigments.

Examples of these inorganic oil-absorbing white pigments include natural or calcined kaolin, silica, bentonite, calcium carbonate, aluminium hydroxide, especially boehmite, and/or mixtures thereof.

The inorganic oil-absorbing white pigments are preferably present in the heat-sensitive layer in an amount of from about 2 to about 50 wt. %, especially preferably in an amount of from about 5 to about 20 wt. %, in relation to the total solids content of the heat-sensitive layer.

In order to improve certain coating properties, it is preferable in individual cases to add further constituents, especially rheology aids, such as thickeners and/or surfactants, to the constituents of the heat-sensitive recording material according to the invention.

The further constituents are each preferably present in customary amounts known to a person skilled in the art.

The heat-sensitive layer preferably has an area density of from 1 to 8 g/m², especially from 2 to 6 g/m².

The heat-sensitive layer preferably has a thickness of from 1 to 10 μm, especially 2 to 8 μm.

In a further preferred embodiment, the heat-sensitive recording material is preferably characterised in that the heat-sensitive recording material has a residual moisture of from 2 to 14%, preferably from 2 to 12% and very especially preferably from 3 to 8%. A residual moisture of from 5 to 8% is most preferred.

A residual moisture in the specified range has the advantage that, after printing, there is a high relative print contrast with advantageous application-related properties, such as better legibility.

The residual moisture can be determined as described in conjunction with the examples.

It is assumed that the opacity in the heat-sensitive layer is not only generated by the scattering particles, especially the polymer particles, but also by the air trapped between the scattering particles, especially the polymer particles (open porosity). Penetration of moisture into these “pores” displaces air and reduces opacity. This can result in a greyer material that is not preferred.

In a further preferred embodiment, the heat-sensitive recording material is preferably characterised in that the heat-sensitive recording material has a surface whiteness of from 35 to 60%, especially from 45 to 50%.

The surface whiteness (paper whiteness) can be determined according to ISO 2470-2 (2008) with an Elrepho 3000 spectrophotometer.

In a further preferred embodiment, the heat-sensitive recording material is preferably characterised in that the contrast from locations where the heat-sensitive layer has become translucent due to local action of heat to locations where the heat-sensitive layer has not become translucent due to local action of heat is 40 to 80%, especially from 50 to 70%.

This contrast can be calculated by taking the difference between the optical density of the background and the script. The measurement of the optical density (o. D.) is done, for example, by means of a densitometer.

Preferably, the support material has a Bekk smoothness of greater than 20 s, especially preferably of greater than 30 s and very especially preferably of greater than 50 s on the side to which the colour layer is applied.

The colour layer preferably has a Bekk smoothness of greater than 50 s, especially preferably of greater than 100 s and very especially preferably of greater than 150 s on the side to which the heat-sensitive layer is applied.

The heat-sensitive layer preferably has a Bekk smoothness of greater than 100 s, especially preferably of greater than 250 s, on the side on which the colour layer is not located.

Preferably, the support material has a Bekk smoothness of 20 to 400 s, especially preferably 50 to 300 s and very especially preferably 50 to 200 s on the side to which the colour layer is applied. A Bekk smoothness of 50 to 150 s is most preferred.

The colour layer preferably has a Bekk smoothness of 50 to 400 s, especially preferably 100 to 250 s and very especially preferably 150 to 250 s on the side to which the heat-sensitive layer is applied.

The heat-sensitive layer preferably has a Bekk smoothness of 100 to 1000 s, especially preferably 250 to 800 s, on the side on which the colour layer does not lie. The Bekk smoothness is determined in each case according to DIN 53107 (2016).

Such a heat-sensitive recording material has the advantage of high dynamic sensitivity.

It is advantageous to already present a smooth web-like support material and to maintain this smoothness over the individual coatings. The smoother the substrate is built up from below, the better the final smoothness and thus the sensitivity of the end product.

It is preferred that each layer applied to the web-like support material has a Bekk smoothness on its upper side, i.e. on the side on which the web-like support material does not lie, that is at least as great as or greater than that of the underlying layer.

Preferably, each layer applied to the web-like support material has a Bekk smoothness of at least 5% (percentage increase) on its upper side, i.e. on the side on which the web-like support material does not lie, compared to the underlying layer.

Preferably, each layer applied to the web-like support material has a Bekk smoothness of at least 5% (absolute increase) on its upper side, i.e. on the side on which the web-like support material does not lie, compared to the underlying layer.

The web-like support material is in principle not limited. In a preferred embodiment, the web-like support material comprises paper, synthetic paper and/or a plastics film. The support material preferably has an area density of from 30 to 100 g/m², especially from 40 to 80 g/m².

The web-like support material of the heat-sensitive recording material according to the invention preferably comprises at least one black or coloured side, which is achieved by applying a colour layer. The term “coloured side” is understood to mean that the side has a colour other than white or black. In other words, the heat-sensitive recording material comprises at least one side which is coloured such that it is not white. Embodiments are also possible in which the at least one black or coloured side has several different colours, also in combination with the colour black.

The at least one colour layer on one side of the web-like support material is preferably characterised in that the colour layer comprises at least one pigment and/or a dye and also preferably a binder.

The pigments and/or dyes include various organic and inorganic pigments, dyes and/or carbon black. These can be used alone or in any mixtures.

The pigment, the dye and/or the carbon black are preferably each present in the colour layer in an amount of from 2 to 50 wt. %, especially preferably from 10 to 35 wt. %, in relation to the total solids content of the colour layer.

Preferred binders are water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

The binder is preferably present in the colour layer in an amount of from 2 to 40 wt. %, especially preferably from 10 to 30 wt. %, in relation to the total solids content of the colour layer.

The colour layer preferably has an area density of from 1 to 10 g/m², especially from 3 to 8 g/m².

The colour layer preferably has a thickness of from 1 to 10 μm, especially from 2 to 8 μm.

In a further preferred embodiment, the heat-sensitive recording material is preferably characterised in that an insulation layer is present between the web-like support material and the colour layer.

In an alternative embodiment, the heat-sensitive recording material is preferably characterised in that the colour layer simultaneously constitutes a colour layer and also an insulation layer.

Such an insulation layer or a colour layer, which is simultaneously a colour layer and also an insulation layer, causes a reduction in heat conduction through the heat-sensitive recording material. This makes the local action of heat by means of a thermal direct printer more efficient and a higher thermal printer speed possible. The cover layer becomes translucent more quickly due to the amount of heat introduced and the sensitivity is thus improved.

This means that less dye is needed, which results in improved recyclability in the materials cycle, especially in the waste paper cycle (easier deinkability, separation of dye and support material components).

The insulation layer or the colour layer, which is simultaneously a colour layer and also an insulation layer, preferably has a Bekk smoothness of greater than 50 s, preferably of greater than 100 s and very preferably of 100 to 250 s.

The insulation layer or the colour layer, which is simultaneously a colour layer and also an insulation layer, preferably comprises a heat-insulating material.

Preferably, the heat-sensitive recording material comprising an insulation layer or a colour layer which is simultaneously also an insulation layer has a lower thermal conductivity than a heat-sensitive recording material that does not comprise an insulation layer or a colour layer which is simultaneously also an insulation layer.

The thermally insulating material preferably comprises kaolin, especially preferably calcined kaolin and mixtures thereof.

The thermally insulating material may also comprise hollow-sphere pigments, especially hollow-sphere pigments comprising styrene-acrylate copolymer.

These hollow-sphere pigments preferably have a glass transition temperature of from 40 to 80° C. and/or a mean particle size of from 0.1 to 2.5 μm.

The thermally insulating material is preferably present in the insulation layer in an amount of from about 20 to about 80 wt. %, especially preferably in an amount of from about 40 to about 60 wt. %, in relation to the total solids content of the insulation layer.

In a colour layer which is simultaneously a colour layer and also an insulation layer, the thermally insulating material is preferably present therein in an amount of from about 30 to about 70 wt. %, especially preferably in an amount of from about 40 to about 60 wt. %, in relation to the total solids content of the colour layer which is simultaneously a colour layer and also an insulation layer.

In order to achieve specific application-related performance characteristics of heat-sensitive recording materials, the binder is preferably present in crosslinked form in the insulation layer and/or colour layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0 wt. %, especially preferably in an amount of from about 0.05 to about 15.0 wt. %, in relation to the total solids content of the insulation or colour layer.

The insulation layer preferably has an area density of from 1 to 5 g/m², especially 2 to 4 g/m².

The insulation layer preferably has a thickness of from 1 to 10 μm, especially from 2 to 8 μm.

The colour layer which is simultaneously a colour layer and also an insulation layer preferably has an area density of from 1 to 10 g/m², especially 3 to 8 g/m².

The colour layer which is simultaneously a colour layer and also an insulation layer preferably has a thickness of from 1 to 12 μm, especially from 4 to 8 μm.

In a further preferred embodiment, the heat-sensitive recording material is preferably characterised in that a layer comprising starch (starch coating) and/or modifications thereof (modified starches) is present directly on at least one side of the web-like support material, preferably directly on both sides of the web-like support material.

The starch coating is preferably applied in an amount of from 0.1 to 3, especially preferably from 0.2 to 1.5 g/m².

A starch coating on the side of the web-like support material on which the colour layer is present has the advantage of sealing the web-like support material and thus improving the adhesion of the colour layer and reducing or preventing penetration of the colour layer into the web-like support material.

A starch coating on the side of the web-like support material that does not have the colour layer has the advantage of reducing or preventing the colour layer from bleeding through the web-like support material.

The layer comprising starch preferably has a Bekk smoothness of greater than 20 s, especially preferably of greater than 50 s and very especially preferably from 50 to 200 s.

In a further preferred embodiment, the heat-sensitive recording material is preferably characterised in that a protective layer is present on the heat-sensitive layer.

The protective layer preferably has a Bekk smoothness of greater than 200 s, especially preferably of greater than 400 s and very especially preferably from 400 to 1500 s. A Bekk smoothness of 400 to 1300 s is most preferred. This is present on the side of the heat-sensitive layer on which the colour layer does not lie.

This protective layer preferably comprises at least one binder and at least one pigment, especially preferably an inorganic pigment.

Suitable binders include water-soluble starches, starch derivatives, starch-based EcoSphere-type biolatices, methyl cellulose, hydroxyethyl cellulose, carboxymethyl cellulose, partially or fully saponified polyvinyl alcohols, chemically modified polyvinyl alcohols, such as acetoacetyl, diacetone, carboxy-, silanol-modified polyvinyl alcohols, or styrene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers. These can be used alone or in any mixtures.

Suitable inorganic pigments include inorganic pigments, both of synthetic and natural origin, preferably clays, precipitated or natural calcium carbonates, aluminium oxides, aluminium hydroxides, silicas, precipitated and fumed silicas (e.g. Aerodisp types), diatomaceous earths, magnesium carbonates, talc, kaolin, titanium oxide, bentonite, but also organic pigments, such as hollow pigments with a styrene/acrylate copolymer wall or urea/formaldehyde condensation polymers. These can be used alone or in any mixtures.

Suitable organic pigments include hollow pigments with a styrene/acrylate copolymer wall or urea/formaldehyde condensation polymers. These can be used alone or in any mixtures.

The binder is preferably present in the protective layer in an amount of from about 40 to about 90 wt. %, especially preferably in an amount of from about 50 to about 80 wt. %, in relation to the total solids content of the protective layer.

The pigment is preferably present in the protective layer in an amount of from about 5 to about 40 wt. %, especially preferably in an amount of from about 10 to about 30 wt. %, in relation to the total solids content of the protective layer.

In order to achieve specific application-related performance characteristics of heat-sensitive recording materials, the binder is preferably present in crosslinked form in the protective layer, the optimum degree of crosslinking of the binder being established in the drying step of the coating process in the presence of a crosslinking agent (crosslinker).

The crosslinkers may be polyvalent aldehydes such as glyoxal, dialdehyde starch, glutaraldehyde, possibly in admixture with boric salts (borax), salts or esters of glyoxylic acid, crosslinking agents based on ammonium zirconium carbonate, polyamidoamine-epichlorohydrin resins (PAE resins), adipic acid dihydrazide (AHD), boric acid or its salts, polyamines, epoxy resins, formaldehyde oligomers, cyclic ureas, methylol urea, melamine formaldehyde oligomers and others. These can be used alone or in any mixtures.

Ammonium zirconium carbonate and polyamidoamine epichlorohydrin resins (PAE resins) are especially preferred for food conformity reasons.

Self-crosslinking binders, such as specially modified polyvinyl alcohols or acrylates, enable crosslinking without any crosslinker at all, thanks to the reactive, crosslinkable groups that are already built into the binder polymer.

The crosslinker is preferably present in an amount of from about 0.01 to about 25.0, especially preferably in an amount of from about 0.05 to about 15.0, in relation to the total solids content of the colour layer.

The protective layer further preferably comprises at least one lubricant or at least one release agent.

These agents are preferably fatty acid metal salts, such as zinc stearate or calcium stearate, or also behenate salts, synthetic waxes, e.g. in the form of fatty acid amides, such as stearic acid amide and behenic acid amide, fatty acid alkanolamides, such as stearic acid methylolamide, paraffin waxes of different melting points, ester waxes of different molecular weights, ethylene waxes, propylene waxes of different hardnesses and/or natural waxes, e.g. carnauba wax or montan wax.

The lubricant or the release agent is preferably present in the protective layer in an amount of from about 1 to about 30 wt. %, especially preferably in an amount of from about 2 to about 20 wt. %, in relation to the total solids content of the protective layer.

To control the surface whiteness of the heat-sensitive recording material according to the invention, optical brighteners, preferably stilbenes, can be incorporated into the protective layer.

The protective layer preferably has an area density of from 0.3 to 5.0 g/m², especially from 1.0 to 3.0 g/m².

The protective layer preferably has a thickness of from 0.3 to 6.0 μm, especially from 0.5 to 2.0 μm.

The use of a protective layer has the advantage that the recording material is better protected against external influences.

In a further preferred embodiment, the heat-sensitive recording material is preferably characterised in that an adhesive layer is present on the web-like support material on the side on which the colour layer is not located.

If a starch coating is present, it lies between the web-like support material and the adhesive layer.

The adhesive layer preferably comprises at least one adhesive, preferably a heat-activatable adhesive, especially a pressure-sensitive adhesive.

Especially preferably, the adhesive, preferably the heat-activatable adhesive and especially the pressure-sensitive adhesive, is a rubber- and/or acrylate-based adhesive.

The adhesive layer preferably has an area density of from 10 to 40 g/m², especially 12 to 25 g/m².

In a further preferred embodiment, the heat-sensitive recording material is preferably characterised in that a siliconised release layer is present on the heat-sensitive layer.

The terms “siliconised release layer” and “siliconised layer” are to be understood synonymously in the sense of “to cover with a layer of silicone”. Preferably, these layers consist of silicone or comprise at least 90 wt. %, preferably at least 95 wt. % and especially preferably at least 99 wt. % and very especially preferably only silicone except for unavoidable traces or auxiliaries (e.g. for UV curing of a siliconisation fluid).

The siliconised release layer preferably has a Bekk smoothness of greater than 400 s, especially preferably greater than 800 s and very especially preferably from 800 to 2000 s.

If a protective layer, especially as defined above, is present on the heat-sensitive layer, the siliconised release layer is preferably located on this protective layer.

In a further preferred embodiment, the heat-sensitive recording material is preferably characterised in that a diffusion layer is formed between the siliconised layer and the underlying layer, preferably the heat-sensitive layer. This diffusion layer is preferably formed by diffusing, areally, at least parts of the siliconised release layer into the upper region of the underlying layer, wherein preferably 5 to 50 wt. %, especially preferably 6 to 45 wt. % and especially 7 to 40 wt. % of the siliconised release layer diffuse into the upper region of the underlying layer. Such a diffusion layer is described, for example, in EP 3 221 153 A1.

A siliconised release layer is preferably present when an adhesive layer, as described above, is also present.

The presence of a siliconised release layer on the heat-sensitive layer and of an adhesive layer on the web-like support material on the side where the colour layer is not located has the advantage that the heat-sensitive recording material can be used as a “linerless” heat-sensitive recording material.

The term “linerless” means that the (self-adhesive) heat-sensitive recording material according to the invention is not applied to a support material, but is wound onto itself. This has the advantage that the production costs can be further reduced, more running metres per roll can be realised, no disposal effort for the disposal of the liner is necessary, and more labels per specific loading space volume can be transported.

If a siliconised release layer is present, it is preferred that at least one platelet-shaped pigment is contained in the heat-sensitive layer or in the layer that lies directly below the siliconised release layer.

The at least one platelet-shaped pigment is preferably selected from the group consisting of kaolin, Al(OH)₃ and/or talc. The use of kaolin is especially preferred.

The use of a coating kaolin is very especially preferred. Such a coating kaolin is available under the trade name Kaolin ASP 109 (BASF, Germany).

The use of these platelet-shaped pigments, especially kaolin, has the especial advantage that the heat-sensitive layer or the layer that lies directly below the siliconised release layer can be siliconised very easily.

A platelet-shaped pigment is understood to mean a pigment in which the diameter to thickness ratio is between about 7 and 40 to 1, preferably between about 15 and 30 to 1.

The particle size of the platelet-shaped pigment is preferably set so that at least about 70%, preferably at least about 85%, of the particles have a particle size of about <2 μm (sedigraph). The pH value of the platelet-shaped pigment in aqueous solution is preferably 6 to 8.

The at least one platelet-shaped pigment is present in the heat-sensitive colour-forming layer or in the layer which lies directly below the siliconised release layer, preferably in an amount of from about 5 to about 60 wt. %, especially preferably in the amount of from about 15 to about 55 wt. %, in relation to the total solids content of the respective layer.

In a further preferred embodiment, the heat-sensitive recording material is preferably characterised in that the siliconised release layer comprises at least one siloxane, preferably a poly(organo)siloxane, especially an acrylic poly(organo)siloxane.

In a further embodiment, the siliconised release layer comprises a mixture of at least two siloxanes. Preferred is a mixture of at least two acrylic-poly(organo)siloxanes.

Examples of very especially preferred siloxanes are siloxanes available under the trade names TEGO® RC902 and TEGO® RC711 (Evonik, Germany).

In another embodiment, the heat-sensitive recording material is preferably characterised in that the siliconised release layer contains at least one polysilicone acrylate, preferably formed by condensation of at least one silicone acrylate.

The siliconised release layer is preferably water-free. It is also preferred that the siliconised release layer does not contain Pt catalysts.

The siliconised release layer preferably contains an initiator, especially preferably a photoinitiator. This serves for the radical curing of the silicone.

Very especially preferred here is the TEGO® photoinitiator A18 (from Evonik, Germany).

The siliconised release layer may preferably contain further additives, such as matting agents and/or adhesion additives.

The siliconised release layer preferably has an area density of from 0.3 to 5.0 g/m², especially from 1.0 to 3.0 g/m².

The siliconised release layer preferably has a thickness of from 0.3 to 6.0 μm, especially from 0.5 to 2.0 μm.

All of the above-mentioned layers can be single- or multi-ply.

The heat-sensitive recording material according to the invention according to the sixth aspect can be obtained by the production method described in conjunction with the first aspect.

The present invention further relates to a heat-sensitive recording material obtainable by the method described above.

The present invention also relates to the use of a heat-sensitive recording material as described above as a sales receipt roll, as an adhesive label (roll), also in the refrigeration and deep-freeze sector, and as a ticket (roll). These have especially a functional side and/or reverse side (with colour, coloured, black/grey) and can be pre-printed. These rolls are preferably available in typical widths and lengths.

In the following, especially preferred embodiments of the invention according to aspects 1 to 6 above are explained in greater detail.

An especially preferred first embodiment comprises a heat-sensitive recording material having a web-like support material, a colour layer applied thereto and a heat-sensitive layer on the colour layer.

In this first embodiment, the web-like support material comprises a paper.

In this first embodiment, the colour layer comprises at least one pigment and/or a dye and preferably a binder.

In this first embodiment, the heat-sensitive layer comprises the above-mentioned embodiments.

An especially preferred second embodiment comprises a heat-sensitive recording material having a web-like support material, an insulation layer applied thereto, a colour layer applied to the insulation layer and a heat-sensitive layer on the colour layer.

In this second embodiment, the web-like support material comprises paper.

In this second embodiment, the insulation layer comprises a thermally insulating material, preferably kaolin, especially preferably calcined kaolin and mixtures thereof, or hollow-sphere pigments, especially hollow-sphere pigments comprising styrene-acrylate copolymer.

In this second embodiment, the colour layer comprises at least one pigment and/or a dye and also preferably a binder.

In this second embodiment, the heat-sensitive layer comprises the above-mentioned embodiments.

An especially preferred third embodiment comprises a heat-sensitive recording material having a web-like support material, a colour layer applied thereto, which is simultaneously an insulation layer, and a heat-sensitive layer on the colour layer.

In this third embodiment, the web-like support material comprises paper.

In this third embodiment, the colour layer, which is simultaneously an insulation layer, comprises a thermally insulating material, preferably kaolin, especially preferably calcined kaolin and mixtures thereof, or hollow-sphere pigments, especially hollow-sphere pigments comprising styrene-acrylate copolymer.

In this third embodiment, the heat-sensitive layer comprises the above-mentioned embodiments.

An especially preferred fourth embodiment comprises a heat-sensitive recording material having a web-like support material, which on both sides has a starch coating, a colour layer applied thereto and a heat-sensitive layer on the colour layer.

In this fourth embodiment, the web-like support material comprises paper.

In this fourth embodiment, the colour layer comprises at least one pigment and/or a dye and also preferably a binder.

In this fourth embodiment, the heat-sensitive layer comprises the above-mentioned embodiments.

An especially preferred fifth embodiment comprises a heat-sensitive recording material having a web-like support material, a colour layer applied thereto and a heat-sensitive layer on the colour layer, a protective layer being applied to the heat-sensitive layer.

In this fifth embodiment, the web-like support material comprises paper.

In this fifth embodiment, the colour layer comprises at least one pigment and/or a dye and also preferably a binder.

In this fifth embodiment, the heat-sensitive layer comprises the above-mentioned embodiments.

In this fifth embodiment the protective layer comprises at least one binder and at least one pigment, especially preferably an inorganic pigment.

An especially preferred sixth embodiment comprises a heat-sensitive recording material having a web-like support material, an insulation layer applied thereto, a colour layer applied to the insulation layer and a heat-sensitive layer on the colour layer, a protective layer being applied to the heat-sensitive layer.

In this sixth embodiment, the web-like support material comprises paper.

In this sixth embodiment, the insulation layer comprises a thermally insulating material, preferably kaolin, especially preferably calcined kaolin and mixtures thereof, or hollow-sphere pigments, especially hollow-sphere pigments comprising styrene-acrylate copolymer.

In this sixth embodiment, the colour layer comprises at least one pigment and/or a dye and also preferably a binder.

In this sixth embodiment, the heat-sensitive layer comprises the above-mentioned embodiments.

In this sixth embodiment the protective layer preferably comprises at least one binder and at least one pigment, especially preferably an inorganic pigment.

An especially preferred seventh embodiment comprises a heat-sensitive recording material having a web-like support material, a colour layer applied thereto, which is simultaneously an insulation layer, and a heat-sensitive layer on the colour layer, a protective layer being applied to the heat-sensitive layer.

In this seventh embodiment, the web-like support material comprises paper.

In this seventh embodiment, the colour layer, which is simultaneously an insulation layer, comprises a thermally insulating material, preferably kaolin, especially preferably calcined kaolin and mixtures thereof, or hollow-sphere pigments, especially hollow-sphere pigments comprising styrene-acrylate copolymer.

In this seventh embodiment, the heat-sensitive layer comprises the above-mentioned embodiments.

In this seventh embodiment the protective layer preferably comprises at least one binder and at least one pigment, especially preferably an inorganic pigment.

An especially preferred eighth embodiment comprises a heat-sensitive recording material having a web-like support material, which on both sides has a starch coating, a colour layer applied thereto and a heat-sensitive layer on the colour layer, a protective layer being applied to the heat-sensitive layer.

In this eighth embodiment, the web-like support material comprises paper.

In this eighth embodiment, the colour layer comprises at least one pigment and/or a dye and also preferably a binder.

In this eighth embodiment, the heat-sensitive layer comprises the above-mentioned embodiments.

In this eighth embodiment the protective layer preferably comprises at least one binder and at least one pigment, especially preferably an inorganic pigment.

An especially preferred ninth embodiment comprises a heat-sensitive recording material having a web-like support material, an adhesive layer on the underside and a colour layer applied to the other side of the web-like support material and a heat-sensitive layer on the colour layer, a siliconised layer being applied to the heat-sensitive layer.

In this ninth embodiment the adhesive layer comprises an adhesive, preferably a heat-curable adhesive, especially a pressure-sensitive adhesive.

In this ninth embodiment, the web-like support material comprises paper.

In this ninth embodiment, the colour layer comprises at least one pigment and/or a dye and also preferably a binder.

In this ninth embodiment, the heat-sensitive layer comprises the above-mentioned embodiments.

In this ninth embodiment the siliconised layer comprises at least one siloxane, preferably a poly(organo)siloxane.

An especially preferred tenth embodiment comprises a heat-sensitive recording material having a web-like support material, an adhesive layer on the underside and an insulation layer applied to the other side of the web-like support material, a colour layer applied to the insulation layer and a heat-sensitive layer on the colour layer, a siliconised layer being applied to the heat-sensitive layer.

In this tenth embodiment the adhesive layer comprises an adhesive, preferably a heat-curable adhesive, especially a pressure-sensitive adhesive.

In this tenth embodiment, the web-like support material comprises paper.

In this tenth embodiment, the insulation layer comprises a thermally insulating material, preferably kaolin, especially preferably calcined kaolin and mixtures thereof, or hollow-sphere pigments, especially hollow-sphere pigments comprising styrene-acrylate copolymer.

In this tenth embodiment, the colour layer comprises at least one pigment and/or a dye and also preferably a binder.

In this tenth embodiment, the heat-sensitive layer comprises the above-mentioned embodiments.

In this tenth embodiment the siliconised layer comprises at least one siloxane, preferably a poly(organo)siloxane.

An especially preferred eleventh embodiment comprises a heat-sensitive recording material having a web-like support material, an adhesive layer on the underside and a colour layer applied to the other side of the web-like support material, which colour layer is simultaneously an insulation layer, and a heat-sensitive layer on the colour layer, a siliconised layer being applied to the heat-sensitive layer.

In this eleventh embodiment the adhesive layer comprises an adhesive, preferably a heat-curable adhesive, especially a pressure-sensitive adhesive.

In this eleventh embodiment, the web-like support material comprises paper.

In this eleventh embodiment, the colour layer, which is simultaneously an insulation layer, comprises a thermally insulating material, preferably kaolin, especially preferably calcined kaolin and mixtures thereof, or hollow-sphere pigments, especially hollow-sphere pigments comprising styrene-acrylate copolymer.

In this eleventh embodiment, the heat-sensitive layer comprises the above-mentioned embodiments.

In this eleventh embodiment the siliconised layer comprises at least one siloxane, preferably a poly(organo)siloxane.

An especially preferred twelfth embodiment comprises a heat-sensitive recording material having a web-like support material, which on both sides has a starch coating, an adhesive layer on the underside, and a colour layer applied to the other side of the web-like support material and a heat-sensitive layer on the colour layer, a siliconised layer being applied to the heat-sensitive layer.

In this twelfth embodiment the adhesive layer comprises an adhesive, preferably a heat-curable adhesive, especially a pressure-sensitive adhesive.

In this twelfth embodiment, the web-like support material comprises paper.

In this twelfth embodiment, the colour layer comprises at least one pigment and/or a dye and also preferably a binder.

In this twelfth embodiment, the heat-sensitive layer comprises the above-mentioned embodiments.

In this twelfth embodiment the siliconised layer comprises at least one siloxane, preferably a poly(organo)siloxane.

An especially preferred thirteenth embodiment comprises a heat-sensitive recording material having a web-like support material, which on both sides has a starch coating, an adhesive layer on the underside, and a colour layer applied to the other side of the web-like support material and a heat-sensitive layer on the colour layer, a protective layer being applied to the heat-sensitive layer, and a siliconised layer being applied to said protective layer.

In this thirteenth embodiment the adhesive layer comprises an adhesive, preferably a heat-curable adhesive, especially a pressure-sensitive adhesive.

In this thirteenth embodiment, the web-like support material comprises paper.

In this thirteenth embodiment, the colour layer comprises at least one pigment and/or a dye and also preferably a binder.

In this thirteenth embodiment, the heat-sensitive layer comprises the above-mentioned embodiments.

In this thirteenth embodiment the protective layer preferably comprises at least one binder and at least one pigment, especially preferably an inorganic pigment.

In this thirteenth embodiment the siliconised layer comprises at least one siloxane, preferably a poly(organo)siloxane.

An especially preferred fourteenth embodiment comprises a heat-sensitive recording material having a web-like support material, a colour layer applied thereto and a heat-sensitive layer on the colour layer, the heat-sensitive layer merely comprising a wax.

In this fourteenth embodiment, the web-like support material comprises paper.

In this fourteenth embodiment, the colour layer comprises at least one pigment and/or a dye and also preferably a binder.

The embodiments mentioned in the preferred embodiments one to thirteen described above with respect to the heat-sensitive layer comprise, especially, the following embodiments:

The heat-sensitive layer comprises at least one polymer particle having a glass transition temperature of from −55° to 130° C., preferably from 40⁰ to 80° C.

The heat-sensitive layer comprises at least one polymer particle having a core/casing structure, wherein the polymer particles are selected from the group consisting of (i) polymer particles having an outer polymer shell with a glass transition temperature of from 40° C. to 800° C. and (ii) polymer particles having an inner polymer shell with a glass transition temperature of from 40° C. to 130° C. and an outer polymer shell with a glass transition temperature of from −55° C. to 50° C., wherein the glass transition temperature of the outer polymer shell is preferably lower than that of the inner polymer shell.

The heat-sensitive layer comprises at least one polymer particle having a melting temperature lower than 250° C., preferably from 0° to 250° C.

The heat-sensitive layer comprises at least one polymer particle having a mean particle size in the range of from 0.1 to 2.5 lim.

In a further preferred embodiment BA, the heat-sensitive layer of any heat-sensitive recording material according to the invention as described above under aspects 1 to 6, especially one of the following heat-sensitive recording materials according to the invention according to claim 41 or claim 85:
according to claim 41:
a heat-sensitive material, comprising a web-like support material,
a colour layer on one side of the web-like support material and a heat-sensitive layer on the colour layer so that the colour layer is at least partially covered,
the heat-sensitive layer being designed so that it becomes translucent due to local action of heat, so that the underlying colour layer becomes visible, characterised in that
the heat-sensitive layer comprises 10 to 90 wt. % of scattering particles, especially polymer particles having a mean particle size in the range of from 0.1 to 2.5 μm, 10 to 80 wt. % of a heat-sensitive material having a melting temperature in the range of from 40 to 200° C. and/or a glass transition temperature in the range of from 40 to 200° C., and 1 to 30 wt. % of a binder;
according to claim 85:
a heat-sensitive material, comprising a web-like support material, a colour layer on one side of the web-like support material and a heat-sensitive layer on the colour layer so that the colour layer is at least partially covered,
the heat-sensitive layer being designed so that it becomes translucent due to local action of heat, so that the underlying colour layer becomes visible, characterised in that
the heat-sensitive layer contains or consists of scattering particles,
especially a heat-sensitive material as scattering particles, especially a heat-sensitive material selected from the group of biopolymers, modified biopolymers, fats, natural waxes, semi-synthetic waxes and/or synthetic waxes, with semi-synthetic waxes being preferred;
   comprises at least one of the following features or any combination of the following features:
the scattering particles preferably have at least one of the following features:
   a) the scattering particle is a wax which has a melting point in the range of from 60° C. to 180° C., especially an amide wax;
   b) the scattering particle is a fatty acid, especially stearic acid and/or palmitic acid;
   c) the scattering particle is a polybutylene succinate (PBS);
   d) the scattering particle is a polybutylene succinate (PBSA);
   e) scattering particles are present in a total amount in the range of from a) 10 to <40 wt. % or b) 40 to 78 wt. %, especially 44 to 73 wt. %, further preferably in the range of from 50 to 67 wt. % or c)>78 to 90 wt. %, in relation to the dry mass of the heat-sensitive layer;
the binder comprises at least one polymeric binder;
the heat-sensitive layer comprises at least one inorganic pigment as an additional scattering particle;
the heat-sensitive layer comprises substantially no (colour) developers or leuco compounds;
preferably, the mean particle size of the scattering particles and the additional scattering particles is in the range of from 0.1 to 2.5 μm;
preferably, the particle size or particle size distribution is suitable to scatter light in the visible range of light and thus contribute to the coverage of the underlying colour layer by the heat-sensitive layer in addition to the light absorption of the materials and components used. Preferably, therefore, the mean particle size D(4,3) of the scattering particles is in the range of from 0.1 to 2.5 μm or the particle diameter D50 of the scattering particles is preferably in the range of from 0.1 to 2.5 μm, preferably 0.8 to 2.0 μm, further preferably 1.0 to 1.8 μm, further preferably in the range of from 1.2 to 1.6 μm;
the quantity ratio between the wax as scattering particle, especially the amide wax, and the inorganic pigment preferably has a value in the range of from 2:8 to 9:1, preferably from 2.5:7.5 to 7.5:2.5, further preferably from 0.3:0.7 to 0.7:0.3. A high wax content has a beneficial effect on the dynamic sensitivity and on the optical density (OD773), although in some examples an optimum could be achieved at a ratio of preferably 6.5:3.5;
the binder is preferably present in a total amount in the range of from 1 to 30 wt. %, preferably 2 to 20 wt. %, further preferably 4 to 16.5 wt. %, in relation to the dry mass of the heat-sensitive layer;
the inorganic pigment is preferably present in a total amount in the range of from 18 to 50 wt. %, preferably 22 to 45 wt. %, especially preferably in the range of from 25 to 39 wt. %, in relation to the dry mass of the heat-sensitive layer;
the amide wax is preferably a monoamide of a saturated fatty acid, the fatty acid residue of which has a total number of carbon atoms in the range of from 14 to 20, preferably in the range of from 16 to 18, and especially preferably the amide wax is stearamide (stearic acid amide, octadecanoic acid amide);
the dry mass per unit area of the heat-sensitive layer is especially in the range of from 2 g/m² to 15 g/m², preferably in the range of from 2.5 g/m² to 12 g/m², especially preferably in the range of from 3 g/m² to 10 g/m²;
the inorganic pigment is preferably selected from the group consisting of calcined kaolin, natural kaolin, kaolinite, magnesium silicate hydrate, silicon dioxide, bentonite, calcium carbonate, calcium silicate, especially calcium silicate hydrate, calcium aluminate sulfate, aluminium hydroxide, aluminium oxide and boehmite;
the inorganic pigment preferably has a particle diameter d50 in the range of from 0.2 to 2.0 μm, preferably 0.8 to 2.0 μm, further preferably 1.0 to 1.8 μm, further preferably in the range of from 1.2 to 1.6 μm;
the one or more polymeric binders are preferably selected from the group consisting of starch, modified starch, polyvinyl alcohol and/or modified polyvinyl alcohol;
preferably, the scattering particles are a fatty acid, especially stearic acid and/or palmitic acid, which presumably form hydrogen bonds with the polar binder, especially with polyvinyl alcohol or modified polyvinyl alcohol, which surprisingly has a positive influence on the print contrast and optical density of the resulting heat-sensitive recording materials.

The heat-sensitive recording materials according to the invention, especially those according to the preferred embodiments BA preferably have an optical density (OD773) of at least 1.10+/−2%, preferably at least 1.15+/−2%, especially preferably of 1.20+/−2% and even more preferably of 1.25+/−2%, with an area density of the heat-sensitive layer of preferably less than 7 g/m², preferably less than 6 g/m², especially preferably less than 5 g/m² and even more preferably less than 4 g/m². These good and very good to excellent optical densities (OD773) result especially from the previously described features and measures according to the invention, individually or in combination.

The heat-sensitive recording material according to the invention comprising the heat-sensitive layer can preferably be used as a sales receipt (roll), adhesive label (roll), ticket (roll), temperature indicator, security paper, admission ticket, voucher, self-adhesive label, ticket, TITO ticket (ticket-in, ticket-out), airline, train, ship or bus ticket, parking ticket, label, betting slip, cash receipt, bank statement, medical and/or technical chart paper, fax paper or security paper.

By means of the following examples, this preferred embodiment BA will be explained in more detail without limiting its scope.

On a Fourdrinier paper machine, a paper web of bleached and ground hardwood and softwood pulps with area densities of 41, 42 and 58 g/m² was produced as a web-like support material with the addition of usual additives in usual amounts and with a Bekk smoothness on at least one side of greater than 20 s.

Subsequently, on a conventional coating machine using carbon black as dye/colour pigment, the colour layers according to Examples 1 to 5 were applied to the smooth side of the support material (paper web), conventionally dried and smoothed, so that a Bekk smoothness of the colour layer of >100 s is obtained.

For the production of the heat-sensitive layers, two suspensions—a wax suspension and a pigment suspension—were produced and then mixed with the ratios given in the following table to obtain the required coating compositions. The coating composition was prepared here following the solution described in EP 3957489 A1. Deviating from this, both the wax and the pigment were present in a particle size distribution to be suitable as scattering particles and as additional scattering particles.

The constituents of the suspensions are given in the following tables:

### Composition of the Pigment Dispersion:

| Constituent | Amount [o-dry, %] | Amount [a-dry, g] |
|---|---|---|
| Water | — | 53.5 |
| Calcium silicate hydrate | 85 | 117.1 |
| Polyvinyl alcohol | 15 | 79.4 |
| Sum | 100 | 250.0 |

### Composition of the Wax Dispersion:

| Constituent | Amount [o-dry, %] | Amount [a-dry, g] |
|---|---|---|
| Water | — | 0.3 |
| Stearic acid amide | 85 | 170.3 |
| Polyvinyl alcohol | 15 | 79.4 |
| Sum | 100 | 250.0 |

### Composition of the Coating Compositions: EXAMPLES: QUANTITY SHARE OF PIGMENT SUSPENSIONS/QUANTITY SHARE OF WAX SUSPENSIONS

Example BA1 70%/30%
Example BA2 50%/50%
Example BA3 40%/60%
Example BA4 30%/70%

Example BA5 With a fixed ratio of calcium silicate hydrate (pigment) to stearic acid amide (scattering particles) of 4:6 and of 3:7, the proportion of polyvinyl alcohol (binder) of the coating composition was varied in the range of from 4% to 30%.

Using a conventional coating machine, these coating compositions were applied to the colour layer by means of a roller blade coater to produce heat-sensitive layers with an area density of 3, 3.5, 4, 5, 6 and 7 g/m², dried conventionally after application and smoothed to obtain a Bekk smoothness of >100 s.

For comparison purposes, using a standard coating device, these coating compositions were applied to the colour layer by means of a standard curtain coating process to produce heat-sensitive layers with an area density of 2, 3, 3.5, 4, 5, 6 and 7 g/m², dried conventionally after application and smoothed to obtain a Bekk smoothness of >100 s, with substantially the same results being achievable as for the coating by means of roller blade coater.

The drying operations, especially those of the carrier material and also all of the layers, especially the heat-sensitive recording layer, were performed such that the residual moisture of the heat-sensitive recording material lies in the range of from 2% to 14%.

These values were then determined as described beforehand under chapters “1) Dynamic colour density” and “2) Relative print contrast”. In addition, the dynamic sensitivity was measured with the methods described in chapter “1) Dynamic colour density” (optical density o.d. or OD against energy input in mJ/mm²), wherein the heat-sensitive recording materials (strips 6 cm wide) were thermally printed and measured using a GeBE PrinterLab GPT-10000 test printer (company: GeBE Elektronik und Feinwerktechnik GmbH, Germany) with a Kyocera print bar of 305 dpi at an applied voltage of 24 V with graduated energy inputs in the range of from 0 to 16 mJ/mm². In addition, the optical density (OD773) was determined for the energy input of 7.73 mJ/mm². For understanding, see also FIG. 14 and the corresponding description.

Especially, Examples BA3 to BA5 (with a binder content of 20% or more) showed an excellent optical density (OD773) of at least 1.15 ODU at an energy input at 7.73 mJ/mm² (optical density, OD773) and at energy inputs >7.73 mJ/mm² of >1.15 ODU, moreover already at economical and especially environmentally friendly area densities of the heat-sensitive layer of 3 g/m² and above.

The heat-sensitive recording materials according to the invention, which have an optical density (OD773) of at least 1.15 after thermal printing, can be used in commercially available thermal printers using the usual printing parameters (printing speed, temperature of the print head, energy input) and at the same time fulfil all the essential requirements of the print image to be achieved (legibility of the print image or barcode legibility).

Further examples were produced with a) an insulation layer between the support material and the colour layer as in Example 6 or 12 and with b) a layer which is simultaneously colour layer and also insulation layer as in Examples 1 to 5 and 7 to 11, with exactly these heat-sensitive layers according to Examples BA1 to BA5.

The heat-sensitive recording materials thus obtained showed even slightly improved results in dynamic sensitivity compared to those previously reported, and, for an energy input at 7.73 mJ/mm² (optical density, OD773), an excellent optical density (OD773) of at least 1.20 ODU, and, for energy inputs >7.73 mJ/mm² of >1.20 ODU.

In further examples, the amount of calcium silicate hydrate used was partially or completely replaced by calcium carbonate. The heat-sensitive recording materials obtained in this way also showed comparably good results in dynamic sensitivity, also in relative print contrast and optical density (OD773).

In further examples, the amount of stearic acid amide used was partially or completely replaced by polybutylene succinate (PBS) or polybutylene succinate adipate (PBSA) or by mixtures of PBS and PBSA. The heat-sensitive recording materials obtained in this way also showed comparably good results in dynamic sensitivity and also in optical density (OD773) and relative print contrast.

In further examples, on a Fourdrinier paper machine, paper webs of bleached and ground hardwood and softwood pulps with area densities of 41 and 58 g/m² were produced as a web-like support material with the addition of usual additives in usual amounts and were provided with usual front- and rear-side coatings (paper webs coated on one or both sides), especially with usual starch-based precoats (starch layer) and were produced with a Bekk smoothness of greater than 20 s on at least one side. These front- and rear-side coatings improve the application and adhesion of the further layers, e.g. the insulation layer or the colour layer, or on the opposite side of the adhesive layer or a print layer, e.g. a print layer as rear-side printing of the heat-sensitive recording material with usual colour printing methods for advertising or information purposes (e.g. “This receipt is environmentally friendly”).

In further examples, these heat-sensitive layers were provided with a) protective layers, b) siliconised release layers or c) protective layers and siliconised release layers on the protective layers. In further examples, the heat-sensitive recording materials thus provided with a siliconised release layer were provided with an adhesive layer on their rear side and further processed and rolled into commercially available rolls for adhesive labels, e.g. for use in direct food contact, provided of course that all materials, raw substances and processes are certified and approved accordingly beforehand, as thermal printer adhesive labels in fruit and vegetable, cheese, fish, meat or sausage departments of supermarkets.

By taking into account the measures and features according to the invention, it could furthermore be shown that also known coating compositions, e.g. from EP 3957489 A1, can be further improved and thus also improved heat-sensitive recording materials can be obtained which, in addition to the required optical densities (final blackness >1.15 and OD773) and relative print contrasts, also exhibit excellent properties with respect to external influences. Thus, the heat-sensitive recording materials according to the invention also exhibit excellent shelf life of the unprinted and the unprinted heat-sensitive recording materials according to some practical examples BA, especially BA3 to BA5 (for the measuring method, see the chapter on shelf life), even under extreme conditions, e.g. as a parking ticket printed by means of a thermal printer in the summer heat and left in the interior of a car for several hours (Tₘₐₓ 60° C.), the printed image of the parking ticket continues to remain very easily legible.

### DESCRIPTION OF THE FIGURES

In the following figures, different layer structures for exemplary heat-sensitive recording materials according to the invention are shown schematically. The composition of the individual layers is to be understood as defined above for each layer.

FIG. 1: a heat-sensitive recording material having a web-like support material, a colour layer applied thereto and a heat-sensitive layer on the colour layer.

FIG. 2: a heat-sensitive recording material having a web-like support material, an insulation layer applied thereto, a colour layer applied to the insulation layer and a heat-sensitive layer on the colour layer.

FIG. 3: a heat-sensitive recording material having a web-like support material, a colour layer applied thereto, which is simultaneously an insulation layer, and a heat-sensitive layer on the colour layer.

FIG. 4: a heat-sensitive recording material having a web-like support material, which on both sides has a starch coating, a colour layer applied thereto and a heat-sensitive layer on the colour layer.

FIG. 5: a heat-sensitive recording material having a web-like support material, a colour layer applied thereto and a heat-sensitive layer on the colour layer, a protective layer being applied to the heat-sensitive layer.

FIG. 6: a heat-sensitive recording material having a web-like support material, an insulation layer applied thereto, a colour layer applied to the insulation layer and a heat-sensitive layer on the colour layer, a protective layer being applied to the heat-sensitive layer.

FIG. 7: a heat-sensitive recording material having a web-like support material, a colour layer applied thereto, which is simultaneously an insulation layer, and a heat-sensitive layer on the colour layer, a protective layer being applied to the heat-sensitive layer.

FIG. 8: a heat-sensitive recording material having a web-like support material, which on both sides has a starch coating, a colour layer applied thereto and a heat-sensitive layer on the colour layer, a protective layer being applied to the heat-sensitive layer.

FIG. 9: a heat-sensitive recording material having a web-like support material, an adhesive layer on the underside and a colour layer applied to the other side of the web-like support material and a heat-sensitive layer on the colour layer, a siliconised layer being applied to the heat-sensitive layer.

FIG. 10: a heat-sensitive recording material having a web-like support material, an adhesive layer on the underside and an insulation layer applied to the other side of the web-like support material, a colour layer applied to the insulation layer and a heat-sensitive layer on the colour layer, a siliconised layer being applied to the heat-sensitive layer.

FIG. 11: a heat-sensitive recording material having a web-like support material, an adhesive layer on the underside and a colour layer applied to the other side of the web-like support material, which colour layer is simultaneously an insulation layer, and a heat-sensitive layer on the colour layer, a siliconised layer being applied to the heat-sensitive layer.

FIG. 12: a heat-sensitive recording material having a web-like support material, which on both sides has a starch coating, an adhesive layer on the underside, and a colour layer applied to the other side of the web-like support material and a heat-sensitive layer on the colour layer, a siliconised layer being applied to the heat-sensitive layer.

FIG. 13: a heat-sensitive recording material having a web-like support material, which on both sides has a starch coating, an adhesive layer on the underside, and a colour layer applied to the other side of the web-like support material and a heat-sensitive layer on the colour layer, a protective layer being applied to the heat-sensitive layer, and a siliconised layer being applied to said protective layer.

FIG. 14: measurement of the dynamic sensitivity of heat-sensitive recording materials, the support material having different Bekk smoothnesses. Shown is the dynamic sensitivity (optical density (ODU)) in dependence on the energisation energy E of three recording materials having different base papers:
A: Uncalendered, smoothness 210 Bekk [s],
B: Calendered, line pressure 0.5 bar, smoothness 490 Bekk [s],
C: Calendered, line pressure 2×10 bar, smoothness 1276 Bekk [s].

### EXAMPLES

The invention will be explained in greater detail below with reference to some non-limiting examples.

Heat-sensitive recording materials according to the invention were prepared with the compositions according to Tables 1 to 6.

In all examples, a paper substrate made of hardwood and softwood pulps with an area density of 41 or 58 g/m² is used as the support material.

All stated area densities refer to the particular dried layer.

The dry contents (TG) of the respective layer formulations are adjusted by adding water as follows: insulation layer (30%), colour layer (26%), heat-sensitive layer (20%) and protective layer (10%).

The raw substances used are employed as a dispersion or as a solution with the following dry contents: Ropaque HP-1055 (21%), styrene butadiene latex (48%), carbon black (45%), Ropaque OP-96 (30%), sodium metaborate tetrahydrate (2%), stearic acid amide wax (22%), silicon oxide (28%), zinc stearate (35%), polyvinyl alcohol (high-viscosity) (10%), calcined kaolin (45%), precipitated calcium carbonate (58%), ammonium zirconium carbonate (9%), polyvinyl alcohol (low viscosity) (7%) and kaolin (75%).

The stated amounts [wt. %] relate to the oven-dry state (o-dry).

### 1. Example 1

In practical example 1, the colour layer and the heat-sensitive layer are applied consecutively by single and/or simultaneously by double curtain coater to the paper substrate at a speed of 900 m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 1
Composition of the individual layers of the heat-sensitive
recording material according to Example 1.
Example 1 (FIG. 3)

| | Formulation | Formulation | | |
|---|---|---|---|---|
| Layer area | constituent | constituent | | Amount |
| density | trade name | chemical name | Function | [wt. %] |
| Colour layer | Ropaque HP-1055, | Styrene-acrylate | Scattering particle/ | 52.3 |
| 5.2 g/m² | company: Dow | copolymer | polymer particle | |
| | Latex, company: | Styrene-butadiene- | Binder | 25.7 |
| | Styron | latex | | |
| | | Carbon black | Dye/Colour pigment | 21.2 |
| | n.a. | n.a. | Rheology aid | Remainder |
| Heat- | Ropaque OP-96, | Styrene-acrylate | Scattering particle/ | 35.1 |
| sensitive | company: Dow | copolymer | polymer particle | |
| layer | | Sodium- | Crosslinker | 0.7 |
| 3.5 g/m² | | metaborate | | |
| | | tetrahydrate | | |
| | company: Chukyo | Stearic acid amide | Heat-sensitive | 40.4 |
| | | wax | material | |
| | | Silicon oxide | Inorganic pigment | 9.0 |
| | | Zinc stearate | Lubricant/ | 3.2 |
| | | | release agent | |
| | Poval, company: | Polyvinyl alcohol, | Binder | 8.3 |
| | Kuraray | highly saponified, | | |
| | | high viscosity | | |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 2. Example 2

In practical example 2, a starch precoat (0.5 g/m²) is applied to the front and back of the paper substrate by film press at a speed of 800 m/min on a paper machine. On the starch-coated paper substrate, the colour layer is applied by blade coater and the heat-sensitive layer by curtain coater at a speed of 900 m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 2
Composition of the individual layers of the heat-sensitive
recording material according to Example 2.
Example 2 (FIG. 4)

| | Formulation | Formulation | | |
|---|---|---|---|---|
| Layer area | constituent | constituent | | Amount |
| density | trade name | chemical name | Function | [wt. %] |
| Colour layer | | Calcined kaolin | Inorganic pigment | 48.2 |
| 7.0 g/m² | | Precipitated | Inorganic pigment | 22.9 |
| | | calcium carbonate, | | |
| | | calcite type | | |
| | Latex, | Styrene-butadiene | Binder | 8.6 |
| | company: Styron | latex | | |
| | | Carbon black | Dye/Colour pigment | 19.0 |
| | n.a. | n.a. | Rheology aid | Remainder |
| Heat- | Ropaque OP-96, | Styrene-acrylate | Scattering particle/ | 36.1 |
| sensitive | company: Dow | copolymer | polymer particle | |
| layer | | Sodium-metaborate | Crosslinker | 0.5 |
| 3.5 g/m² | | tetrahydrate | | |
| | company: | Stearic acid amide | Heat-sensitive | 40.4 |
| | Chukyo | wax | material | |
| | | Silicon oxide | Inorganic pigment | 8.0 |
| | | Zinc stearate | Lubricant/release | 3.9 |
| | | | agent | |
| | Poval, company: | Polyvinyl alcohol, | Binder | 10.3 |
| | Kuraray | highly saponified, | | |
| | | high viscosity | | |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 3. Example 3

In practical example 3, a starch precoat (0.5 g/m²) is applied to the front and rear sides of the paper substrate by film press at a speed of 800m/min on a paper machine. On the starch-coated paper substrate, the colour layer is applied by blade coater at a speed of 600 m/min on a paper coating machine. The heat-sensitive layer and the protective layer are applied consecutively by single and/or simultaneous double curtain coater at a speed of 900m/min to the starch-coated paper substrate provided with a colour layer on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 3
Composition of the individual layers of the heat-sensitive
recording material according to Example 3.
Example 3 (FIG. 8)

| | Formulation | Formulation | | |
|---|---|---|---|---|
| Layer area | constituent | constituent | | Amount |
| density | trade name | chemical name | Function | [wt. %] |
| Colour layer | | Calcined kaolin | Inorganic pigment | 52.2 |
| 7.0 g/m² | | Precipitated | Inorganic pigment | 16.9 |
| | | calcium | | |
| | | carbonate, | | |
| | | calcite type | | |
| | Latex, | Styrene-butadiene | Binder | 12.6 |
| | company: Styron | latex | | |
| | | Carbon black | Dye/Colour pigment | 19.0 |
| | n.a. | n.a. | Rheology aid | Remainder |
| Heat- | Ropaque OP-96, | Styrene-acrylate | Scattering particle/ | 38.5 |
| sensitive | company: Dow | copolymer | polymer particle | |
| layer | | Ammonium | Crosslinker | 0.9 |
| 3.5 g/m² | | zirconium | | |
| | | carbonate | | |
| | company: Chukyo | Stearic acid amide | Heat-sensitive | 51.0 |
| | | wax | material | |
| | Poval, company: | Polyvinyl alcohol, | Binder | 8.3 |
| | Kuraray | highly saponified, | | |
| | | high viscosity | | |
| | n.a. | n.a. | Rheology aid | Remainder |
| Protective | Poval, company: | Polyvinyl alcohol, | Binder | 75.0 |
| layer | Kuraray | highly saponified, | | |
| 1.0 g/m² | | high viscosity | | |
| | | Silicon oxide | Inorganic pigment | 8.0 |
| | | Zinc stearate | Lubricant/release | 4.0 |
| | | | agent | |
| | | Ammonium | Crosslinker | 11.0 |
| | | zirconium | | |
| | | carbonate | | |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 4. Example 4

In practical example 4, the colour layer and the heat-sensitive layer are applied consecutively by single and/or simultaneously by double curtain coater to the paper substrate at a speed of 900 n/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 4
Composition of the individual layers of the heat-sensitive
recording material according to Example 4.
Example 4 (FIG. 3)

| | Formulation | Formulation | | |
|---|---|---|---|---|
| Layer area | constituent | constituent | | Amount |
| density | trade name | chemical name | Function | [wt. %] |
| Colour layer | Ropaque HP-1055, | Styrene-acrylate | Scattering particle/ | 47.2 |
| 7.5 g/m² | company: Dow | copolymer | polymer particle | |
| | | Kaolin | Inorganic pigment | 16.2 |
| | Latex, | Styrene-butadiene | Binder | 12.8 |
| | company: Styron | latex | | |
| | | Carbon black | Dye/Colour pigment | 23.3 |
| | n.a. | n.a. | Rheology aid | Remainder |
| Heat- | Plastic Pigment 756A, | Styrene polymer | Scattering particle/ | 35.3 |
| sensitive | company: Trinseo LLC | | polymer particle | |
| layer | company: Chukyo | Stearic acid amide | Heat-sensitive | 30.8 |
| 4.0 g/m² | | wax | material | |
| | Latex, | Styrene-butadiene | Binder | 10.3 |
| | company: Styron | latex | | |
| | | Zinc stearate | Lubricant/ | 3.5 |
| | | | release agent | |
| | | Precipitated | Inorganic pigment | 6.0 |
| | | calcium | | |
| | | carbonate, | | |
| | | calcite type | | |
| | | Silicon oxide | Inorganic pigment | 9.0 |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 5. Example 5

In practical example 5, the colour layer and the heat-sensitive layer are applied consecutively by single and/or simultaneously by double curtain coater to the paper substrate at a speed of 900 m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

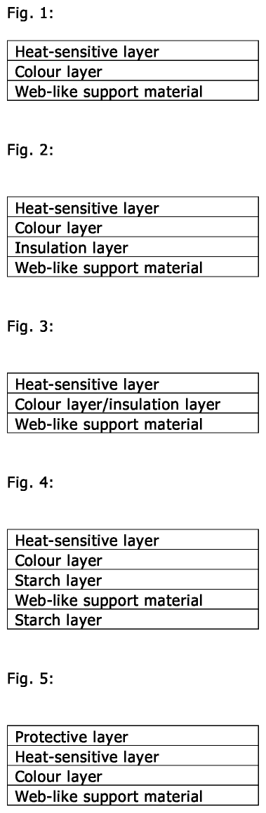

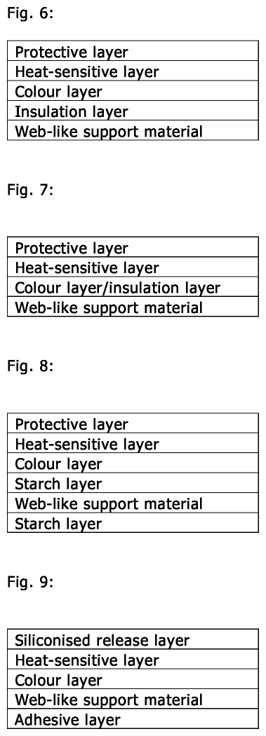

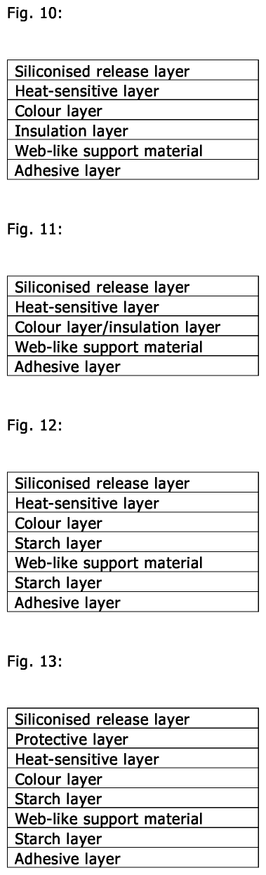

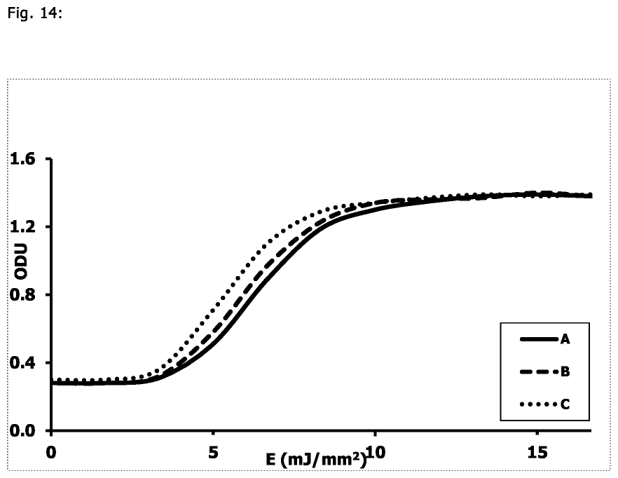

TABLE 5
Composition of the individual layers of the heat-sensitive
recording material according to Example 5.
Example 5 (FIG. 1)

| | Formulation | Formulation | | |
|---|---|---|---|---|
| Layer area | constituent | constituent | | Amount |
| density | trade name | chemical name | Function | [wt. %] |
| Colour layer | | Precipitated | Inorganic pigment | 40.3 |
| 4.0 g/m² | | calcium carbonate, | | |
| | | calcite type | | |
| | Latex, | Styrene-butadiene | Binder | 16.9 |
| | company: | latex | | |
| | Styron | | | |
| | | Carbon black | Dye/Colour pigment | 42.4 |
| | n.a. | n.a. | Rheology aid | Remainder |
| Heat- | company: | Stearic acid amide | Scattering particle/ | 72.3 |
| sensitive | Chukyo | wax | heat-sensitive | |
| layer | | | material/lubricant | |
| 6.0 g/m² | Poval, | Polyvinyl alcohol, | Binder | 12.8 |
| | company: | highly saponified, | | |
| | Kuraray | high viscosity | | |
| | | Precipitated | Inorganic pigment | 5.5 |
| | | calcium carbonate, | | |
| | | calcite type | | |
| | | Silicon oxide | Inorganic pigment | 8.7 |
| | n.a. | n.a. | Rheology aid | Remainder |

n.a.: standard auxiliaries, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 6. Example 6

In practical example 6, the insulation layer (insulator layer) is applied to the paper substrate by film press at a speed of 800 m/min on a paper machine. On the paper substrate provided with an insulation layer (insulator layer), the colour layer and the heat-sensitive layer are applied consecutively by single and/or simultaneously by double curtain coater at a speed of 900m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 6
Composition of the individual layers of the heat-sensitive
recording material according to Example 6.
Example 6 (FIG. 2)

| | Formulation | Formulation | | |
|---|---|---|---|---|
| Layer area | constituent | constituent | | Amount |
| density | trade name | chemical name | Function | [wt. %] |
| Insulation | Ropaque HP- | Styrene-acrylate | Scattering particle/ | 41.1 |
| layer | 1055, | copolymer | polymer particle | |
| 2.5-3.0 g/m² | company: Dow | | | |
| | | Precipitated calcium | Inorganic pigment | 39.9 |
| | | carbonate, | | |
| | | calcite type | | |
| | Poval, | Polyvinyl alcohol, | Binder | 3.0 |
| | company: | highly saponified, | | |
| | Kuraray | low viscosity | | |
| | Latex, | Styrene-butadiene | Binder | 15.5 |
| | company: Styron | latex | | |
| | n.a. | n.a. | Rheology aid | Remainder |
| Colour layer | | Kaolin | Inorganic pigment | 67.4 |
| 3.5 g/m² | Poval, | Polyvinyl alcohol, | Binder | 20.0 |
| | company: | highly saponified, | | |
| | Kuraray | low viscosity | | |
| | | Carbon black | Dye/Colour pigment | 12.0 |
| | n.a. | n.a. | Rheology aid | Remainder |
| Heat- | Ropaque OP-96, | Styrene-acrylate | Scattering particle/ | 44.1 |
| sensitive | company: Dow | copolymer | polymer particle | |
| layer | | Sodium-metaborate | Crosslinker | 0.9 |
| 3.5 g/m² | | tetrahydrate | | |
| | company: | Stearic acid amide wax | Heat-sensitive | 34.4 |
| | Chukyo | | material | |
| | | Silicon oxide | Inorganic pigment | 8.0 |
| | | Zinc stearate | Lubricant/ | 3.9 |
| | | | release agent | |
| | Poval, company: | Polyvinyl alcohol, | Binder | 8.3 |
| | Kuraray | highly saponified, high | | |
| | | viscosity | | |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

It has been shown that the use of any mixture of scattering particles/polymer particles (e.g. styrene-acrylate copolymer) and inorganic pigment (e.g. calcined kaolin) in the insulation/colour layer offers especial advantages in terms of improved barcode readability of the heat-sensitive recording material due to a high degree of fixation of the heat-sensitive layer on the colour layer.

The mixing ratio between scattering particles/polymer particles and inorganic pigment is preferably in the range of from 8:1 to 1:8, especially preferably in the range of from 4:1 to 1:4, in relation to the stated amounts [wt. %] in the oven-dry state (o-dry).

By means of the following examples (Examples 7 to 12), these embodiments are explained in greater detail without limiting their scope.

### 7. Example 7

In practical example 7, the colour layer and the heat-sensitive layer are applied consecutively by single and/or simultaneously by double curtain coater to the paper substrate at a speed of 900 m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 7
Composition of the individual layers of the heat-sensitive
recording material according to Example 7.
Example 7 (FIG. 3)

| | Formulation | Formulation | | |
|---|---|---|---|---|
| Layer area | constituent | constituent | | Amount |
| density | trade name | chemical name | Function | [wt. %] |
| Colour layer | Ropaque HP-1055, | Styrene-acrylate | Scattering | 36.3 |
| 5.2 g/m² | company: Dow | copolymer | particle/polymer particle | |
| | | Calcined kaolin | Inorganic pigment | 16.0 |
| | Latex, company: | Styrene-butadiene- | Binder | 25.7 |
| | Styron | latex | | |
| | | Carbon black | Dye/colour pigment | 21.2 |
| | n.a. | n.a. | Rheology aid | Remainder |
| Heat- | Ropaque OP-96, | Styrene-acrylate | Scattering | 35.1 |
| sensitive | company: Dow | copolymer | particle/polymer particle | |
| layer | | Sodium-metaborate | Crosslinker | 0.7 |
| 3.5 g/m² | | tetrahydrate | | |
| | company: Chukyo | Stearic acid amide | Heat-sensitive material | 40.4 |
| | | wax | | |
| | | Silicon oxide | Inorganic pigment | 9.0 |
| | | Zinc stearate | Lubricant/release agent | 3.2 |
| | Poval, company: | Polyvinyl alcohol, | Binder | 8.3 |
| | Kuraray | highly saponified, | | |
| | | high viscosity | | |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 8. Example 8

In practical example 8, the colour layer and the heat-sensitive layer are applied consecutively by single and/or simultaneously by double curtain coater to the paper substrate at a speed of 900 m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 8
Composition of the individual layers of the heat-sensitive
recording material according to Example 8.
Example 8 (FIG. 4)

| | Formulation | Formulation | | |
|---|---|---|---|---|
| Layer area | constituent | constituent | | Amount |
| density | trade name | chemical name | Function | [wt. %] |
| Colour layer | Ropaque HP- | Styrene-acrylate | Scattering | 16.0 |
| 7.0 g/m² | 1055, company: | copolymer | particle/polymer | |
| | Dow | | particle | |
| | | Calcined kaolin | Inorganic pigment | 42.2 |
| | | Precipitated calcium | Inorganic pigment | 22.9 |
| | | carbonate, calcite | | |
| | | type | | |
| | Latex, company: | Styrene-butadiene- | Binder | 8.6 |
| | Styron | latex | | |
| | | Carbon black | Dye/colour pigment | 19.0 |
| | n.a. | n.a. | Rheology aid | Remainder |
| Heat- | Ropaque OP-96, | Styrene-acrylate | Scattering particle, | 36.1 |
| sensitive | company: Dow | copolymer | polymer particle | |
| layer | | Sodium-metaborate | Crosslinker | 0.5 |
| 3.5 g/m² | | tetrahydrate | | |
| | company: Chukyo | Stearic acid amide | Heat-sensitive | 40.4 |
| | | wax | material | |
| | | Silicon oxide | Inorganic pigment | 8.0 |
| | | Zinc stearate | Lubricant/release | 3.9 |
| | | | agent | |
| | Poval, company: | Polyvinyl alcohol, | Binder | 10.3 |
| | Kuraray | highly saponified, | | |
| | | high viscosity | | |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 9. Example 9

In practical example 9, the colour layer and the heat-sensitive layer are applied consecutively by single and/or simultaneously by double curtain coater to the paper substrate at a speed of 900 m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 9
Composition of the individual layers of the heat-sensitive
recording material according to Example 9.
Example 9 (FIG. 8)

| | Formulation | Formulation | | |
|---|---|---|---|---|
| Layer area | constituent | constituent | | Amount |
| density | trade name | chemical name | Function | [wt. %] |
| Colour layer | Ropaque HP-1055, | Styrene-acrylate | Scattering | 17.2 |
| 7.0 g/m² | company: Dow | copolymer | particle/polymer | |
| | | | particle | |
| | | Calcined kaolin | Inorganic pigment | 35.0 |
| | | Precipitated calcium | Inorganic pigment | 16.9 |
| | | carbonate, calcite | | |
| | | type | | |
| | Latex, company: | Styrene-butadiene- | Binder | 12.6 |
| | Styron | latex | | |
| | | Carbon black | Dye/Colour pigment | 19.0 |
| | n.a. | n.a. | Rheology aid | Remainder |
| Heat- | Ropaque OP-96, | Styrene-acrylate | Scattering particle, | 38.5 |
| sensitive | company: Dow | copolymer | polymer particle | |
| layer | | Ammonium zirconium | Crosslinker | 0.9 |
| 3.5 g/m² | | carbonate | | |
| | company: Chukyo | Stearic acid amide | Heat-sensitive | 51.0 |
| | | wax | material | |
| | Poval, company: | Polyvinyl alcohol, | Binder | 8.3 |
| | Kuraray | highly saponified, | | |
| | | high viscosity | | |
| | n.a. | n.a. | Rheology aid | Remainder |
| Protective | Poval, company: | Polyvinyl alcohol, | Binder | 75.0 |
| layer | Kuraray | highly saponified, | | |
| 1.0 g/m² | | high viscosity | | |
| | | Silicon oxide | Inorganic pigment | 8.0 |
| | | Zinc stearate | Lubricant/release | 4.0 |
| | | | agent | |
| | | Ammonium zirconium | Crosslinker | 11.0 |
| | | carbonate | | |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 10. Example 10

In practical example 10, the colour layer and the heat-sensitive layer are applied consecutively by single and/or simultaneously by double curtain coater to the paper substrate at a speed of 900 m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 10
Composition of the individual layers of the heat-sensitive
recording material according to Example 10.
Example 10 (FIG. 3)

| | Formulation | Formulation | | |
|---|---|---|---|---|
| Layer area | constituent | constituent | | Amount |
| density | trade name | chemical name | Function | [wt. %] |
| Colour layer | Ropaque HP-1055, | Styrene-acrylate | Scattering | 32.2 |
| 7.5 g/m² | company: Dow | copolymer | particle/polymer | |
| | | | particle | |
| | | Calcined kaolin | Inorganic pigment | 15.0 |
| | | kaolin | Inorganic pigment | 16.2 |
| | Latex, company: | Styrene- | Binder | 12.8 |
| | Styron | butadiene-latex | | |
| | | Carbon black | Dye/colour pigment | 23.3 |
| | n.a. | n.a. | Rheology aid | Remainder |
| Heat- | Plastic Pigment | Styrene polymer | Scattering | 35.3 |
| sensitive | 756A, company: | | particle/polymer | |
| layer | Trinseo LLC | | particle | |
| 4.0 g/m² | company: Chukyo | Stearic acid | Heat-sensitive | 30.8 |
| | | amide wax | material | |
| | Latex, company: | Styrene- | Binder | 10.3 |
| | Styron | butadiene-latex | | |
| | | Zinc stearate | Lubricant/release | 3.5 |
| | | | agent | |
| | | Precipitated | Inorganic pigment | 6.0 |
| | | calcium | | |
| | | carbonate, calcite | | |
| | | type | | |
| | | Silicon oxide | Inorganic pigment | 9.0 |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 11. Example 11

In practical example 11, the colour layer and the heat-sensitive layer are applied consecutively by single and/or simultaneously by double curtain coater to the paper substrate at a speed of 900 m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 11
Composition of the individual layers of the heat-sensitive
recording material according to Example 11.
Example 11 (FIG. 1)

| | Formulation | Formulation | | |
|---|---|---|---|---|
| Layer area | constituent | constituent | | Amount |
| density | trade name | chemical name | Function | [wt. %] |
| Colour layer | Ropaque HP-1055, | Styrene-acrylate | Scattering particle/polymer | 15.3 |
| 4.0 g/m² | company: Dow | copolymer | particle | |
| | | Calcined kaolin | Inorganic pigment | 14.7 |
| | | Precipitated | Inorganic pigment | 28.3 |
| | | calcium carbonate, | | |
| | | calcite type | | |
| | Latex, company: | Styrene-butadiene- | Binder | 8.9 |
| | Styron | latex | | |
| | | Carbon black | Dye/colour pigment | 32.4 |
| | n.a. | n.a. | Rheology aid | Remainder |
| Heat- | company: Chukyo | Stearic acid amide | Scattering particle/heat- | 72.3 |
| sensitive | | wax | sensitive material/lubricant | |
| layer | Poval, company: | Polyvinyl alcohol, | Binder | 12.8 |
| 6.0 g/m² | Kuraray | highly saponified, | | |
| | | high viscosity | | |
| | | Precipitated | Inorganic pigment | 5.5 |
| | | calcium carbonate, | | |
| | | calcite type | | |
| | | Silicon oxide | Inorganic pigment | 8.7 |
| | n.a. | n.a. | Rheology aid | Remainder |

n.a.: standard auxiliaries, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

### 12. Example 12

In practical example 12, the insulation layer is applied to the paper substrate by film press at a speed of 800 m/min on a paper machine. On the paper substrate provided with an insulation layer, the colour layer and the heat-sensitive layer are applied consecutively by single and/or simultaneously by double curtain coater at a speed of 900 m/min on a paper coating machine. After each application, the drying process is carried out in the usual manner without negatively influencing the properties of the heat-sensitive recording material according to the invention, such as the surface whiteness or paper whiteness of the heat-sensitive layer, of the coated paper substrate.

TABLE 12
Composition of the individual layers of the heat-sensitive
recording material according to Example 12.
Example 12 (FIG. 2)

| | Formulation | Formulation | | |
|---|---|---|---|---|
| Layer area | constituent | constituent | | Amount |
| density | trade name | chemical name | Function | [wt. %] |
| Insulation | Ropaque HP- | Styrene-acrylate | Scattering | 41.1 |
| layer | 1055, company: | copolymer | particle/polymer particle | |
| 2.5-3.0 g/m² | Dow | | | |
| | | Calcined kaolin | Inorganic pigment | 12.3 |
| | | Precipitated calcium | Inorganic pigment | 25.6 |
| | | carbonate, calcite type | | |
| | Poval, company: | Polyvinyl alcohol, | Binder | 3.0 |
| | Kuraray | highly saponified, low | | |
| | | viscosity | | |
| | | Ammonium zirconium | Crosslinker | 2.0 |
| | | carbonate | | |
| | Latex, company: | Styrene-butadiene- | Binder | 15.5 |
| | Styron | latex | | |
| | n.a. | n.a. | Rheology aid | Remainder |
| Colour layer | | kaolin | Inorganic pigment | 61.2 |
| 3.5 g/m² | Poval, company: | Polyvinyl alcohol, | Binder | 20.0 |
| | Kuraray | highly saponified, low | | |
| | | viscosity | | |
| | | Ammonium zirconium | Crosslinker | 6.2 |
| | | carbonate | | |
| | | Carbon black | Dye/colour pigment | 12.0 |
| | n.a. | n.a. | Rheology aid | Remainder |
| Heat- | Ropaque OP-96, | Styrene-acrylate | Scattering | 44.1 |
| sensitive | company: Dow | copolymer | particle/polymer particle | |
| layer | | Sodium-metaborate | Crosslinker | 0.9 |
| 3.5 g/m² | | tetrahydrate | | |
| | company: Chukyo | Stearic acid amide wax | Heat-sensitive material | 34.4 |
| | | Silicon oxide | Inorganic pigment | 8.0 |
| | | Zinc stearate | Lubricant/release agent | 3.9 |
| | Poval, company: | Polyvinyl alcohol, | Binder | 8.3 |
| | Kuraray | highly saponified, high | | |
| | | viscosity | | |
| | n.a. | n.a. | Rheology aid | Remainder |

n.a.: standard materials, known to a person skilled in the art.

In order to improve certain coating-related properties, further constituents, especially rheology aids, such as thickeners and/or surfactants, are added to the individual layers. The further constituents are added in such amounts that the wt. % of the layer in question add up to 100 wt. %. The corresponding amounts are known to a person skilled in the art.

The thermal recording materials thus obtained were evaluated as described below:

### 1) Dynamic Colour Density:

The heat-sensitive recording materials (strips 6 cm wide) were thermally printed using a GeBE PrinterLab GPT-10000 test printer (company: GeBE Elektronik und Feinwerktechnik GmbH, Germany) with a Kyocera print bar of 305 dpi at an applied voltage of 24 V and a maximum pulse width of 0.8 ms with a chequerboard pattern without energy gradations determined by preliminary tests, the pulse width being selected to achieve an optical density of 1.20±0.05. The area of one square of the printed pattern corresponds to 80×80 dots. The image densities of the printed and non-printed areas (optical density, o. D.) were measured with a SpectroEye densitometer from X-Rite, whereby the measurement uncertainty of the o. D. values is estimated at ≤2%. The scatter of the % values calculated according to (eq. 2) is ≤±2 percentage points.

### 2) Relative Print Contrast:

The relative contrast was calculated using the value of the optical density of a thermally printed area (oDₛ) or a mechanically treated area (friction sensitivity test) (oDₛ) and the optical density of a non-printed area (oD_{w}) according to eq. (2) (s=black area, w=white area):

$$\\ \begin{matrix}\% rel . contrast = ( \frac{oDs - oDw}{oDs} ) * 100 & ( eq . 2 )\end{matrix}$$

### 3) Resistance Testing of the Printed Image

### a) Resistance to Plasticiser (Omni Film):

A plasticiser-containing cling film (PVC film containing 20 to 25% dioctyl adipate) was placed in contact with two strips of the heat-sensitive recording material printed according to method (1), avoiding wrinkles and air inclusions, wound into a roll and stored for 16 hours. One strip was stored at room temperature (20 to 22° C.), the second at 40° C. After peeling off the film, the image density (o.D.) of the printed and non-printed areas was measured and set in relation to the corresponding image density values before plasticiser action to determine the relative print contrast according to the formula (eq. 2).

### b) Resistance to Adhesive:

Two strips of the heat-sensitive recording material were printed according to method (1). Transparent Tesa self-adhesive tape (Tesafilm® crystal clear, #57315) and, separately, a strip of Tesa packaging tape (#04204) were glued to one strip each, avoiding wrinkles and air inclusions. After storage at room temperature (20-22° C.), the image density (o. D.)—through the particular adhesive tape—of the printed and non-printed areas was measured after seven days and set in relation to the corresponding image density values of the freshly laminated samples to determine the relative print contrast according to the formula (eq. 2).

### c) Resistance to Hydrophobic/Hydrophilic Agents:

On each strip of the heat-sensitive recording material printed according to method (1), one drop/finger tip each of sunflower oil (Nestlé-Thomy 100% pure sunflower oil), lard (LARU GmbH Schweineschmalz), hand cream (lanolin hand cream), sweat (produced according to DIN EN ISO 105-E04), milk (3.5% fat), ethanol (40% in water) and water (tap water) were applied to a printed and a non-printed area. After an exposure time of 30 minutes, the agents were removed by brief contact with a commercially available kitchen towel and the papers were stored at room temperature (20-22° C.). After a specific storage period (see Table 1), the image density (o. D.) of the printed and non-printed areas was measured and set in relation to the corresponding image density values before the agent action to determine the relative print contrast according to the formula (eq. 2).

TABLE 13
Resistances of the printed/unprinted heat-sensitive
recording materials according to the invention

| | | | | | | Relative print | | |
|---|---|---|---|---|---|---|---|---|
| | | Background | | Image density | | contrast (%)* | | |
| | | (o.D., ODU) | | (o.D., ODU) | | | | % rem. |
| | Test | Before | After | Before | After | Before | After | contrast |
| Example 1 | Omni film | 0.49 | 0.49 | 1.19 | 1.21 | 59 | 59 | 100 |
| | (16 h, RT) | | | | | | | |
| | Omni film | 0.50 | 0.51 | 1.15 | 1.20 | 57 | 57 | 100 |
| | (16 h, 40° C.) | | | | | | | |
| | Tesa #57315 | 0.52 | 0.54 | 1.34 | 1.34 | 61 | 60 | 98 |
| | (7 d, RT) | | | | | | | |
| | Tesa, #04204 | 0.52 | 0.58 | 1.41 | 1.41 | 63 | 59 | 94 |
| | (7 d, RT) | | | | | | | |
| | Sunflower oil | 0.48 | 0.85 | 1.21 | 1.39 | 60 | 39 | 65 |
| | (24 h, RT) | | | | | | | |
| | Lard | 0.48 | 0.85 | 1.24 | 1.35 | 61 | 37 | 61 |
| | (24 h, RT) | | | | | | | |
| | Hand cream | 0.48 | 0.89 | 1.21 | 1.36 | 60 | 35 | 58 |
| | (24 h, RT) | | | | | | | |
| | Sweat | 0.48 | 0.52 | 1.16 | 1.20 | 59 | 57 | 97 |
| | (3 h, RT) | | | | | | | |
| | Milk | 0.48 | 0.62 | 1.24 | 1.34 | 61 | 54 | 89 |
| | (3 h, RT) | | | | | | | |
| | Ethanol | 0.48 | 0.53 | 1.21 | 1.20 | 60 | 56 | 93 |
| | (3 h, RT) | | | | | | | |
| | Water resist. | 0.48 | 0.53 | 1.22 | 1.25 | 61 | 58 | 95 |
| | (3 h, RT) | | | | | | | |
| Example 2 | Omni film | 0.44 | 0.45 | 1.18 | 1.20 | 63 | 63 | 100 |
| | (16 h, RT) | | | | | | | |
| | Omni film | 0.44 | 0.45 | 1.16 | 1.19 | 62 | 62 | 100 |
| | (16 h, 40° C.) | | | | | | | |
| | Tesa #57315 | 0.45 | 0.48 | 1.24 | 1.27 | 64 | 62 | 97 |
| | (7 d, RT) | | | | | | | |
| | Tesa, #04204 | 0.45 | 0.49 | 1.31 | 1.34 | 66 | 63 | 95 |
| | (7 d, RT) | | | | | | | |
| | Sunflower oil | 0.45 | 0.78 | 1.21 | 1.33 | 63 | 41 | 65 |
| | (24 h, RT) | | | | | | | |
| | Lard | 0.44 | 0.69 | 1.21 | 1.35 | 64 | 49 | 77 |
| | (24 h, RT) | | | | | | | |
| | Hand cream | 0.45 | 0.74 | 1.24 | 1.40 | 64 | 47 | 73 |
| | (24 h, RT) | | | | | | | |
| | Sweat | 0.45 | 0.53 | 1.18 | 1.19 | 62 | 55 | 89 |
| | (3 h, RT) | | | | | | | |
| | Milk | 0.44 | 0.53 | 1.23 | 1.32 | 64 | 60 | 94 |
| | (3 h, RT) | | | | | | | |
| | Ethanol | 0.44 | 0.50 | 1.24 | 1.25 | 65 | 60 | 92 |
| | (3 h, RT) | | | | | | | |
| | Water resist. | 0.44 | 0.50 | 1.21 | 1.22 | 64 | 59 | 92 |
| | (3 h, RT) | | | | | | | |
| Example 3 | Omni film | 0.41 | 0.41 | 1.18 | 1.17 | 65 | 65 | 100 |
| | (16 h, RT) | | | | | | | |
| | Omni film | 0.41 | 0.41 | 1.16 | 1.16 | 65 | 65 | 100 |
| | (16 h, 40° C.) | | | | | | | |
| | Tesa #57315 | 0.46 | 0.46 | 1.32 | 1.33 | 65 | 65 | 100 |
| | (7 d, RT) | | | | | | | |
| | Tesa, #04204 | 0.46 | 0.46 | 1.31 | 1.33 | 65 | 65 | 100 |
| | (7 d, RT) | | | | | | | |
| | Sunflower oil | 0.42 | 0.45 | 1.15 | 1.20 | 63 | 63 | 100 |
| | (24 h, RT) | | | | | | | |
| | Lard | 0.41 | 0.45 | 1.22 | 1.27 | 66 | 65 | 98 |
| | (24 h, RT) | | | | | | | |
| | Hand cream | 0.42 | 0.47 | 1.20 | 1.33 | 65 | 65 | 100 |
| | (24 h, RT) | | | | | | | |
| | Sweat | 0.43 | 0.45 | 1.21 | 1.11 | 64 | 59 | 92 |
| | (3 h, RT) | | | | | | | |
| | Milk | 0.43 | 0.47 | 1.22 | 1.20 | 65 | 61 | 94 |
| | (3 h, RT) | | | | | | | |
| | Ethanol | 0.43 | 0.47 | 1.22 | 1.17 | 65 | 60 | 92 |
| | (3 h, RT) | | | | | | | |
| | Water resist. | 0.41 | 0.42 | 1.22 | 1.12 | 66 | 63 | 95 |
| | (3 h, RT) | | | | | | | |
| Example 4 | Omni film | 0.46 | 0.46 | 1.15 | 1.13 | 60 | 59 | 98 |
| | (16 h, RT) | | | | | | | |
| | Omni film | 0.45 | 0.58 | 1.09 | 1.10 | 59 | 47 | 80 |
| | (16 h, 40° C.) | | | | | | | |
| | Tesa #57315 | 0.49 | 0.56 | 1.37 | 1.39 | 64 | 60 | 94 |
| | (7 d, RT) | | | | | | | |
| | Tesa, #04204 | 0.48 | 0.69 | 1.39 | 1.44 | 65 | 52 | 80 |
| | (7 d, RT) | | | | | | | |
| | Sunflower oil | 0.45 | 1.19 | 1.21 | 1.41 | 63 | 16 | 25 |
| | (24 h, RT) | | | | | | | |
| | Lard | 0.45 | 1.36 | 1.22 | 1.36 | 63 | 0 | 0 |
| | (24 h, RT) | | | | | | | |
| | Hand cream | 0.45 | 1.38 | 1.22 | 1.38 | 63 | 0 | 0 |
| | (24 h, RT) | | | | | | | |
| | Sweat | 0.45 | 0.45 | 1.18 | 1.21 | 62 | 62 | 100 |
| | (3 h, RT) | | | | | | | |
| | Milk | 0.45 | 0.55 | 1.25 | 1.31 | 64 | 58 | 91 |
| | (3 h, RT) | | | | | | | |
| | Ethanol | 0.45 | 0.45 | 1.20 | 1.20 | 63 | 63 | 100 |
| | (3 h, RT) | | | | | | | |
| | Water resist. | 0.45 | 0.45 | 1.22 | 1.22 | 63 | 63 | 100 |
| | (3 h, RT) | | | | | | | |
| Example 5 | Omni film | 0.59 | 0.59 | 1.15 | 1.15 | 49 | 49 | 100 |
| | (16 h, RT) | | | | | | | |
| | Omni film | 0.58 | 0.61 | 1.15 | 1.15 | 50 | 47 | 94 |
| | (16 h, 40° C.) | | | | | | | |
| | Tesa #57315 | 0.62 | 0.68 | 1.35 | 1.35 | 54 | 50 | 93 |
| | (7 d, RT) | | | | | | | |
| | Tesa ,#04204 | 0.62 | 0.70 | 1.40 | 1.44 | 56 | 51 | 91 |
| | (7 d, RT) | | | | | | | |
| | Sunflower oil | 0.56 | 1.32 | 1.14 | 1.38 | 51 | 4 | 8 |
| | (24 h, RT) | | | | | | | |
| | Lard | 0.56 | 1.41 | 1.18 | 1.43 | 53 | 2 | 4 |
| | (24 h, RT) | | | | | | | |
| | Hand cream | 0.56 | 1.47 | 1.18 | 1.35 | 53 | −9 | 0 |
| | (24 h, RT) | | | | | | | |
| | Sweat | 0.56 | 0.62 | 1.16 | 1.04 | 52 | 40 | 77 |
| | (3 h, RT) | | | | | | | |
| | Milk | 0.56 | 0.76 | 1.16 | 1.20 | 52 | 37 | 71 |
| | (3 h, RT) | | | | | | | |
| | Ethanol | 0.56 | 0.55 | 1.14 | 1.13 | 51 | 51 | 100 |
| | (3 h, RT) | | | | | | | |
| | Water resist. | 0.56 | 0.50 | 1.15 | 1.03 | 51 | 51 | 100 |
| | (3 h, RT) | | | | | | | |

*According to equation 2 (eq. 2).

### Shelf Life of the Printed/Unprinted Heat-Sensitive Recording Materials According to the Invention:

A strip of the heat-sensitive recording material was printed and measured according to method (1) (o. D., image density before storage) and, together with an unprinted strip of the heat-sensitive recording material, subjected to storage for four weeks between two glass plates at 60° C., a pressure of 1350 N/m², a relative humidity of 50% and in the absence of light.

After storage and climate control to room temperature, the unprinted strip was printed according to (1) (=remaining writing performance); the printed and non-printed areas were measured and set in relation to the corresponding image density values of the printed strip before storage to determine the relative print contrast according to the formula (eq. 2). The printed and non-printed areas of the printed strip were also measured (=remaining image permanence) and set in relation to the corresponding image density values before storage to determine the relative print contrast according to the formula (eq. 2).

TABLE 13
Shelf life of the printed/unprinted heat-sensitive
recording materials according to the invention:

| | | | | | | Relative print | | |
|---|---|---|---|---|---|---|---|---|
| | | Background | | Image density | | contrast (%)* | | |
| | | (o.D., ODU) | | (o.D., ODU) | | | | % rem. |
| | Test | Before | After | Before | After | Before | After | contrast |
| Example 1 | Image | 0.49 | 0.53 | 1.24 | 1.27 | 60 | 58 | 97 |
| | permanence | | | | | | | |
| | Writing | 0.49 | 0.53 | 1.24 | 1.19 | 60 | 55 | 92 |
| | performance | | | | | | | |
| Example 2 | Image | 0.42 | 0.49 | 1.16 | 1.27 | 64 | 61 | 95 |
| | permanence | | | | | | | |
| | Writing | 0.42 | 0.49 | 1.16 | 1.19 | 64 | 59 | 92 |
| | performance | | | | | | | |
| Example 3 | Image | 0.44 | 0.57 | 1.23 | 1.26 | 64 | 55 | 86 |
| | permanence | | | | | | | |
| | Writing | 0.44 | 0.53 | 1.23 | 1.31 | 64 | 60 | 94 |
| | performance | | | | | | | |
| Example 4 | Image | 0.44 | 0.44 | 1.16 | 1.16 | 62 | 62 | 100 |
| | permanence | | | | | | | |
| | Writing | 0.44 | 0.46 | 1.16 | 1.21 | 62 | 62 | 100 |
| | performance | | | | | | | |
| Example 5 | Image | 0.56 | 0.57 | 1.25 | 0.85 | 55 | 33 | 60 |
| | permanence | | | | | | | |
| | Writing | 0.56 | 0.57 | 1.25 | 1.24 | 55 | 54 | 98 |
| | performance | | | | | | | |

*According to equation 2 (eq. 2).

### Equipping the Heat-Sensitive Recording Materials as Self-Adhesive Labels.

Applying a layer of adhesive to the rear side of an A4 sheet.
a) The adhesive dispersion is applied using a squeegee to the rear side of an A4 paper carrying the heat-sensitive layer (heat-sensitive recording material) on the front side and dried at max. 70° C. using a hot-air gun. To protect the adhesive layer during further processing, a siliconised release paper is laminated onto the adhesive layer, avoiding air inclusions and wrinkles.
b) In the presence of an “adhesive-liner sandwich” consisting of a thin adhesive layer between two release papers, after removing one of the two liner papers, the adhesive layer (sticky side) is laminated to the reverse side of the A4 thermal paper, avoiding air inclusions and wrinkles.

It is irrelevant whether, during the production of the label, the adhesive layer is applied first and then the heat-sensitive recording layer is applied to the opposite side carrying the adhesive layer.

To produce self-adhesive labels, a removable acrylate-based adhesive (R5000N, company: Avery Fasson) was used as a commercially available adhesive.

The heat-sensitive recording materials thus finished to form self-adhesive labels were tested/evaluated as shown below (Table 4).

### Adhesive Migration Test of Heat-Sensitive Labels

A strip of the heat-sensitive recording material was printed and measured according to method (1) (o. D., image density before storage) and, together with an unprinted strip of the heat-sensitive recording material, subjected to storage for four weeks between two glass plates at 60° C., a pressure of 1350 N/m², a relative humidity of 50% and in the absence of light.

After storage and climate control to room temperature, the unprinted strip was printed according to (1) (=remaining writing performance); the printed and non-printed areas were measured and set in relation to the corresponding image density values of the printed strip before storage to determine the relative print contrast according to the formula (eq. 2). The printed and non-printed areas of the printed strip were also measured (=remaining image permanence) and set in relation to the corresponding image density values before storage to determine the relative print contrast according to the formula (eq. 2).

TABLE 14
Adhesive migration test of the heat-sensitive
label papers according to the invention.

| | | | | | | Relative print | | |
|---|---|---|---|---|---|---|---|---|
| | | Background | | Image density | | contrast (%)* | | |
| | | (o.D., ODU) | | (o.D., ODU) | | | | % rem. |
| | Test | Before | After | Before | After | Before | After | contrast |
| Example 1 | Image | 0.50 | 0.69 | 1.31 | 1.47 | 62 | 53 | 85 |
| | permanence | | | | | | | |
| | Writing | 0.50 | 0.69 | 1.31 | 1.38 | 62 | 50 | 81 |
| | performance | | | | | | | |
| Example 2 | Image | 0.42 | 0.55 | 1.29 | 1.47 | 67 | 63 | 94 |
| | permanence | | | | | | | |
| | Writing | 0.42 | 0.56 | 1.29 | 1.44 | 67 | 61 | 91 |
| | performance | | | | | | | |
| Example 3 | Image | 0.44 | 0.62 | 1.31 | 1.30 | 66 | 52 | 79 |
| | permanence | | | | | | | |
| | Writing | 0.44 | 0.61 | 1.31 | 1.39 | 66 | 56 | 85 |
| | performance | | | | | | | |
| Example 4 | Image | 0.45 | 0.44 | 1.23 | 1.20 | 63 | 63 | 100 |
| | permanence | | | | | | | |
| | Writing | 0.45 | 0.44 | 1.23 | 1.20 | 63 | 63 | 100 |
| | performance | | | | | | | |
| Example 5 | Image | 0.57 | 0.54 | 1.32 | 0.77 | 57 | 30 | 53 |
| | permanence | | | | | | | |
| | Writing | 0.57 | 0.55 | 1.32 | 1.23 | 57 | 55 | 96 |
| | performance | | | | | | | |

*According to equation 2 (eq. 2).

TABLE 15
Friction sensitivity tests of the heat-sensitive
recording materials according to the invention.

| | Rel. print contrast (%) after |
|---|---|
| | friction sensitivity test* |
| Example 1 | 10.9 |
| Example 2 | 11.0 |
| Example 3 | 0.8 |
| Example 4 | 11.1 |
| Example 5 | 6.7 |

*According to equation 2 (eq. 2).

The friction sensitivity test was carried out on a material testing machine (company: Karl Schröder KG, Weinheim), consisting of a lower rotating and an upper axially displaceable supporting disc loaded by a counterweight of 3.5 kg, both equipped with a yielding support for the heat-sensitive recording material to be tested in the form of a round disc of 56.5 mm. The mechanical load was applied over a period of 60 seconds. The friction sensitivity of the heat-sensitive recording material treated in this way was evaluated by determining the relative print contrast according to eq. 2.

TABLE 16
Bekk smoothness in sec. and thickness in μm of the heat-
sensitive recording materials according to the invention

| | Support material with | | | | | | | |
|---|---|---|---|---|---|---|---|---|
| | optional starch precoat | | Colour layer | | Heat-sensitive layer | | Protective layer | |
| | Smoothness | Thickness | Smoothness | Thickness | Smoothness | Thickness | Smoothness | Thickness |
| Example 0 | 144 | 41.0 | — | — | 627 | 54.0 | — | — |
| Example 1 | — | — | — | — | 417 | 66.0 | — | — |
| Example 2 | 123 | 46.0 | — | — | 585 | 55.0 | — | — |
| Example 3 | 53 | 71.0 | 155 | 76.0 | 325 | 79.5 | 472 | 79.5 |
| Example 3 | 53 | 71.0 | 155 | 76.0 | — | — | 251 | 80.0 |
| Example 3 | 83 | 69.0 | 190 | 73.5 | 274 | 80.0 | 820 | 80.0 |
| Example 3 | 71 | 71.5 | 139 | 73.5 | — | — | 343 | 84.0 |
| Example 3 | 83 | 69.0 | 201 | 73.5 | — | — | 342 | 80.0 |
| Example 3 | 103 | 66.0 | 198 | 72.0 | — | — | 404 | 80.0 |
| Example 4 | 79 | 69.5 | 162 | 73.0 | 129 | 66.0 | — | — |
| Example 5 | 91 | 71.5 | 173 | 74.5 | 159 | 62.0 | — | — |

Example 0 corresponds to Example 2 with regard to the formulation constituents and the amounts used, but the area density was 37 g/m².

The above-mentioned Examples 3 correspond in respect of the formulation constituents and the used amounts to the above-mentioned Example 3 (Table 3), but proceed from different paper coating machine runs (different application methods).

The smoothness measurement was performed according to DIN 53107 (2016).

The thickness measurement was performed according to DIN-EN DIN 534 (2011).

Prior to determining the residual moisture (paper moisture), the heat-sensitive recording materials were stored for one week at room temperature and at a relative air humidity of 30%.

The residual moisture (paper moisture) was determined with the aid of a Precisa XM60 moisture-determining measurement unit using aluminium shells (70 mm) at room temperature and at a relative air humidity of 30%. “Standard” was selected as heating rate, and the maximum temperature was set to 120° C. After taring the aluminium shell, this was equipped with a paper sample of from 0.5 to 0.7 g of the corresponding paper sample. To this end, the sample is shaped and cut so that it can be placed in the aluminium shell without touching the heating element. In auto-start mode the determination of the residual moisture starts automatically once the sample chamber has been closed; once complete, the residual moisture value can be read.

TABLE 17
Residual moisture in % and paper whiteness in % of the heat-
sensitive recording materials according to the invention.

| | | | Support | Support material | | Support material | |
|---|---|---|---|---|---|---|---|
| | Support material | | material | with colour layer | | with colour layer, | |
| | with optional | | with colour | and heat-sensitive | | heat-sensitive layer | |
| | starch precoat | | layer | layer | | and protective layer | |
| | RF | PW | RF | RF | PW | RF | PW |
| Example 0 | 4.9 | 84.5 | — | 4.5 | 41.5 | — | — |
| Example 1 | — | — | — | 7.2 | 42.4 | — | — |
| Example 2 | 4.1 | 83.0 | — | 5.8 | 46.5 | — | — |
| Example 3 | 4.7 | 83.4 | 5.2 | 6.8 | 45.9 | 10.8 | 44.2 |
| Example 3 | 4.7 | 83.4 | 5.2 | — | — | 11.1 | 34.3 |
| Example 3 | 4.1 | 83.4 | — | 4.7 | 49.5 | — | 45.0 |
| Example 3 | 4.1 | 85.5 | — | — | — | 6.4 | 39.4 |
| Example 3 | — | 83.4 | 4.1 | — | — | 7.6 | 36.0 |
| Example 3 | 4.0 | 84.6 | 5.6 | — | — | 6.5 | 43.8 |
| Example 4 | 5.2 | 84.3 | 5.6 | 7.9 | 42.8 | — | — |
| Example 5 | 5.4 | 83.2 | 5.8 | 7.1 | 32.4 | — | — |

Example 0 corresponds to Example 2 with regard to the formulation constituents and the amounts used, but the area density was 37 g/m².

The above-mentioned Examples 3 correspond in respect of the formulation constituents and the used amounts to the above-mentioned Example 3 (Table 3), but proceed from different paper coating machine runs (different application methods).
RF=residual moisture, PW=paper whiteness

Furthermore, the dynamic sensitivity of heat-sensitive recording materials was determined, wherein the support material was calendered differently and thus exhibited a different Bekk smoothness.

The results are shown in FIG. 14, which shows the dynamic sensitivity (optical density (ODU)) in dependence on the energisation E.

The following were measured:
A: Support material uncalendered=>smoothness 210 Bekk [s]
B: Support material calendered line pressure 0.5 bar, smoothness 490 Bekk [s]
C: Support material calendered, line pressure 2×10 bar, smoothness 1276 Bekk [s]

It can be seen that the dynamic sensitivity rises with increasing Bekk smoothness.

1. A heat-sensitive recording material comprising
a web-like support material,
a colour layer on one side of the web-like support material and
a heat-sensitive layer on the colour layer so that the colour layer is at least partially covered,
the heat-sensitive layer being designed so that it becomes translucent due to local action of heat, so that the underlying colour layer becomes visible, characterised in that
the support material has a Bekk smoothness of greater than 20 s on the side to which the colour layer is applied, the Bekk smoothness being determined according to DIN 53107 (2016).

2. The heat-sensitive recording material according to claim 1, characterised in that the colour layer has a Bekk smoothness of greater than 100 s on the side to which the heat-sensitive layer is applied.

3. The heat-sensitive recording material according claim 1, characterised in that the heat-sensitive layer has a Bekk smoothness of greater than 100 s, on the side on which the colour layer does not lie.

4. The heat-sensitive recording material according claim 1, characterised in that each layer applied to the web-like support material has, on its upper side, a Bekk smoothness which is at least as great as or greater than that of the underlying layer, the upper side in each case being the side on which the web-like support material does not lie.

5. The heat-sensitive recording material according to claim 1, characterised in that the colour layer comprises at least one pigment and/or a dye and a binder.

6. The heat-sensitive recording material according to claim 1, characterised in that the heat-sensitive layer comprises at least one scattering polymer particle having a glass transition temperature of from −55° C. to 130° C., a melting temperature lower than 250° C., and/or a mean particle size in the range of from 0.1 to 2.5 μm.

7. The heat-sensitive recording material according to claim 1, characterised in that the heat-sensitive layer comprises at least one heat-sensitive fatty acid and/or fatty acid amide having a melting temperature in the range of from 40 to 200° C. and/or a glass transition temperature in the range of from 40 to 200° C.

8. The heat-sensitive recording material according to claim 1, characterised in that an insulation layer is present between the web-like support material and the colour layer, the insulation layer having a Bekk smoothness of greater than 50 s.

9. The heat-sensitive recording material according to claim 1, characterised in that the colour layer simultaneously constitutes a colour layer and an insulation layer, the colour layer which is simultaneously an insulation layer having a Bekk smoothness of greater than 50 s.

10. The heat-sensitive recording material according to claim 8, characterised in that the insulation layer or the colour layer, which simultaneously constitutes a colour layer and also an insulation layer, comprises at least one heat-insulating material selected from calcined kaolin or hollow-sphere pigments comprised of styrene-acrylate copolymer having a glass transition temperature of from 40° C. to 80° C. and/or a mean particle size of from 0.1 to 2.5 μm.

11. The heat-sensitive recording material according to claim 1, characterised in that a layer comprising starch is present directly on at least one side of the web-like support material said starch layer having a Bekk smoothness of greater than 20 s.

12. The heat-sensitive recording material according to claim 1, characterised in that a protective layer is present on the heat-sensitive layer, the protective layer having a Bekk smoothness of greater than 200 s.

13. The heat-sensitive recording material according to claim 12, characterised in that the protective layer comprises at least one binder and at least one pigment.

14. The heat-sensitive recording material according to claim 1, characterised in that an adhesive layer is present on the web-like support material on the side on which the colour layer is not located.

15. The heat-sensitive recording material according to claim 14, characterised in that the adhesive layer comprises at least one pressure-sensitive adhesive.

16. The heat-sensitive recording material according to claim 1, characterised in that a siliconised release layer is present on the heat-sensitive layer, the siliconised release layer having a Bekk smoothness of greater than 400 s.

17. The heat-sensitive recording material according to claim 16, characterised in that the siliconised release layer comprises at least one siloxane.

18. The heat-sensitive recording material according to claim 1, characterised in that the heat-sensitive recording material has a residual moisture of from 2 to 14%.

19. The heat-sensitive recording material according to claim 1, characterised in that the heat-sensitive recording material has a surface whiteness of from 35 to 60%.

20. The heat-sensitive recording material according to claim 1, characterised in that the contrast from locations where the heat-sensitive layer has become translucent due to local action of heat to locations where the heat-sensitive layer has not become translucent due to local action of heat is 40 to 80%.

21. A heat-sensitive recording material comprising
a web-like support material,
a colour layer on one side of the web-like support material and
a heat-sensitive layer on the colour layer so that the colour layer is at least partially covered,
the heat-sensitive layer being designed so that it becomes translucent due to local action of heat, so that the underlying colour layer becomes visible, characterised in that
the heat-sensitive recording material has a residual moisture of from 2 to 14%.

22. (canceled)

23. The heat-sensitive recording material according to claim 21, characterised in that the contrast from locations where the heat-sensitive layer has become translucent due to local action of heat to locations where the heat-sensitive layer has not become translucent due to local action of heat is 40 to 80%.

24. (canceled)

25. (canceled)

26. (canceled)

27. The heat-sensitive recording material according to claim 21, characterised in that each layer applied to the web-like support material has, on its upper side, a Bekk smoothness which is at least as great as or greater than that of the underlying layer, the upper side in each case being the side on which the web-like support material does not lie.

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A heat-sensitive recording material comprising
a web-like support material,
a colour layer on one side of the web-like support material and
a heat-sensitive layer on the colour layer so that the colour layer is at least partially covered,
the heat-sensitive layer being designed so that it becomes translucent by local action of heat, so that the underlying colour layer becomes visible, characterised in that the heat-sensitive layer comprises from 10 to 90 wt. % of scattering polymer particles having a mean particle size in the range of from 0.1 to 2.5 μm, 10 to 80 wt. % of a heat-sensitive material having a melting temperature in the range of from 40 to 200° C. and/or a glass transition temperature in the range of from 40 to 200° C., and 1 to 30 wt. % of a binder.

42. The heat-sensitive recording material according to claim 41, characterised in that the scattering polymer particles are crystalline, semi-crystalline and/or amorphous and are selected from closed hollow-body particles, open hollow-body particles and/or solid-body particles, each of which is regularly or irregularly shaped.

43. The heat-sensitive recording material according to claim 41, characterised in that the heat-sensitive material comprises a fatty acid and/or a fatty acid amide.

44. The heat-sensitive recording material according to claim 41, characterised in that the binder comprises water-soluble starches, starch derivatives, starch-based EcoSphere-type biolatices, methyl cellulose, hydroxyethyl cellulose, carboxymethyl cellulose, gelatine, casein, partially or fully saponified polyvinyl alcohols, chemically modified polyvinyl alcohols, ethylene-vinyl alcohol copolymers, sodium polyacrylates, styrene-maleic anhydride copolymers, ethylene-maleic anhydride copolymers, styrene-butadiene copolymers, acrylamide-(meth)acrylate copolymers, acrylamide-acrylate-methacrylate terpolymers, polyacrylates, poly(meth)acrylic acid esters, acrylate-butadiene copolymers, polyvinyl acetates and/or acrylonitrile-butadiene copolymers.

45. The heat-sensitive recording material according to claim 41, characterised in that the polymer particles have a mean particle size in the range of from 0.2 to 0.8 μm.

46. (canceled)

47. (canceled)

48. (canceled)

49. The heat-sensitive recording material according to claim 41, characterised in that the support material has a Bekk smoothness of greater than 20 s on the side to which the colour layer is applied.

50. The heat-sensitive recording material according to claim 41, characterised in that the colour layer has a Bekk smoothness of greater than 100 s on the side to which the heat-sensitive layer is applied.

51. The heat-sensitive recording material according to claim 41, characterised in that the heat-sensitive layer has a Bekk smoothness of greater than 100 s on the side on which the colour layer does not lie.

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. A heat-sensitive recording material comprising
a web-like support material,
an insulation layer on one side of the web-like support material,
a colour layer on the insulation layer and
a heat-sensitive layer, on the colour layer, so that the colour layer is at least partially covered,
the heat-sensitive layer being designed so that it becomes translucent due to local action of heat, so that the underlying colour layer becomes visible.

65. A heat-sensitive recording material comprising
a web-like support material,
a layer which is simultaneously a colour layer and an insulation layer on one side of the web-like support material, and
a heat-sensitive layer, on the colour layer, so that the colour layer is at least partially covered,
the heat-sensitive layer being designed so that it becomes translucent due to local action of heat, so that the underlying colour layer becomes visible.

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. A heat-sensitive recording material comprising
a web-like support material,
a colour layer on one side of the web-like support material and
a heat-sensitive layer on the colour layer so that the colour layer is at least partially covered,
the heat-sensitive layer being designed so that it becomes translucent due to local action of heat, so that the underlying colour layer becomes visible,
characterised in that the heat-sensitive layer contains or consists of a heat-sensitive material as scattering particles, the heat-sensitive material being selected from the group of biopolymers, modified biopolymers, fats, natural waxes, semi-synthetic waxes and/or synthetic waxes.

86. The heat-sensitive recording material according to claim 85, characterised in that the scattering particles are selected from amide waxes, stearic acid amide waxes, palmitic acid amide waxes or combinations thereof.

87. The heat-sensitive recording material according to claim 85, characterised in that the scattering particles are present in the heat-sensitive layer in an amount of from 5 to 100 wt. % in relation to the total weight of the heat-sensitive layer.

88. (canceled)

89. (canceled)

90. The heat-sensitive recording material according to claim 85, characterised in that the heat-sensitive layer is free from polymer particles having a mean particle size in the range of from 0.1 to 2 μm, except for unavoidable amounts.

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)
